(19) United States
(12) Patent Application Publication
(10) Pub. No.: US 2016/0199928 A1
(43) Pub. Date: Jul. 14, 2016

(54) METHOD OF MANUFACTURING PROTECTIVE STRUCTURE AND METHOD OF MANUFACTURING PROTECTIVE STRUCTURE OF COMPOSITE ELECTRIC WIRE

(71) Applicant: Yazaki Corporation, Tokyo (JP)

(72) Inventors: Hiroki Mukaiyama, Makinohara-shi (JP); Syogo Matsuoka, Makinohara-shi (JP); Kazuya Ikegaya, Makinohara-shi (JP); Satoru Horiuchi, Susono-shi (JP); Kazuyoshi Kagami, Susono-shi (JP); You Yanagida, Susono-shi (JP)

(21) Appl. No.: 14/995,465

(22) Filed: Jan. 14, 2016

(30) Foreign Application Priority Data
Jan. 14, 2015 (JP) 2015-004809
Jan. 14, 2015 (JP) 2015-004810
Jan. 14, 2015 (JP) 2015-004811
Jan. 30, 2015 (JP) 2015-016194
Jan. 30, 2015 (JP) 2015-016195
Jan. 30, 2015 (JP) 2015-016196
Jan. 12, 2016 (JP) 2016-003861

(51) Int. Cl. B23K 1/002

(52) U.S. Cl. CPC B23K 1/002

(57) ABSTRACT

To facilitate the protection of an exposed portion of a core wire of a cable and enable the acquisition of desired electric wire characteristics A coating portion at an end of a composite electric wire is peeled to expose a core wire and the exposed core wires are bundled and welded to form a composite exposed portion having a welded portion. The composite exposed portion is heated and then immersed in a powder material with which an immersion portion of an immersion container is filled and the powder material is melted to allow a melt thereof to adhere to the composite exposed portion to form a protective member covering the composite exposed portion. Heat-up of the composite exposed portion is set to a melting temperature of the powder material or higher.

### BACKGROUND

1. Technical Field

The present invention relates to a method of manufacturing a protective structure of a core wire exposed portion of a cable and a method of manufacturing a protective structure of a composite electric wire, and for example, relates to the protection of a core wire exposed portion of a cable applied to an automobile wire harness.

2. Related Art

In a cable including a core wire (core wire formed by using one or more wire-shaped or stranded metallic wires) and a coating portion with which the core wire is coated, the core wire at a desired location is frequently exposed (exposed by removing a portion of the coating portion by peeling or the like) appropriately for application. In the case of, for example, a composite electric wire such as an automobile wire harness formed of a plurality of cables, an application example in which core wires at an end or the like of some cables are exposed and exposed portions of these core wires are appropriately bundled and electrically connected (for example, a splice portion is formed by connecting by welding or the like) can be cited.

The exposed portion of the core wire is protected, instead of being left alone, by covering with a protective member formed by using an insulating polymeric material (such as a resin material) so that desired electric wire characteristics (insulation properties, resistance to water, durability and the like) can be obtained. As a technique (hereinafter, the conventional technique) to protect the exposed portion, a technique using a protective member such as a protective cap (obtained by sealing one end of heat-shrinkable tubing molded by, for example extrusion) produced by a molding process of, for example, injection molding or extrusion molding is known (see JP 2012-130225 A and JP 2013-17286 A).

### SUMMARY

However, the shape of the exposed portion is different depending on the type and application method (for example, the shape of the core wire and the number of bundled core wires) of the cable. Therefore, when the conventional technique is used, complicated processes, for example, a molding process to mold (mold using, for example, the mold for each exposed portion) a protective member by fitting to the shape of each exposed portion in advance and a covering process to manually cover the exposed portion with the protective member are needed, which makes it difficult to obtained desired electric wire characteristics.

In view of the above circumstances, an object of the present invention is to provide a method of manufacturing a protective structure facilitating the protection of an exposed portion of a core wire of a cable and capable of obtaining desired electric wire characteristics and a method of manufacturing a protective structure of a composite electric wire.

To achieve the above object, a first method of manufacturing a protective structure in the present invention is a method of manufacturing a protective structure covering an exposed portion of a core wire of a cable with a protective member made of an insulating polymeric material, the method including a heat-up process of heating the exposed portion to a melting temperature of the insulating polymeric material or higher and an immersion process of immersing the exposed portion having been heated in the insulating polymeric material in a powder state inside an immersion container to allow the insulating polymeric material to adhere to the exposed portion.

According to the first method of manufacturing a protective structure in the present invention, complicated processes of the conventional technique as described above are not needed and even if the shape of the exposed portion is diverse, coating to protect the exposed portion of the core wire of the cable can easily be performed by heating the exposed portion to the melting temperature of the insulating polymeric material or higher (heat-up process) and immersing the heated exposed portion in the insulating polymeric material in a powder state (immersion process). Then, due to the coating, desired electric wire characteristics such as insulation properties, resistance water, and durability can be obtained.

Also, in the first method of manufacturing a protective structure in the present invention, the heat-up process suitably is a process of heating the exposed portion by an induction heating unit.

According to the suitable method of manufacturing a protective structure, by locally heating only the exposed portion of the core wire of the cable in the heat-up process, melting of the exposed portion of the cable can be prevented in the heat-up process or a contribution to a higher cycle or energy saving concerning the formation of a protective member that protects the exposed portion by coating can be made.

Also, to achieve the above object, a second method of manufacturing a protective structure in the present invention is a method of manufacturing a protective structure covering an exposed portion of a core wire of a cable with a protective member made of an insulating polymeric material, the method including an immersion/heat-up process of heating the exposed portion immersed in the insulating polymeric material in a powder state inside an immersion container to a melting temperature of the insulating polymeric material or higher by an induction heating unit positioned on an outer circumferential side of the immersion container through induction heating.

According to the second method of manufacturing a protective structure in the present invention, like the first method of manufacturing a protective structure described above, coating to protect the exposed portion of the core wire of the cable can easily be performed. Then, due to the coating, desired electric wire characteristics such as insulation properties, resistance water, and durability can be obtained. Further, according to the second method of manufacturing a protective structure, the exposed portion immersed in the insulating polymeric material in a powder state is heated by induction heating and thus, heating and coating by contact can be performed in one process. Accordingly, the coating of the exposed portion can be performed more easily.

In the first and second methods of manufacturing a protective structure in the present invention, a reheat-up process of reheating the protective member to the melting temperature or higher is suitably included.

According to the suitable method of manufacturing a protective structure, the surface of the protective member is smoothly shaped by reheat-up. Accordingly, beauty of the protective member can also be obtained.

Also, in the suitable method of manufacturing a protective structure, the reheat-up process is more suitably a process of heating the protective member to the melting temperature or higher by induction heating the exposed portion covered with the protective member.

According to the more suitable method of manufacturing a protective structure, also in the reheat-up process, melting of the coating portion of the cable can be prevented or a contribution to a higher cycle or energy saving concerning the formation of the protective member can be made.

In the first and second methods of manufacturing a protective structure in the present invention, the exposed portion may be formed at an end, a midpoint, or both of the end and the midpoint of the cable.

Also, to achieve the above object, a method of manufacturing a protective structure of a composite electric wire in the present invention includes protecting an exposed portion obtained by bundling and electrically connecting exposed portions of core wires of a plurality of cables by covering with a protective member by the above methods of manufacturing a protective structure.

Also according to the method of manufacturing a protective structure of a composite electric wire in the present invention, like the first and second methods of manufacturing a protective structure in the present invention, the protection of an exposed portion of a core wire of a cable is facilitated and desired electric wire characteristics can be obtained.

According to the method of manufacturing a protective structure and the method of manufacturing a protective structure of a composite electric wire, the protection of an exposed portion of a core wire of a cable is facilitated and desired electric wire characteristics can be obtained.

### BRIEF DESCRIPTION OF DRAWINGS

FIG. 1 is a schematic diagram of a composite electric wire illustrating an example of a protective structure of an exposed portion in a first mode of a method of manufacturing the protective structure;

FIG. 2 is a schematic diagram of an immersion container illustrating an example of an immersion process in the first mode of the method of manufacturing the protective structure (schematic longitudinal view);

FIGS. 3A and 3B are schematic diagrams of the composite electric wire illustrating an example of a protective member in the first mode of the method of manufacturing the protective structure (composite electric wire after the immersion process; 3A is before reheat-up and 3B is after reheat-up);

FIG. 4 is a schematic diagram of the composite electric wire illustrating an example of a composite exposed portion in the first mode of the method of manufacturing the protective structure (schematic explanatory view of a state in which a center portion is peeled);

FIG. 5 is a schematic diagram of the composite electric wire illustrating an example of the composite exposed portion in the first mode of the method of manufacturing the protective structure (composite electric wire having a branching portion);

FIGS. 6A and 6B are schematic diagrams of the immersion container illustrating an example of the composite electric wire and the immersion process in the first mode of the method of manufacturing the protective structure (schematic longitudinal view; 6A is before immersion and 6B is after immersion);

FIG. 7 is a schematic diagram of an immersion container illustrating an example of the composite electric wire and the immersion process in the first mode of the method of manufacturing the protective structure (schematic longitudinal view);

FIG. 8 is a schematic diagram of a heat-up unit illustrating an example of a heat-up process in the first mode of the method of manufacturing the protective structure;

FIG. 9 is a schematic diagram of an induction heating unit illustrating an example of the heat-up process in a second mode of the method of manufacturing the protective structure;

FIG. 10 is a schematic longitudinal view of FIG. 9;

FIG. 11 is a schematic diagram of the immersion container and the induction heating unit illustrating an example of an immersion/heat-up process in a third mode of the method of manufacturing the protective structure (schematic longitudinal view);

FIGS. 12A and 12B are schematic diagrams of the immersion container and the induction heating unit illustrating an example of the immersion/heat-up process in the third mode of the method of manufacturing the protective structure (schematic longitudinal view; 12A is before immersion/heat-up and 12B is after immersion/heat-up);

FIG. 13 is a schematic diagram of the immersion container and the induction heating unit illustrating an example of the immersion/heat-up process in the third mode of the method of manufacturing the protective structure (schematic longitudinal view);

FIG. 14 is a schematic diagram of an induction heating unit illustrating an example of a reheat-up process in the third mode of the method of manufacturing the protective structure;

FIG. 15 is a schematic diagram of a core wire illustrating an example of a cable in the first mode of a method of manufacturing the cable;

FIG. 16 is a schematic diagram of the immersion container illustrating an example of the immersion process in the first mode of the method of manufacturing the cable (schematic longitudinal view);

FIGS. 17A and 17B are schematic diagrams of the cable illustrating an example of a coating portion in the first mode of the method of manufacturing the cable (after the immersion process; 17A is before reheat-up and 17B is after reheat-up);

FIGS. 18A and 18B are schematic diagrams of the core wire and the cable illustrating an example of an exposure target portion and a coating target portion in the first mode of the method of manufacturing the cable (17A is a masked state before the immersion process and 17B is after the immersion process);

FIG. 19 is a schematic diagram of the cable (or the composite electric wire) illustrating an example in which a plurality of core wires is bundled and the branching portion is formed in the first mode of the method of manufacturing the cable;

FIG. 20 is a schematic diagram of the heat-up unit illustrating an example of the heat-up process in the first mode of the method of manufacturing the cable;

FIG. 21 is a schematic diagram of the immersion container illustrating an example of the core wire and the immersion process in the first mode of the method of manufacturing the cable (schematic longitudinal view);

FIG. 22 is a schematic diagram of the immersion container illustrating an example of the core wire and the immersion process in the first mode of the method of manufacturing the cable (schematic longitudinal view);

FIGS. 23A and 23B are schematic diagrams of the immersion container illustrating an example of the core wire and the immersion process in the first mode of the method of manufacturing the cable (schematic longitudinal view; 23A is before immersion and 23B is after immersion);

FIG. 24 is a schematic diagram of the immersion container illustrating an example of the core wire and the immersion process in the first mode of the method of manufacturing the cable (schematic longitudinal view);

FIG. 25 is a schematic diagram of the immersion container illustrating an example of the core wire and the immersion process in the first mode of the method of manufacturing the cable (schematic longitudinal view);

FIG. 26 is a schematic diagram illustrating an example of the core wire having the branching portion in the first mode of the method of manufacturing the cable;

FIG. 27 is a schematic diagram illustrating an example of the composite electric wire using a plurality of cables in the first mode of the method of manufacturing the cable;

FIG. 28 is a schematic diagram of a wire harness illustrating an example of usage of the cable and the composite electric wire in the first mode of a method of manufacturing the cable;

FIGS. 29A, 29B, and 29C are schematic diagrams of the induction heating unit illustrating an example of the heat-up process in the second mode of the method of manufacturing the cable (29A and 29B are before the immersion process and 29C is a longitudinal view of 29A after the immersion process);

FIG. 30 is a schematic diagram of the immersion container and the induction heating unit illustrating an example of the immersion/heat-up process in the third mode of the method of manufacturing the cable (schematic longitudinal view);

FIG. 31 is a schematic diagram of the immersion container illustrating an example of the core wire and the immersion/heat-up process in the third mode of the method of manufacturing the cable (schematic longitudinal view);

FIG. 32 is a schematic diagram of the immersion container illustrating an example of the core wire and the immersion/heat-up process in the third mode of the method of manufacturing the cable (schematic longitudinal view);

FIG. 33 is a schematic diagram of the immersion container illustrating an example of the core wire and the immersion/heat-up process in the third mode of the method of manufacturing the cable;

FIGS. 34A and 34B are schematic diagrams of the immersion container illustrating an example of the core wire and the immersion/heat-up process in the third mode of the method of manufacturing the cable (schematic longitudinal view; 34A is before immersion and 34B is after immersion);

FIG. 35 is a schematic diagram of the immersion container illustrating an example of the core wire and the immersion/heat-up process in the third mode of the method of manufacturing the cable (schematic longitudinal view);

FIG. 36 is a schematic diagram of the immersion container illustrating an example of the core wire and the immersion/heat-up process in the third mode of the method of manufacturing the cable (schematic longitudinal view);

FIGS. 37A and 37B are schematic diagrams of the induction heating unit illustrating an example of the reheat-up process in the third mode of the method of manufacturing the cable (37A is a case when a coating target portion is linear and 37B is a case when the branching portion is included);

FIGS. 38A and 38B are diagrams illustrating situations that may arise in the third mode of the method of manufacturing the protective structure and in the third mode of the method of manufacturing the cable;

FIGS. 39A and 39B are diagrams showing the immersion container of a first different example;

FIGS. 40A and 40B are diagrams showing the immersion container of a second different example;

FIGS. 41A and 41B are diagrams showing the immersion container of a third different example;

FIG. 42 is a diagram showing the immersion container of a fourth different example;

FIGS. 43A and 43B are diagrams showing an example of an insertion structure into the immersion container of a heating target portion (that is, the coating target portion);

FIG. 44 is a diagram illustrating a first heating method and a coating method adopting the heating method;

FIGS. 45A, 45B, and 45C are diagrams illustrating a second heating method and a coating method adopting the heating method;

FIG. 46 is a diagram illustrating a third heating method and a coating method adopting the heating method;

FIG. 47 is a graph showing an example of changes over time of the temperature determined from a detection result of a thermocouple shown in FIG. 46 and a detection result by an ammeter;

FIGS. 48A, 48B, and 48C are diagrams illustrating a fourth heating method and a coating method adopting the heating method;

FIG. 49 is a graph showing changes over time of the temperature of the composite exposed portion when heated up in the heat-up process by the fourth heating method shown in FIGS. 48A, 48B, and 48C;

FIGS. 50A and 50B are diagrams showing coating devices adopting a heating device of a different example using an induction coil;

FIGS. 51A, 51B, and 51C are diagrams comparing internal magnetic flux densities of a heating coil portion of the coating device shown in FIG. 50A and a heating coil portion of the coating device of a comparative example shown in FIG. 50B;

FIG. 52A is a diagram showing the coating device adopting the heating device of another different example using the induction coil and FIG. 52B is a diagram showing the coating device of a comparative example to compare with the coating device of FIG. 52A;

FIGS. 53A and 53B are explanatory views illustrating how to assemble the coating device shown in FIG. 52A; and

FIG. 54 is a diagram showing a modification of the heating device of the other different example shown in FIG. 52A.

### DETAILED DESCRIPTION

Hereinafter, the method of manufacturing a protective structure that covers an exposed portion of a core wire of a cable with a protective member made of an insulating polymeric material, the method of manufacturing a protective structure of a composite electric wire, and a production unit of a protective structure (hereinafter, called the method of manufacturing a protective structure) will be described. First, a first mode of the method of manufacturing a protective structure will be described.

The first mode of the method of manufacturing a protective structure can protect an exposed portion (for example, a bundled exposed portion in the case of a composite electric wire) by a technique quite different from a conventional technique and forms a protective member by immersing an exposed portion heated up to a melting temperature of an insulating polymeric material or higher in the insulating polymeric material in a powder state inside an immersion container to allow the insulating polymeric material to adhere to the exposed portion.

A protective member such as a protective cap applied by the conventional technique is produced, like, for example, a general-purpose cable, by facilities using an injection molding machine, an extrusion molding machine or the like. According to facilities using such a molding machine, for example, protective members of the same shape or the like can easily be mass-produced, but such protective members are stored in a predetermined storage location before being applied to an exposed portion and also a molding machine needs to be installed and thus, upsizing or higher costs of facilities may be invited and also waste related to the protective member (for example, waste of a surplus of protective members or a material remaining in a so-called runner or the like in the case of injection molding) may arise. Further, a work space may become narrower so that work efficiency of each process (for example, work efficiency related to protection of the exposed portion) in facilities is degraded.

When the exposed portion of a composite electric wire, for example, an automobile wire harness or the like is protected by a protective member according to the conventional technique, it is necessary to produce the composite electric wire and the protective member in separate facilities or to prepare large facilities.

The shape of the exposed portion is different depending on the type of cable and the application method. In a composite electric wire, for example, an automobile wire harness or the like, the composite electric wire has a configuration in which exposed portions of core wires of a plurality of cables are appropriately bundled by fitting to the automobile and electrically connected and the shape of the exposed portion is diverse. Thus, it has become difficult to share protective members mass-produced as described above.

Therefore, when the conventional technique is used, a molding process to mold (molding using, for example, the mold for each exposed portion) a protective member by fitting to the shape of each exposed portion in advance and a covering process to manually cover the exposed portion with the protective member are needed. For example, manual work of the covering process needs a complicated work time depending on the shape of the exposed portion or the protective member and it may become difficult to obtain desired electric wire characteristics.

On the other hand, according to the first mode of the method of manufacturing a protective structure, complicated processes of the conventional technique are not needed and even if the shape of the exposed portion is diverse, a protective member can be formed by heating the exposed portion to the melting temperature of an insulating polymeric material or higher (heat-up process) and immersing the heated exposed portion in a powder insulating polymeric material inside an immersion container (immersion process) to allow the insulating polymeric material to adhere to the exposed portion. Compared with the molding process and the covering process of the conventional technique, the heat-up process and the immersion process as described above can be considered to be simple and easy from various viewpoints.

That is, in the first mode of the method of manufacturing a protective structure, compared with the conventional technique, the exposed portion can easily be protected and obtaining desired electric wire characteristics such as insulation properties, resistance to water, and durability can be considered to be certainly possible. In addition, the storage location and a molding machine needed for the conventional technique are not needed so that work efficiency can be increased by securing sufficient work space or facilities can be reduced in size or costs thereof can be reduced. Further, a protective member may be formed by undergoing the heat-up process and the immersion process as described above when an exposed portion should be protected so that costs can be reduced by avoiding waste related to the protective member. Therefore, when an exposed portion of a composite electric wire, for example, an automobile wire harness or the like is protected by forming a protective member, it is certainly possible to produce the composite electric wire and the protective member by the same facilities (for example, existing automobile wire harness facilities).

In the first mode of the method of manufacturing a protective structure, if a protective member can be formed by allowing an insulating polymeric material to adhere to an exposed portion to protect the exposed portion as described above, technologies known generally in various fields such as the automobile field, electric wire field, terminal field, welding field, powder coating field, insulating polymeric material field and the like can be applied to appropriately design a protective structure and, for example, examples of the protective structures as shown below can be cited.

<<Example of the Protective Structure of an Exposed Portion in the First Mode of the Method of Manufacturing a Protective Structure>>

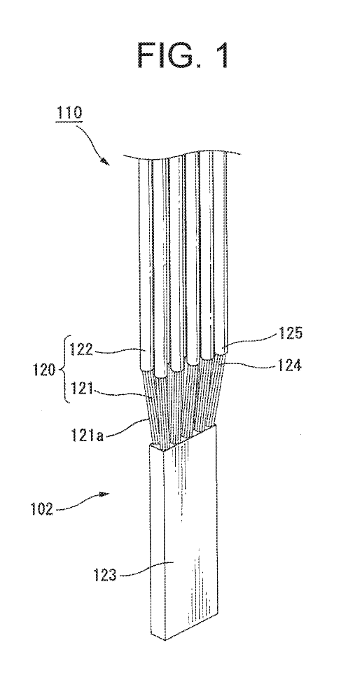

A composite electric wire 110 shown in FIGS. 1 to 8 (details of each diagram will be described below when appropriate) is a composite electric wire having a configuration in which a plurality of cables 120 having a core wire 121 and a coating portion 122 coating the core wire 121 is bundled and shows an example applicable to, for example, an automobile wire harness and the like. In the composite electric wire 110, the coating portion 122 on one end (one end of each of the cables 120) is removed by peeling or the like and a portion of the core wire 121 is exposed to form an exposed portion 121a of the core wire 121 and further, a plurality of the exposed portions 121a is bundled and electrically connected to form a composite exposed portion 102.

In a configuration like that of the composite electric wire 110 in which the composite exposed portion 102 is formed from the plurality of cables 120, each of the core wires 121 in the composite exposed portion 102 can be mutually electrically joined (that is, each of the core wires 121 is electrically joined) or can be prevented from being scattered about by, for example, bundling and welding (for example, electric resistance welding, ultrasonic welding or the like) each of the core wires 121. The composite exposed portion 102 in FIGS. 1 to 4, 6 to 8 has a configuration in which a sheet welded portion 123 is formed by the above welding.

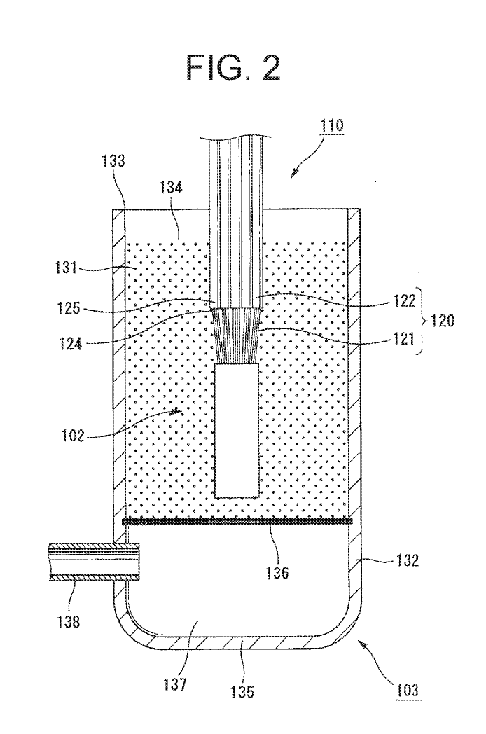

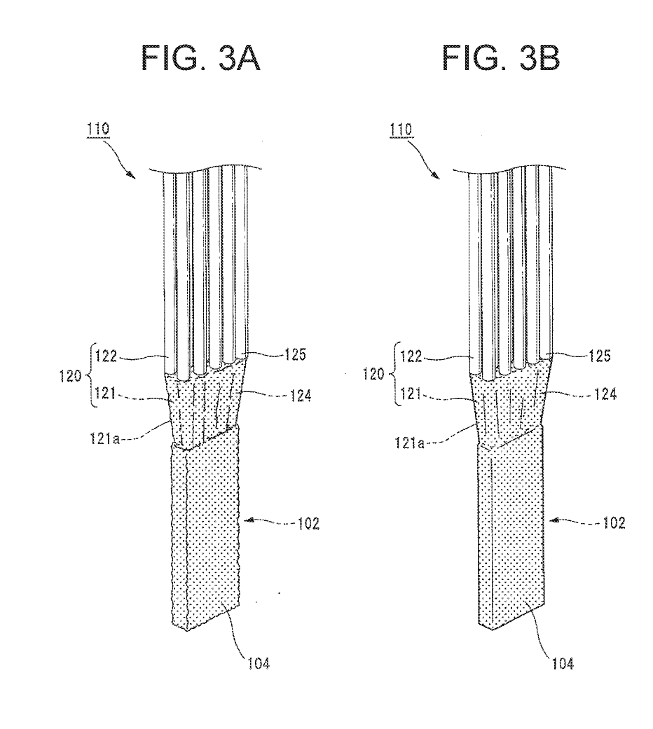

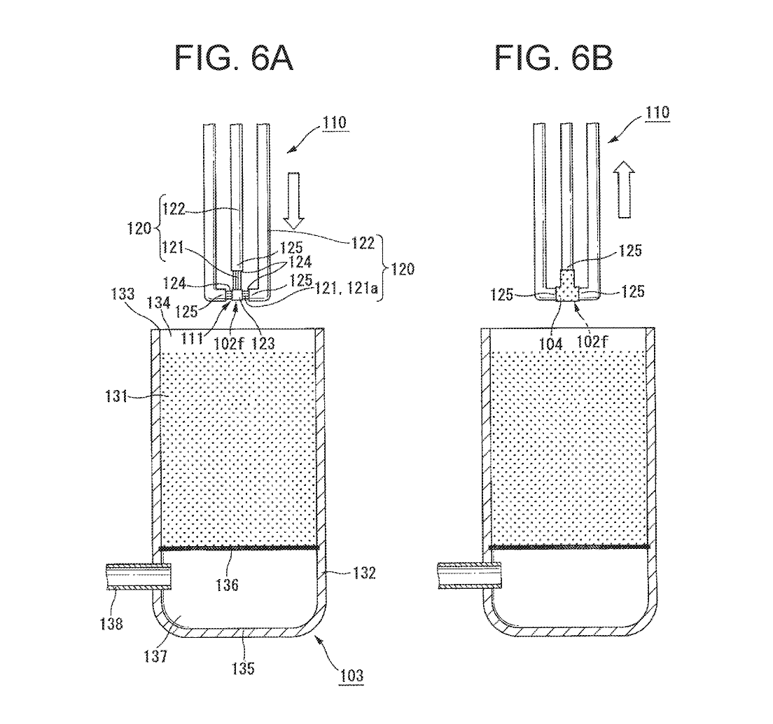

The composite exposed portion 102 (or the composite exposed portion 102 and an edge 125 described below; hereinafter, simply called the composite exposed portion 102 when appropriate) formed as described above can obtain desired electric wire characteristics by, for example, covering and protecting by a protective member 104 made of a powder insulating polymeric material (hereinafter, simply a powder material) 131 (that is, an insulating polymeric material) as shown in FIGS. 3 and 6B using, for example, the technique using an immersion container 103 filled with the powder material 131 as shown in FIGS. 2, 6, and 7.

In the technique using the immersion container 103, first the composite exposed portion 102 is heated to the melting temperature of the powder material 131 (hereinafter, simply a power melting temperature) or higher in the heat-up process using a desired heat-up unit (for example, a heating furnace 106 described below or the like). Next, when the aforementioned composite exposed portion 102 in a heated state is immersed in the powder material 131 inside the immersion container 103 as shown in, for example, FIGS. 2, 6, and 7 by the immersion process, the powder material 131 around the composite exposed portion 102 is melted and the melt adheres like covering the composite exposed portion 102. Then, the composite exposed portion 102 is taken out of the immersion container 103 and when the melt drops to a temperature below the powder melting temperature and is set, as shown in FIGS. 3A and 6B, the protective member 104 covering the composite exposed portion 102 is formed. When the protective member 104 rises in temperature up to the powder melting temperature or higher in, for example, the reheat-up process and softens, the surface thereof is smoothed (smoothed like in FIG. 3B in the case of, for example, the protective member 104 in FIG. 3A) and the appearance thereof is improved.

<Example of the Cable in the First Mode of the Method of Manufacturing a Protective Structure>

Various modes can be applied to the cable 120 in accordance with desired electric wire characteristics and, for example, as shown in FIG. 1, the configuration in which the core wire 121 is covered with the coating portion 122 and the exposed portion 121a of the core wire 121 can be formed by removing the coating portion 122 of a desired location (an end or the center portion of the cable 120) by peeling or the like can be cited. As a concrete example, a cable that can be produced by a common extrusion molding machine can be cited. By applying a plurality of the cables 120 as described above, the composite electric wire 110 applied to an automobile wire harness can be constructed or the composite exposed portion 102 can be formed by appropriately forming the exposed portion 121a in a desired location of each of the cables 120 of the composite electric wire 110 and electrically joining the exposed portions 121a by forming the welded portion 123 or the like.

The material, shape (the transverse section shape, the diameter and the like) and the like of the core wire 121 can also be set appropriately in accordance with desired electric wire characteristics and, for example, a configuration formed by using one or a plurality of element wires obtained by molding a conductive material such as copper, aluminum, or an alloy like a wire or a stranded wire can be cited.

The material, shape (the coating thickness and the like) and the like of the coating portion 122 can also be set appropriately in accordance with desired electric wire characteristics and, for example, applying an insulating polymeric material (hereinafter, an insulating polymeric material applied to the coating portion 122 is called a coating material when appropriate) capable of coating the core wire 121 and from which desired electric wire characteristics such as insulation properties and resistance to water can be cited and it is preferable to apply a coating material having heat resistance and whose melting temperature (hereinafter, the melting temperature of the coating portion 122 is called a coating melting temperature) is higher than the powder melting temperature. By applying a coating material having such heat resistance, the coating portion 122 can be prevented from melting when the composite exposed portion 102 is heated in the heat-up process and the like.

As a concrete example of the coating material, a material obtained by appropriately applying various additives used generally in the field of insulating polymeric material molding technology, for example, heat stabilizers, light stabilizers (ultraviolet inhibitors), antioxidants, age inhibitors, pigments, coloring agents, inorganic fillers, small inorganic fillers (nanoparticles), fire retardants, antibacterial agents, and corrosion inhibitors to an insulating polymeric material such as a thermoplastic resin as a main component within a range that does not impair desired electric wire characteristics can be cited. As the main component (thermoplastic resin and the like), various insulating polymeric components of PVC, EVA, PA, polyester, polyolefin and the like can be cited.

The shape, forming location and the like of the composite exposed portion 102 can appropriately be set according to purpose of use of the cable 120 (or the composite electric wire 110) and as an example thereof, a mode in which the composite exposed portion 102 is formed at an end of the cable 120 can be cited, but any mode capable of forming the protective member 104 by undergoing the heat-up process and the immersion process described below may be used.

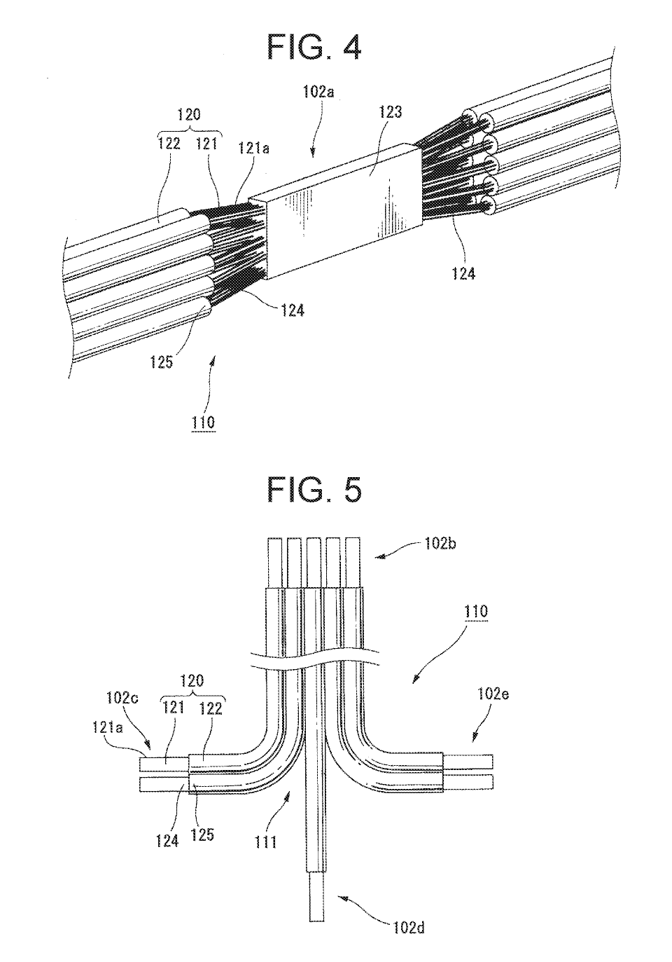

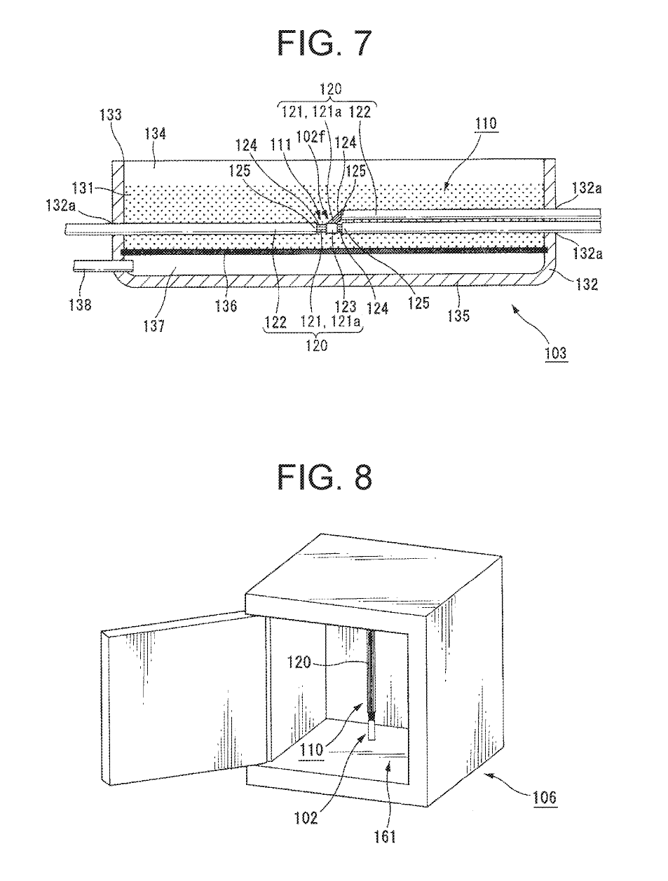

For example, the composite exposed portion 102 (reference sign 102a in FIG. 4) formed by peeling the coating portion 122 (so-called center peeling) in the center portion where a plurality of the cables 120 is bundled like the composite electric wire 110 shown in FIG. 4 can be cited. In a configuration having, as shown in FIGS. 5 to 7, a branching portion 111 in the center portion or the like of the composite electric wire 110, the composite exposed portion 102 (reference signs 102b to 102e in FIG. 5) formed by appropriately peeling each of the branched cables 120 and the composite exposed portion 102 (reference sign 102f in FIGS. 6 and 7) formed by peeling the branching portion 111 can be cited.

<Example of the Heat-Up Process in the First Mode of the Method of Manufacturing a Protective Structure>

The heat-up process is a process in which the temperature of the composite exposed portion 102 is heated up to the powder melting temperature or higher by using a heat-up unit and the process is not specifically limited if, when the composite exposed portion 102 in a heated state is immersed in the powder material 131 inside the immersion container 103 in a subsequent immersion process, the powder material 131 is melted (the powder material 131 around the composite exposed portion 102) and the melt is allowed to adhere to (adhere like covering) the composite exposed portion 102.

For example, a process in which the heating furnace 106 as shown in FIG. 8 is applied as a heat-up unit and the composite exposed portion 102 is heated by accommodating the composite electric wire 110 in an inside 161 of the heating furnace 106 can be cited. Heat-up conditions by the heating furnace 106 can appropriately be set in accordance with the heat capacity (heat capacity based on the specific heat, specific gravity, shape and the like) and heat dissipation (temperature drop) characteristics of the composite exposed portion 102 and conditions (the powder melting temperature, the immersion time and the like) of the subsequent immersion process.

It is preferable to heat the composite exposed portion 102 while inhibiting melting of the coating portion 122 by setting the heat-up temperature of the composite exposed portion 102 to a range, for example, equal to or higher than the powder melting temperature and lower than the coating melting temperature. If, for example, the composite exposed portion 102 is heated up to the powder melting temperature or higher in the heat-up process, the composite exposed portion 102 side (the edge 125 and the like) of the coating portion 122 may rise up to the powder melting temperature or higher, but if the composite exposed portion 102 side of the coating portion 122 rises up to a temperature lower than the coating melting temperature, melting is inhibited.

<Example of the Immersion Process in the First Mode of the Method of Manufacturing a Protective Structure>

The immersion process can be performed by appropriately using the general powder coating method and using, for example, an immersion coating method using the immersion container 103 as shown in, for example, FIGS. 2, 6, and 7 can be cited. The immersion coating method is a method by which the intended composite exposed portion 102 (surface or the like) heated (pre-heated) in advance by the aforementioned heat-up process or the like and the composite exposed portion 102 in a heated state is immersed in the powder material 131 inside the immersion container 103 to melt the powder material 131 (the powder material 131 around the immersed composite exposed portion 102) by heat of the composite exposed portion 102 and to form the protective member 104 in the composite exposed portion 102 by allowing the melt to adhere to the composite exposed portion 102.

Various modes can be applied to the immersion container 103 in accordance with the shape or the like of the immersed composite exposed portion 102 and any mode allowing the immersion container 103 to be sufficiently filled with the powder material 131 and allowing the composite exposed portion 102 to be immersed in the powder material 131 may be used. As a concrete example, as shown in FIGS. 2, 6, and 7, a configuration including a peripheral wall 132 in a closed-end cylindrical shape, an immersion portion 134 formed on the side of an opening 133 inside the peripheral wall 132, a gas jetting portion 137 formed on the side of a bottom wall 135 inside the peripheral wall 132 and partitioned from the immersion portion 134 by a partition wall 136, and a supply portion 138 communicatively connecting an outer circumferential side of the peripheral wall 132 and the gas jetting portion 137 and capable of supplying a gas to the gas jetting portion 137 can be cited.

In the immersion container 103 shown in FIG. 7, a through hole 132a (three holes in FIG. 7) is formed on the immersion portion 134 side of the peripheral wall 132 and the through hole 132a is configured to allow a portion (both ends in FIG. 7) of the composite electric wire 110 to pass through. By adopting such a configuration, for example, as illustrated in FIG. 7, the composite exposed portion 102 can be immersed in the immersion portion 134 while extending the composite electric wire 110 linearly. In the configuration including the through hole 132a as described above, as shown in FIG. 7, the powder material 131 inside the immersion portion 134 can be inhibited from leaking out to the outer circumferential side of the peripheral wall 132 even in a state in which a portion of the composite electric wire 110 passes through the through hole 132a by an appropriate design (for example, by providing a check valve outside FIG. 7 or the like in the through hole 132a).

A porous structure in which a plurality of holes (not shown) of shape substantially equal to the size of the powder material 131 or less than the size of the powder material 131 is punched can be applied as the partition wall 136 of the gas jetting portion 137 and, for example, a partition wall obtained by sintering, fiber cloth, or machining can be cited. By using the immersion container 103 having the partition wall 136 as described above, a gas supplied to the gas jetting portion 137 via the supply portion 138 is equally jetted (for example, jetted under the atmospheric pressure) to the immersion portion 134 via each hole of the partition wall 136, which makes the powder material 131 inside the immersion portion 134 easier to flow. In a state in which the powder material 131 is made to flow, it is easier to immerse the composite exposed portion 102 in the powder material 131.

The gas supplied from the supply portion 138 is not specifically limited, but applying an inert gas such as air, dry air, nitrogen, and dry nitrogen can be cited. Concerning the flow rate of gas, setting the flow rate appropriately in accordance with the particle size, distribution, shape, density and the like of the powder material 131 with which the immersion portion 134 is filled can be cited. For example, the flow rate can be set based on a linear speed (cm/min) of the value obtained by dividing a gas flow rate (cm³/min) by an effective area (effective area (cm²) of a region of the immersion portion 134 in which the gas is jetted equally). For example, setting 0.5 cm/min to 50 cm/min (more desirably, 1 cm/min to 20 cm/min) can be cited.

<Example of the Powder Material in the Immersion Process in the First Mode of the Method of Manufacturing a Protective Structure>

Concerning the powder material 131, applying the powder material 131 obtained by pulverizing, for example, the composition (for example, a pellet-shaped composition; hereinafter, simply “the composition”) of an insulating polymeric material, wherein the composition is pulverized to the extent that the protective member 104 can be formed in the intended composite exposed portion 102 (coated region) by the aforementioned immersion coating method can be cited. For example, the powder material 131 pulverized to about a few tens of μm to a few hundred μm (as a concrete example, pulverized to about 80 μm to 170 μm) in average particle size can be cited, but the average particle size can appropriately be set in accordance with the intended composite exposed portion 102 or the applied immersion coating method (for example, conditions of the heat-up process and the immersion process). The shape (the particle size, powder shape and the like) of the powder material 131 obtained by pulverization may change depending on the kind (the type, model and the like) of device used for pulverization or the pulverization time within a range to the extent that the protective member 104 can be formed in the intended composite exposed portion 102 by the immersion coating method as described above.

As the device used for pulverization, for example, applying various mill devices can be cited and as concrete examples, devices by rotation, impact, vibration and the line can be cited. Considerable heat is generated during pulverization by a mill device and the composition itself may unintendedly be melted (autohesion) or degraded. In such a case, cooling the whole mill device or a portion (portion related to pulverization) thereof or cooling (cooling by using a refrigerator, a freezer, liquid nitrogen or the like) the composition itself in advance can be considered. If the composition cannot be input into the mill device due to a large lump state or the like, the composition may coarsely be pulverized to the extent that the pulverized composition can be input.

As a method of preventing fusion (autohesion) and adhesion of powder in the powder material 131, applying the powder material 131 obtained by pulverizing a composition using the composition to which inorganic powder such as silica and calcium carbonate can be considered. The inorganic powder can appropriately be used to the extent that characteristics of the intended powder material 131 are not impaired and adding 0.1 wt % to 10 wt % of the inorganic powder having the average particle size of, for example, about 0.1 μm to 20 μm can be cited.

As a concrete example of the powder material 131, a material obtained by appropriately applying various additives used generally in the field of polymeric material molding technology, for example, heat stabilizers, light stabilizers (ultraviolet inhibitors), antioxidants, age inhibitors, pigments, coloring agents, inorganic fillers, small inorganic fillers (nanoparticles), fire retardants, antibacterial agents, and corrosion inhibitors to an insulating polymeric material such as a thermoplastic resin as a main component within a range that does not impair desired electric wire characteristics, wherein the material melts when heated up to a predetermined temperature (that is, the powder melting temperature) and sets when cooled below the predetermined temperature can be cited. As the main component (thermoplastic resin and the like), various insulating polymeric components of PVC, EVA, PA, polyester, polyolefin and the like can be cited.

<Example of Immersion in the Immersion Process in the First Mode of the Method of Manufacturing the Protective Structure>

Immersion conditions in the immersion process, for example, the immersion time and immersion position (the spatial position, direction and the like during immersion and the state of the composite electric wire 110 during immersion and the like) of the composite exposed portion 102 with respect to the immersion portion 134 of the immersion container 103 can appropriately be set in accordance with the heat capacity (heat capacity based on the specific heat, specific gravity, shape and the like), heat dissipation (temperature drop) characteristics, the shape, and the powder melting temperature of the composite exposed portion 102 and the shape and the like of the intended protective member 104.

If, for example, the composite exposed portion 102 is formed at an end of the composite electric wire 110, as shown in FIG. 2, immersing the composite exposed portion 102 side of the composite electric wire 110 in the immersion portion 134 can be cited. If the composite exposed portion 102 is formed in a center portion of the composite electric wire 110, immersing the composite exposed portion 102 side in the immersion portion 134 after, as shown in FIGS. 6A and 6B, the composite electric wire 110 is bent using the composite exposed portion 102 side as a base point (in FIGS. 6A and 6B, each of the cables 120 is bent and bundled) or after, as shown in FIG. 7, the composite electric wire 110 is extended linearly can be cited.

While FIGS. 2, 6, and 7 show a state in which, in addition to the composite exposed portion 102, the coating portion 122 (a portion (such as the edge 125) or all thereof) is immersed in the immersion portion 134, if the temperature of the coating portion 122 is lower than the powder melting temperature, the adhesion of melt of the powder material 131 to the coating portion 122 (for example, the edge 125) is inhibited and also the protective member 104 can be formed such that a space between the side of an underhead portion 124 of the composite exposed portion 102 and the coating portion 122 can be sealed without any gap. On the other hand, as described in, for example, <Example of the heat-up process in the first mode of the method of manufacturing a protective structure>, if the temperature of the edge 125 of the coating portion 122 is equal to or higher than the power melting temperature (and lower than the coating melting temperature) due to heat-up of the composite exposed portion 102, the melt of the powder material 131 adheres, in addition to the composite exposed portion 102, to the edge 125, the protective member 104 is formed like covering the composite exposed portion 102 and the edge 125 (the protective member 104 covering the edge 125 is not shown), and, for example, the space between the underhead portion 124 side of the composite exposed portion 102 and the coating portion 122 is more sealed without any gap.

If, in the composite exposed portion 102 (or/and the coating portion 122), for example, any location that does not need (or temporarily does not need) covering by the protective member 104 exists, it is preferable to perform the immersion process by appropriately masking the relevant location. Further, the immersion process may be performed not simply once, but may be repeated a plurality of times.

The thickness of the melt (melt of the powder material 131) adhering to the composite exposed portion 102 can be changed by appropriately adjusting immersion conditions or the heat-up temperature or the like of the heat-up process. Without adjustments of immersion conditions or the heat-up temperature or the like of the heat-up process, the thickness of the melt increases over time in a fixed immersion time after starting the immersion of the composite exposed portion 102, but after the fixed immersion time, the thickness of the melt is considered to be constant or nonuniform (the surface state is coarse). For example, depending on the shape of the composite exposed portion 102, it may be difficult for the melt to be fixed (for example, when the melt peels off) or the melt may dangle so that the thickness may become nonuniform. Such a trend may also arise if the heat-up temperature in the heat-up process is too low or too high. In such a case, in addition to appropriately adjusting immersion conditions or the heat-up temperature or the like of the heat-up process as described above, it is preferable to perform the reheat-up process described below when appropriate.

<Example of the Reheat-Up Process in the First Mode of the Method of Manufacturing a Protective Structure>

The reheat-up process is not specifically limited if the surface of the protective member 104 (including a half-melting state before complete setting) can be smoothed by heating the protective member 104 formed in the composite exposed portion 102 in the prior immersion process up to the powder melting temperature or higher. For example, like the heat-up process described above, a process in which the heating furnace 106 as shown in FIG. 8 is applied as a heat-up unit and the protective member 104 is heated by accommodating the cable 120 in the inside 161 of the heating furnace 106 can be cited. Also, heat-up conditions by the heating furnace 106 in the reheat-up process can appropriately be set in accordance with the heat capacity (heat capacity based on the specific heat, specific gravity, shape and the like) and heat dissipation (temperature drop) characteristics of the protective member 104. Also, by setting the heat-up temperature of the protective member 104 to a range, for example, equal to or higher than the powder melting temperature and lower than the coating melting temperature, the protective member 104 can be heated while inhibiting melting of the coating portion 122.

The immersion process and the reheat-up process described above may each be performed once, but may also be alternately repeated in accordance with the intended protective member 104.

<Example 1 According to the First Mode of the Method of Manufacturing a Protective Structure>

Based on the content described above, we tried to produce a protective structure using the protective member 104 in the composite exposed portion 102 that may be formed in an automobile wire harness. First, as shown in FIG. 1, the composite electric wire 110 made of a plurality of the cables 120 and applicable to an automobile wire harness is prepared, the coating portion 122 at an end of the composite electric wire 110 is peeled to expose the core wires 121, and the exposed core wires 121 are bundled and welded to form the composite exposed portion 102 having the welded portion 123.

Next, the composite electric wire 110 is accommodated in the inside 161 of the heating furnace 106 and the composite exposed portion 102 is heated up to about 120° C. by the heat-up process as shown in FIG. 8. Then, the heated composite exposed portion 102 is immersed (immersed swiftly after heat-up) in the powder material 131 with which the immersion portion 134 of the immersion container 103 is filled by the immersion process as shown in FIG. 2 and after holding the immersed state for about 30 sec, the composite exposed portion 102 is taken out of the immersion portion 134. Incidentally, a material using a polyamide thermoplastic resin (Platamid manufactured by Arkema, product number: HX2544PRA170) and pulverized to about 80 μm to 170 μm in average particle size is applied as the powder material 131.

The observation of the composite exposed portion 102 taken out of the immersion portion 134 shows that the melt of the powder material 131 adheres like covering the composite exposed portion 102 and the melt is set after the temperature thereof drops to form the protective member 104 as shown in FIG. 3A. When, in addition to the composite exposed portion 102, the edge 125 of the coating portion 122 is heated up to about 120° C. by the heat-up process, the protective member 104 covering the composite exposed portion 102 and the edge 125 is formed.

The protective member 104 covers the outer circumferential side of the composite exposed portion 102 (or the composite exposed portion 102 and the edge 125) without gap and is also formed by sealing the space between, for example, the underhead portion 124 side of the composite exposed portion 102 and the coating portion 122 without any gap, confirming that electric wire characteristics (insulation properties, resistance to water, durability and the like) required of an automobile wire harness can sufficiently be provided.

Then, the composite electric wire 110 is again accommodated in the inside 161 of the heating furnace 106 and the protective member 104 is heated up to about 120° C. (reheat-up process) and then, the observation of the composite electric wire 110 after being taken out of the inside 161 confirms that, as shown in FIG. 3B, the surface of the protective member 104 is smoothed.

<Example 2 According to the First Mode of the Method of Manufacturing a Protective Structure>

We also tried to produce a protective structure using the protective member 104 for the composite electric wire 110 applicable to an automobile wire harness and in which the composite exposed portion 102 is formed, as shown in FIGS. 4 to 7, in a center portion thereof. First, using a technique similar to that of Example 1, the composite electric wire 110 is accommodated in the inside 161 of the heating furnace 106 and the composite exposed portion 102 is heated up to about 120° C. by the heat-up process as shown in FIG. 8. Then, the heated composite exposed portion 102 is immersed (immersed swiftly after heat-up) in the powder material 131 with which the immersion portion 134 of the immersion container 103 is filled by the immersion process as shown in FIGS. 6 and 7 and after holding the immersed state for about 30 sec, the composite exposed portion 102 is taken out of the immersion portion 134. The powder material 131 similar to that in Example 1 is applied.

The observation of the composite exposed portion 102 taken out of the immersion portion 134 shows that the melt of the powder material 131 adheres like covering the composite exposed portion 102 and the melt is set after the temperature thereof drops to form the protective member 104 as shown in FIG. 6B. When, in addition to the composite exposed portion 102, the edge 125 of the coating portion 122 is heated up to about 120° C. by the heat-up process, the protective member 104 covering the composite exposed portion 102 and the edge 125 is formed.

The protective member 104 covers the outer circumferential side of the composite exposed portion 102 (or the composite exposed portion 102 and the edge 125) without gap and is also formed by sealing the space between, for example, the underhead portion 124 side of the composite exposed portion 102 and the coating portion 122 without any gap, confirming that electric wire characteristics (insulation properties, resistance to water, durability and the like) required of an automobile wire harness can sufficiently be provided.

Then, the composite electric wire 110 is again accommodated in the inside 161 of the heating furnace 106 and the protective member 104 is heated up to about 120° C. (reheat-up process) and then, the observation of the composite electric wire 110 after being taken out of the inside 161 confirms that the surface of the protective member 104 is smoothed (smoothed as shown in, for example, FIG. 3B).

Next, the second mode of the method of manufacturing a protective structure will be described. The second mode of the method of manufacturing a protective structure is the same as the first mode except that induction heating is used for heat-up. Hereinafter, the description focuses on differences of the second mode of the method of manufacturing a protective structure from the first mode of the method of manufacturing a protective structure and a repeated description of equal points is omitted.

In the second mode of the method of manufacturing a protective structure, first by including a configuration equal to that of the first mode of the method of manufacturing a protective structure, complicated processes of the conventional technique are not needed and even if the shape of the exposed portion is diverse, a protective member can be formed by heating the exposed portion to the melting temperature of an insulating polymeric material or higher (heat-up process) and immersing the heated exposed portion in a powder insulating polymeric material inside an immersion container (immersion process) to allow the insulating polymeric material to adhere to the exposed portion. Compared with the molding process and the covering process of the conventional technique, the heat-up process and the immersion process as described above can be considered to be simple and easy from various viewpoints.

That is, in the second mode of the method of manufacturing a protective structure, compared with the conventional technique, the exposed portion can easily be protected and obtaining desired electric wire characteristics such as insulation properties, resistance to water, and durability can be considered to be certainly possible. In addition, the storage location and a molding machine needed for the conventional technique are not needed so that work efficiency can be increased by securing sufficient work space or facilities can be reduced in size or costs thereof can be reduced. Further, a protective member may be formed by undergoing the heat-up process and the immersion process as described above when an exposed portion should be protected so that costs can be reduced by avoiding waste related to the protective member. Therefore, when an exposed portion of a composite electric wire, for example, an automobile wire harness or the like is protected by forming a protective member, it is certainly possible to produce the composite electric wire and the protective member by the same facilities (for example, existing automobile wire harness facilities).

Also, by heating only the core wire of the cable, for example, locally heating only the exposed portion by applying an induction heating unit in the heat-up process, melting of the coating portion of the cable can be prevented in the heat-up process or a contribution to a higher cycle or energy saving concerning the formation of a protective structure can be made.

In the second mode of the method of manufacturing a protective structure, if a protective member can be formed by allowing an insulating polymeric material to adhere to an exposed portion to protect the exposed portion as described above, technologies known generally in various fields such as the automobile field, electric wire field, terminal field, welding field, powder coating field, induction heating field, insulating polymeric material field and the like can be applied to appropriately design a protective structure and, for example, examples as shown below can be cited.

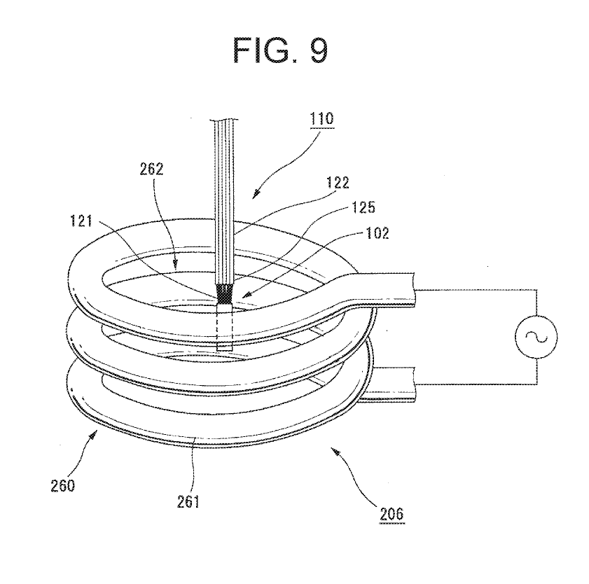

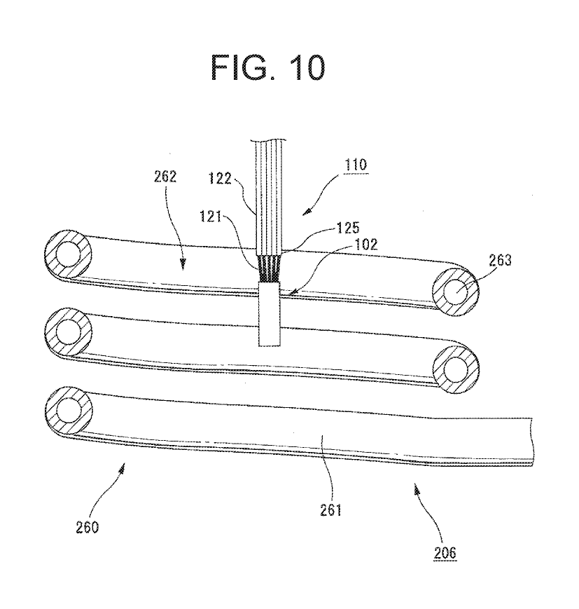

Hereinafter, the second mode of the method of manufacturing a protective structure will be described with reference to FIGS. 9 and 10. In FIGS. 9 and 10, the same reference signs as those in FIGS. 1 to 8 are attached to elements equivalent to those shown in FIGS. 1 to 8 and hereinafter, a repeated description of the same element is omitted.

<Example of the Heat-Up Process in the Second Mode of the Method of Manufacturing a Protective Structure>

The heat-up process is a process in which the temperature of the composite exposed portion 102 is heated up to the powder melting temperature or higher by using a heat-up unit and the process is not specifically limited if, when the composite exposed portion 102 in a heated state is immersed in the powder material 131 inside the immersion container 103 in a subsequent immersion process, the powder material 131 is melted (the powder material 131 around the composite exposed portion 102) and the melt is allowed to adhere to (adhere like covering) the composite exposed portion 102.

As a heat-up unit, for example, a process of applying an induction heating unit 206 as shown in FIG. 9 and induction heating the composite exposed portion 102 by the induction heating unit 206 for heat-up can be cited. The induction heating unit 206 shown in FIG. 9 has, for example, a heating coil portion 260 made of a conductive material 261 extending like a coil and is configured so that an alternating current can be passed to the heating coil portion 260.

According to the heat-up unit like the induction heating unit 206, as shown in, for example, FIG. 9, the composite exposed portion 102 (object to be heated) is arranged in an inner portion 262 (axial center side) of the heating coil portion 260 and when an alternating current is passed to the heating coil portion 260, the composite exposed portion 102 can be heated by induction heating (non-contact direct heating) without heating (melting), for example, the coating portion 122.

Compared with a case when the composite exposed portion 102 is heated by, for example, a common heating furnace, only the composite exposed portion 102 can locally be heated by induction swiftly and the heat-up efficiency (heating efficiency) is good and thus, miniaturization or cost reductions of facilities (particularly the heat-up unit) can be achieved or a higher cycle or energy saving concerning the formation of the protective member 104 can be achieved. In addition, scaling of the composite exposed portion 102 can be inhibited.

The shape (the number of winding, diameter, axial center direction length of the heating coil portion 260, the transverse section shape of the conductive material 261 and the like) of the heating coil portion 260, conducting conditions (the frequency of AC, conducting time and the like), the arrangement position (the spatial position, direction and the like in the inner portion 262) of the composite exposed portion 102 with respect to the inner portion 262 are not specifically limited and can appropriately be set in accordance with the heat capacity (heat capacity based on the specific heat, specific gravity, shape and the like), heat dissipation (temperature drop) characteristics, electric characteristics (electric conductivity, magnetic permeability and the like), and conditions (the powder melting temperature, immersion time and the like) of the subsequent immersion process of, for example, the composite exposed portion 102 to be heated.

If the composite exposed portion 102 is heated by induction heating as described above, heat of the composite exposed portion 102 is conducted to the coating portion 122 via the core wire 121 or the like and the temperature of the coating portion 122 may rise, but by setting conducting conditions of the heating coil portion 260 appropriately (for example, by shortening the conducting time), the temperature rise or melting of the coating portion 122 can be inhibited. If, for example, the composite exposed portion 102 is heated up to the powder melting temperature or higher in the heat-up process, the composite exposed portion 102 side (the edge 125 and the like) of the coating portion 122 may rise up to the powder melting temperature or higher, but if the composite exposed portion 102 side of the coating portion 122 rises up to a temperature lower than the coating melting temperature, melting is inhibited.

If an alternating current can be passed, as described above, the conductive material 261 is not specifically limited and, for example, applying a metallic material such as copper as the conductive material 261 can be cited. By adopting a configuration in which, as shown in FIG. 10, the conductive material 261 in a tubular shape having a hollow portion 263 is applied and a refrigerant can be circulated to the hollow portion 263, the temperature of the heating coil portion 260 can be inhibited from rising when an alternating current is passed to the heating coil portion 260.

<Example of the Reheat-Up Process in the Second Mode of the Method of Manufacturing a Protective Structure>

The reheat-up process is not specifically limited if the surface of the protective member 104 (including a half-melting state before complete setting) can be smoothed by heating the protective member 104 formed in the composite exposed portion 102 in the prior immersion process up to the powder melting temperature or higher. For example, like the aforementioned heat-up process, a process of applying the induction heating unit 206 as shown in FIGS. 9 and 10 to reheat the composite exposed portion 102 by induction heating and conducting heat of the composite exposed portion 102 to the protective member 104 for heat-up (heat-up by indirect heating) can be cited.

Heat-up conditions of the protective member 104 by the induction heating unit 206 in the reheat-up process can appropriately be set in accordance with the heat capacity (heat capacity based on the specific heat, specific gravity, shape and the like) and heat dissipation (temperature drop) characteristics of the protective member 104. Also, by setting the heat-up temperature of the protective member 104 to a range, for example, equal to or higher than the powder melting temperature and lower than the coating melting temperature, the protective member 104 can be heated while inhibiting melting of the coating portion 122. In addition, the induction heating unit 206 in the reheat-up process can appropriately be applied based on content of <Example of the heat-up process in the second mode of the method of manufacturing a protective structure> described above and a detailed description thereof is omitted.

The immersion process and the reheat-up process described above may each be performed once, but may also be alternately repeated in accordance with the intended protective member 104.

<Example 1 According to the Second Mode of the Method of Manufacturing a Protective Structure>

Based on the content described above, we tried to produce a protective structure using the protective member 104 in the composite exposed portion 102 that may be formed in an automobile wire harness. First, as shown in FIG. 1, the composite electric wire 110 made of a plurality of the cables 120 and applicable to an automobile wire harness is prepared, the coating portion 122 at an end of the composite electric wire 110 is peeled to expose the core wires 121, and the exposed core wires 121 are bundled and welded to form the composite exposed portion 102 having the welded portion 123.

Next, the composite exposed portion 102 is heated by induction heating up to about 120° C. by applying the induction heating unit 206, arranging the composite exposed portion 102 of the composite electric wire 110 in the inner portion 262 of the heating coil portion 260, and passing an alternating current to the heating coil portion 260 by the heat-up process as shown in FIGS. 9 and 10. Then, the heated composite exposed portion 102 is immersed (immersed swiftly after heat-up) in the powder material 131 with which the immersion portion 134 of the immersion container 103 is filled by the immersion process as shown in FIG. 2 and after holding the immersed state for about 30 sec, the composite exposed portion 102 is taken out of the immersion portion 134. Incidentally, a material using a polyamide thermoplastic resin (Platamid manufactured by Arkema, product number: HX2544PRA170) and pulverized to about 80 μm to 170 μm in average particle size is applied as the powder material 131.

The observation of the composite exposed portion 102 taken out of the immersion portion 134 shows that the melt of the powder material 131 adheres like covering the composite exposed portion 102 and the melt is set after the temperature thereof drops to form the protective member 104 as shown in FIG. 3A. When, in addition to the composite exposed portion 102, the edge 125 of the coating portion 122 is heated up to about 120° C. by the heat-up process, the protective member 104 covering the composite exposed portion 102 and the edge 125 is formed.

The protective member 104 covers the outer circumferential side of the composite exposed portion 102 (or the composite exposed portion 102 and the edge 125) without gap and is also formed by sealing the space between, for example, the underhead portion 124 side of the composite exposed portion 102 and the coating portion 122 without any gap, confirming that electric wire characteristics (insulation properties, resistance to water, durability and the like) required of an automobile wire harness can sufficiently be provided.

Then, the composite exposed portion 102 having the protective member 104 formed as described above is again arranged in the inner portion 262 of the heating coil portion 260 and the composite exposed portion 102 is induction-heated by passing an alternating current to the heating coil portion 260 to indirectly heat the protective member 104 up to about 120° C. (reheat-up process) and then, the observation confirms that the surface of the protective member 104 is smoothed as shown in FIG. 3B.

<Example 2 According to the Second Mode of the Method of Manufacturing a Protective Structure>

We also tried to produce a protective structure using the protective member 104 for the composite electric wire 110 applicable to an automobile wire harness and in which the composite exposed portion 102 is formed, as shown in FIGS. 4 to 7, in a center portion thereof. First, using a technique similar to that of Example 1, the composite exposed portion 102 is heated up to about 120° C. by applying the induction heating unit 206 in the heat-up process as shown in FIGS. 9 and 10. Then, the heated composite exposed portion 102 is immersed (immersed swiftly after heat-up) in the powder material 131 with which the immersion portion 134 of the immersion container 103 is filled by the immersion process as shown in FIGS. 6 and 7 and after holding the immersed state for about 30 sec, the composite exposed portion 102 is taken out of the immersion portion 134. The powder material 131 similar to that in Example 1 is applied.

The observation of the composite exposed portion 102 taken out of the immersion portion 134 shows that the melt of the powder material 131 adheres like covering the composite exposed portion 102 and the melt is set after the temperature thereof drops to form the protective member 104 as shown in FIG. 6B. When, in addition to the composite exposed portion 102, the edge 125 of the coating portion 122 is heated up to about 120° C. by the heat-up process, the protective member 104 covering the composite exposed portion 102 and the edge 125 is formed.

The protective member 104 covers the outer circumferential side of the composite exposed portion 102 (or the composite exposed portion 102 and the edge 125) without gap and is also formed by sealing the space between, for example, the underhead portion 124 side of the composite exposed portion 102 and the coating portion 122 without any gap, confirming that electric wire characteristics (insulation properties, resistance to water, durability and the like) required of an automobile wire harness can sufficiently be provided.

Then, the protective member 104 is indirectly heated up to about 120° C. by induction heating the composite exposed portion 102 having the protective member 104 formed as described above by applying the induction heating unit 206 again (reheat-up process) and the observation confirms that the surface of the protective member 104 is smoothed (smoothed as shown in, for example, FIG. 3B).

Next, the third mode of the method of manufacturing a protective structure will be described. The third mode is equal to the first mode of the method of manufacturing a protective structure described above except that the composite exposed portion 102 is heated while the composite exposed portion 102 is immersed in the powder material 131. Hereinafter, the description focuses on differences of the third mode of the method of manufacturing a protective structure from the first mode of the method of manufacturing a protective structure and a repeated description of equal points is omitted.

In the third mode of the method of manufacturing a protective structure, first by including a configuration equal to that of the first mode of the method of manufacturing a protective structure, complicated processes of the conventional technique are not needed and even if the shape of the exposed portion is diverse, a protective member can be formed by allowing an insulating polymeric material to adhere to the exposed portion by heating the exposed portion to the melting temperature of the insulating polymeric material or higher using the induction heating unit positioned on the outer circumferential side of the immersion container while the exposed portion is immersed in the powder insulating polymeric material in the immersion container. Compared with a case when a protective member is formed by the molding process and the covering process of the conventional technique, the third mode of the method of manufacturing a protective structure by undergoing the immersion/heat-up process as described above can be considered to be simple and easy from various viewpoints.

That is, in the third mode of the method of manufacturing a protective structure, compared with the conventional technique, the exposed portion can easily be protected with a smaller number of processes and obtaining desired electric wire characteristics such as insulation properties, resistance to water, and durability can be considered to be certainly possible. In addition, the storage location and a molding machine needed for the conventional technique are not needed so that work efficiency can be increased by securing sufficient work space or facilities can be reduced in size or costs thereof can be reduced. Further, a protective member may be formed by undergoing the immersion/heat-up process as described above when an exposed portion should be protected so that costs can be reduced by avoiding waste related to the protective member. Therefore, when an exposed portion of a composite electric wire, for example, an automobile wire harness or the like is protected by forming a protective member, it is certainly possible to produce the composite electric wire and the protective member by the same facilities (for example, existing automobile wire harness facilities).

Also, only the core wire of the cable, for example, only the exposed portion can be heated locally by applying the induction heating unit as a heat-up unit of the exposed portion and thus, melting of the coating portion of the cable can be prevented in the immersion/heat-up process or a contribution to a higher cycle or energy saving concerning the formation of a protective structure can be made.

In the third mode of the method of manufacturing a protective structure, if a protective member can be formed by allowing an insulating polymeric material to adhere to an exposed portion to protect the exposed portion as described above, technologies known generally in various fields such as the automobile field, electric wire field, terminal field, welding field, powder coating field, induction heating field, insulating polymeric material field and the like can be applied to appropriately design a protective structure and, for example, examples as shown below can be cited.

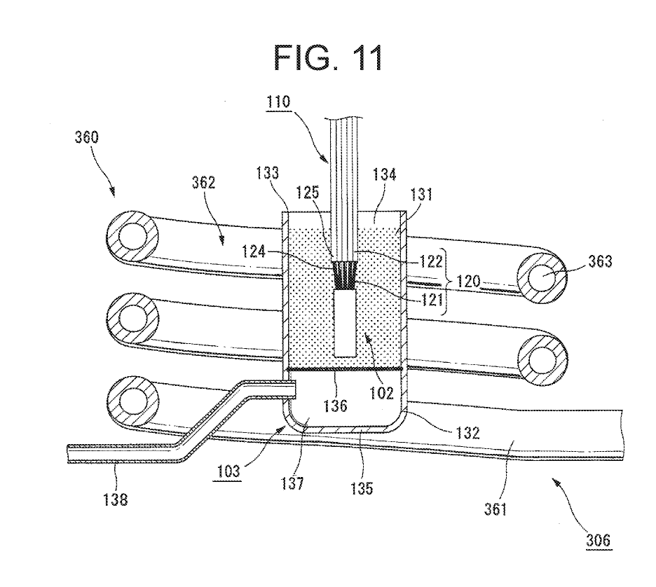

Hereinafter, the third mode of the method of manufacturing a protective structure will be described with reference to FIGS. 11 to 14. In FIGS. 11 to 14, the same reference signs as those in FIGS. 1 to 8 are attached to elements equivalent to those shown in FIGS. 1 to 8 and hereinafter, a repeated description of the same element is omitted.

<Example of the Immersion Container of the Immersion/Heat-Up Process in the Third Mode of the Method of Manufacturing a Protective Structure>

The immersion/heat-up process can be performed by using the general powder coating method when appropriate and, for example, the immersion coating method using the immersion container 103 as shown in, for example, FIGS. 11, 12, and 13 can be used.

Various modes can be applied to the immersion container 103 in accordance with the shape or the like of the immersed composite exposed portion 102 and any mode allowing the immersion container 103 to be sufficiently filled with the powder material 131 and allowing the composite exposed portion 102 to be immersed in the powder material 131 may be used. As a concrete example, as shown in FIGS. 11, 12, and 13, a configuration including the peripheral wall 132 in a closed-end cylindrical shape, the immersion portion 134 formed on the side of the opening 133 inside the peripheral wall 132, the gas jetting portion 137 formed on the side of the bottom wall 135 inside the peripheral wall 132 and partitioned from the immersion portion 134 by the partition wall 136, and the supply portion 138 communicatively connecting an outer circumferential side of the peripheral wall 132 and the gas jetting portion 137 and capable of supplying a gas to the gas jetting portion 137 can be cited. It is preferable to prevent melting by induction heating of an induction heating unit 306 described below by forming the immersion container 103 using a material having, for example, insulation properties and heat resistance.

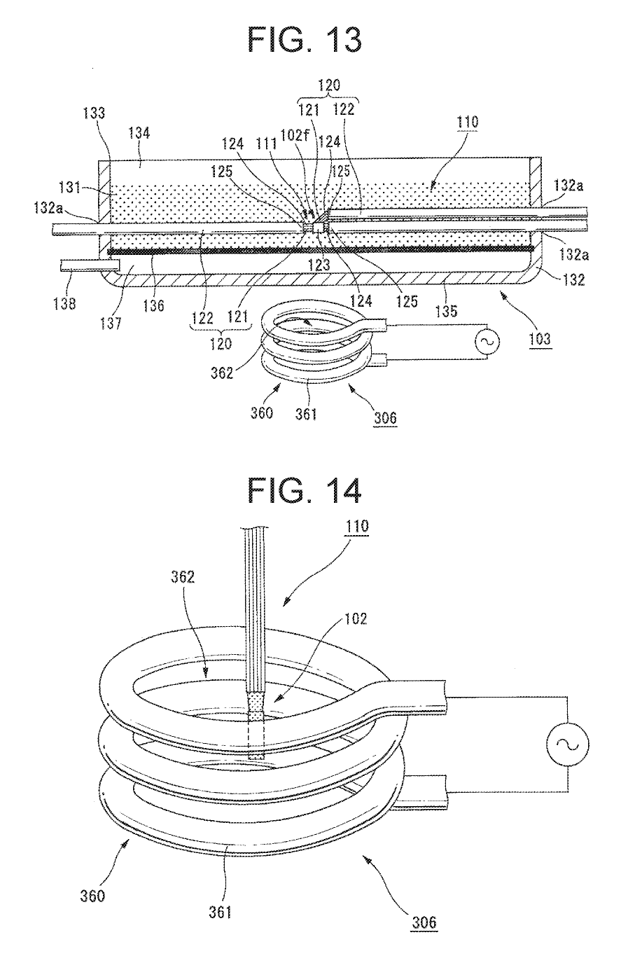

In the immersion container 103 shown in FIG. 13, a through hole 132a (three holes in FIG. 13) is formed on the immersion portion 134 side of the peripheral wall 132 and the through hole 132a is configured to allow a portion (both ends in FIG. 13) of the composite electric wire 110 to pass through. By adopting such a configuration, for example, as illustrated in FIG. 13, the composite exposed portion 102 can be immersed in the immersion portion 134 while extending the composite electric wire 110 linearly. In the configuration including the through hole 132a as described above, as shown in FIG. 13, the powder material 131 inside the immersion portion 134 can be inhibited from leaking out to the outer circumferential side of the peripheral wall 132 even in a state in which a portion of the composite electric wire 110 passes through the through hole 132a by an appropriate design (for example, by providing a check valve outside FIG. 13 or the like in the through hole 132a).

A porous structure in which a plurality of holes (not shown) of shape substantially equal to the size of the powder material 131 or less than the size of the powder material 131 is punched can be applied as the partition wall 136 of the gas jetting portion 137 and, for example, a partition wall obtained by sintering, fiber cloth, or machining can be cited. By using the immersion container 103 having the partition wall 136 as described above, a gas supplied to the gas jetting portion 137 via the supply portion 138 is equally jetted (for example, jetted under the atmospheric pressure) to the immersion portion 134 via each hole of the partition wall 136, which makes the powder material 131 inside the immersion portion 134 easier to flow. In a state in which the powder material 131 is made to flow, it is easier to immerse the composite exposed portion 102 in the powder material 131.

The gas supplied from the supply portion 138 is not specifically limited, but applying an inert gas such as air, dry air, nitrogen, and dry nitrogen can be cited. Concerning the flow rate of gas, setting the flow rate appropriately in accordance with the particle size, distribution, shape, density and the like of the powder material 131 with which the immersion portion 134 is filled can be cited. For example, the flow rate can be set based on a linear speed (cm/min) of the value obtained by dividing a gas flow rate (cm³/min) by an effective area (effective area (cm²) of a region of the immersion portion 134 in which the gas is jetted equally). For example, setting 0.5 cm/min to 50 cm/min (more desirably, 1 cm/min to 20 cm/min) can be cited.

<Example of the Heat-Up Unit of the Immersion/Heat-Up Process in the Third Mode of the Method of Manufacturing a Protective Structure>

When the protective member 104 is formed by a general immersion coating method, for example, a technique (hereinafter, called a post-heating immersion technique) by which the composite exposed portion 102 is heated by the heat-up unit such as a heating furnace for heat-up (that is, heat-up before immersion) and then, the heated composite exposed portion 102 is immersed in the immersion container 103 to allow the melt of the powder material 131 to adhere to the composite exposed portion 102 can be considered.

However, if the post-heating immersion technique is simply applied, the thickness of the melt increases over time in a fixed immersion time after starting the immersion of the composite exposed portion 102, but after the fixed immersion time, the thickness of the melt is considered to be constant or nonuniform (the surface state is coarse) because the temperature of the composite exposed portion 102 drops below the powder melting temperature. For example, depending on the shape of the composite exposed portion 102, it may be difficult for the melt to be fixed (for example, when the melt peels off) or the melt may dangle so that the thickness may become nonuniform. Such a trend may also be observed when the heat-up temperature by the heating furnace is too low or too high.

Thus, in the third mode of the method of manufacturing a protective structure, a technique by which the composite exposed portion 102 immersed in the powder material 131 inside the immersion container 103 is heated by induction heating of the induction heating unit 306 as shown in, for example, FIGS. 11, 12, and 13 is applied. The induction heating unit 306 includes, as shown in, for example, FIGS. 11, 12, and 13, a heating coil portion 360 having a conductive material 361 extending like a coil and applying a configuration allowing the induction heating unit 306 to be arranged on the outer circumferential side of the immersion container 103 can be cited.

According to the heat-up unit such as the induction heating unit 306, as shown in, for example, FIGS. 11, 12, and 13, even in a state in which the composite exposed portion 102 is immersed in the powder material 131 inside the immersion container 103, the composite exposed portion 102 can be heated by induction heating (non-contact direct heating) by passing an alternating current to the heating coil portion 360 without heating (melting), for example, the coating portion 122. Then, the powder material 131 around the composite exposed portion 102 is melted by heat of the heated composite exposed portion 102 and the melt thereof adheres to (adheres by covering) the composite exposed portion 102.

Compared with the post-heating immersion technique by a heating furnace or the like, only the composite exposed portion 102 can locally be heated by induction heating swiftly and the heat-up efficiency (heating efficiency) is good and thus, miniaturization or cost reductions of facilities (particularly the heat-up unit) can be achieved or a higher cycle or energy saving concerning the formation of the protective member 104 can be achieved, In addition, scaling of the composite exposed portion 102 can be inhibited.

Further, by continuously passing a current to the heating coil portion 360, the composite exposed portion 102 immersed in the powder material 131 can be maintained at the power melting temperature or higher and the thickness of the protective member 104 can be controlled by easily adjusting the thickness of the melt allowed to adhere to the composite exposed portion 102.

The heating coil portion 360 only needs to be configured so that the composite exposed portion 102 immersed in the powder material 131 inside the immersion container 103 can be heated by induction heating from the outer circumferential side of the immersion container 103. Therefore, the shape (the number of winding, diameter, axial center direction length of the heating coil portion 360, the transverse section (or longitudinal section) shape of the conductive material 361, the position and the like) of the heating coil portion 360, conducting conditions (the frequency of AC, conducting time and the like), the arrangement position (the spatial position, direction and the like in an inner portion 362) of the immersion container 103 with respect to the inner portion 362 are not specifically limited and can appropriately be set in accordance with the heat capacity (heat capacity based on the specific heat, specific gravity, shape and the like), heat dissipation (temperature drop) characteristics, electric characteristics (electric conductivity, magnetic permeability and the like), the powder melting temperature of the powder material 131, and immersion conditions (details thereof will be described below) of, for example, the composite exposed portion 102 to be heated.

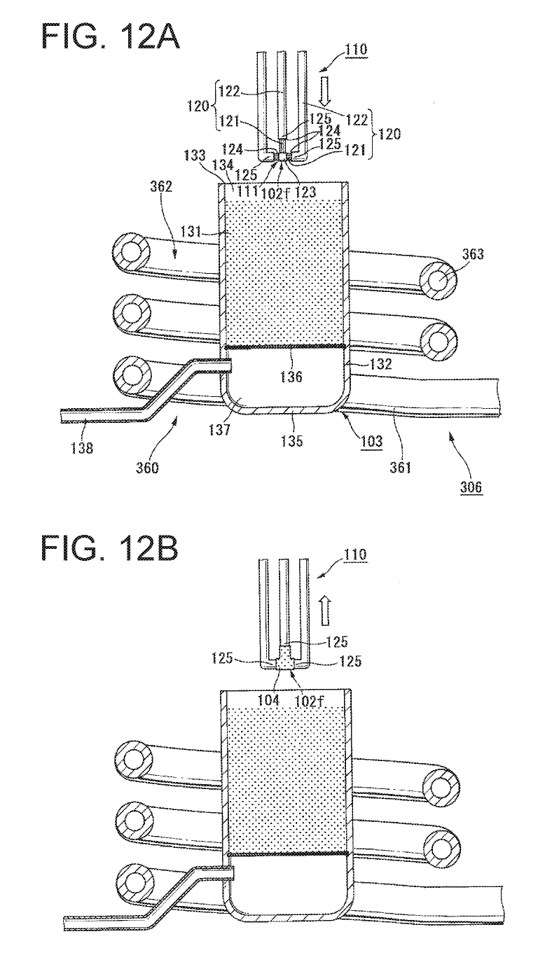

As a concrete example, as shown in FIGS. 11 and 12, applying the heating coil portion 360 having the conductive material 361 extending like a coil so as to be able to surround the outer circumferential side of the immersion container 103, wherein the inner portion 362 (axial center side) of the heating coil portion 360 is configured to be able to accommodate the immersion container 103 can be cited. Also, as shown in FIG. 13, a configuration having the conductive material 361 extending like a coil such that the immersion portion 134 of the immersion container 103 is positioned in the axial center direction of the inner portion 362 and allowing the heating coil portion 360 to be arranged on the bottom wall 135 side of the immersion container 103 can be cited.

If the composite exposed portion 102 is heated by induction heating as described above, heat of the composite exposed portion 102 is conducted to the coating portion 122 via the core wire 121 or the like and the temperature of the coating portion 122 may also rise, but by setting conducting conditions of the heating coil portion 360 appropriately (for example, by shortening the conducting time), the temperature rise or melting of the coating portion 122 can be inhibited. If, for example, the composite exposed portion 102 is heated up to the powder melting temperature or higher by the induction heating, the composite exposed portion 102 side (the edge 125 and the like) of the coating portion 122 may rise up to the powder melting temperature or higher, but if the composite exposed portion 102 side of the coating portion 122 rises up to a temperature lower than the coating melting temperature, melting is inhibited.

If an alternating current can be passed, as described above, the conductive material 361 is not specifically limited and, for example, applying a metallic material such as copper as the conductive material 361 can be cited. By adopting a configuration in which, as shown in FIG. 11, the conductive material 361 in a tubular shape having a hollow portion 363 is applied and a refrigerant can be circulated to the hollow portion 363, the temperature of the heating coil portion 360 can be inhibited from rising when an alternating current is passed to the heating coil portion 360.

<Example of Immersion Conditions for the Immersion/Heat-Up Process in the Third Mode of the Method of Manufacturing a Protective Structure>

Immersion conditions in the immersion/heat-up process, for example, the immersion time and immersion position (the spatial position, direction and the like during immersion and the state of the composite electric wire 110 during immersion and the like) of the composite exposed portion 102 with respect to the immersion portion 134 of the immersion container 103 can appropriately be set in accordance with the heat capacity (heat capacity based on the specific heat, specific gravity, shape and the like), heat dissipation (temperature drop) characteristics, and the shape of the composite exposed portion 102, the powder melting temperature, the configuration of the induction heating unit 306, and the shape and the like of the intended protective member 104.

If, for example, the composite exposed portion 102 is formed at an end of the composite electric wire 110, as shown in FIG. 11, immersing the composite exposed portion 102 side of the composite electric wire 110 in the immersion portion 134 can be cited. If the composite exposed portion 102 is formed in a center portion of the composite electric wire 110, immersing the composite exposed portion 102 side in the immersion portion 134 after, as shown in FIGS. 12A and 12B, the composite electric wire 110 is bent using the composite exposed portion 102 side as a base point (in FIGS. 12A and 12B, each of the cables 120 is bent and bundled) or after, as shown in FIG. 13, the composite electric wire 110 is extended linearly can be cited.

While FIGS. 11, 12, and 13 show a state in which, in addition to the composite exposed portion 102, the coating portion 122 (a portion (such as the edge 125) or all thereof) is immersed in the immersion portion 134, if the temperature of the coating portion 122 is lower than the powder melting temperature, the adhesion of melt of the powder material 131 to the coating portion 122 (for example, the edge 125) is inhibited and also the protective member 104 can be formed such that a space between the side of an underhead portion 124 of the composite exposed portion 102 and the coating portion 122 can be sealed without any gap. On the other hand, as described in, for example, <Example of the heat-up unit in the immersion/heat-up process in the third mode of the method of manufacturing a protective structure>, if the temperature of the edge 125 of the coating portion 122 is equal to or higher than the power melting temperature (and lower than the coating melting temperature) due to heat-up of the composite exposed portion 102, the melt of the powder material 131 adheres, in addition to the composite exposed portion 102, to the edge 125, the protective member 104 is formed like covering the composite exposed portion 102 and the edge 125 (the protective member 104 covering the edge 125 is not shown), and, for example, the space between the underhead portion 124 side of the composite exposed portion 102 and the coating portion 122 is more sealed without any gap.

If, in the composite exposed portion 102 (or/and the coating portion 122), for example, any location that does not need (or temporarily does not need) covering by the protective member 104 exists, it is preferable to perform the immersion process by appropriately masking the relevant location. Further, the immersion process may be performed not simply once, but may be repeated a plurality of times. Also, the reheat-up process described below may be performed when necessary.

<Example of the Reheat-Up Process in the Third Mode of the Method of Manufacturing a Protective Structure>

The reheat-up process is not specifically limited if the surface of the protective member 104 (including a half-melting state before complete setting) can be smoothed by heating the protective member 104 formed in the composite exposed portion 102 in the prior immersion/heat-up process up to the powder melting temperature or higher. For example, like the aforementioned immersion/heat-up process, applying the induction heating unit 306 can be considered. As a concrete example, as shown in, for example, FIG. 14, a process of arranging the composite exposed portion 102 (protective member 104) in the inner portion 362 (axial center side) of the heating coil portion 360 and passing an alternating current to the heating coil portion 360 to reheat the composite exposed portion 102 by induction heating so that heat of the composite exposed portion 102 is conducted to the protective member 104 for heat-up (heat-up by indirect heating) can be cited.

Heat-up conditions of the protective member 104 by the induction heating unit 306 in the reheat-up process can appropriately be set in accordance with the heat capacity (heat capacity based on the specific heat, specific gravity, shape and the like) and heat dissipation (temperature drop) characteristics of the protective member 104. Also, by setting the heat-up temperature of the protective member 104 to a range, for example, equal to or higher than the powder melting temperature and lower than the coating melting temperature, the protective member 104 can be heated while inhibiting melting of the coating portion 122. In addition, the induction heating unit 306 in the reheat-up process can appropriately be applied based on content of <Example of the heat-up unit of the immersion/heat-up process in the third mode of the method of manufacturing a protective structure> described above and a detailed description thereof is omitted.

The immersion/heat-up process and the reheat-up process described above may each be performed once, but may also be alternately repeated in accordance with the intended protective member 104.

<Example 1 According to the Third Mode of the Method of Manufacturing a Protective Structure>

Based on the content described above, we tried to produce a protective structure using the protective member 104 in the composite exposed portion 102 that may be formed in an automobile wire harness. First, as shown in FIG. 1, the composite electric wire 110 made of a plurality of the cables 120 and applicable to an automobile wire harness is prepared, the coating portion 122 at an end of the composite electric wire 110 is peeled to expose the core wires 121, and the exposed core wires 121 are bundled and welded to form the composite exposed portion 102 having the welded portion 123.

Next, the composite exposed portion 102 is heated up to about 120° C. by induction heating by passing an alternating current to the heating coil portion 360 of the induction heating unit 306 positioned on the outer circumferential side of the immersion container 103 while the composite exposed portion 102 is immersed in the powder material 131 inside the immersion container 103 by the immersion/heat-up process as shown in FIG. 11 and the heated state is maintained for about 30 sec. Incidentally, a material using a polyamide thermoplastic resin (Platamid manufactured by Arkema, product number: HX2544PRA170) and pulverized to about 80 μm to 170 μm in average particle size is applied as the powder material 131.

Then, the observation of the composite exposed portion 102 taken out of the immersion portion 134 shows that the melt of the powder material 131 adheres like covering the composite exposed portion 102 and the melt is set after the temperature thereof drops to form the protective member 104 as shown in FIG. 3A. Incidentally, when, in addition to the composite exposed portion 102, the edge 125 of the coating portion 122 is heated up to about 120° C. in the immersion/heat-up process, the protective member 104 covering the composite exposed portion 102 and the edge 125 is formed.

The protective member 104 covers the outer circumferential side of the composite exposed portion 102 (or the composite exposed portion 102 and the edge 125) without gap and is also formed by sealing the space between, for example, the underhead portion 124 side of the composite exposed portion 102 and the coating portion 122 without any gap, confirming that electric wire characteristics (insulation properties, resistance to water, durability and the like) required of an automobile wire harness can sufficiently be provided.

Further, the composite exposed portion 102 having the protective member 104 formed as described above is again arranged in the inner portion 362 of the heating coil portion 360 as shown in FIG. 14 and the composite exposed portion 102 is induction-heated by passing an alternating current to the heating coil portion 360 to indirectly heat the protective member 104 up to about 120° C. (reheat-up process) and then, the observation confirms that the surface of the protective member 104 is smoothed as shown in FIG. 3B,

<Example 2 According to the Third Mode of the Method of Manufacturing a Protective Structure>

We also tried to produce a protective structure using the protective member 104 for the composite electric wire 110 applicable to an automobile wire harness and in which the composite exposed portion 102 is formed, as shown in FIGS. 4, 11 to 13, in a center portion thereof. First, as shown in FIGS. 12 and 13, like in Example 1, the composite exposed portion 102 is heated up to about 120° C. by induction heating while the composite exposed portion 102 is immersed in the powder material 131 inside the immersion container 103 and the heated state is maintained for about 30 sec. The powder material 131 similar to that in Example 1 is applied.

Then, the observation of the composite exposed portion 102 taken out of the immersion portion 134 shows that the melt of the powder material 131 adheres like covering the composite exposed portion 102 and the melt is set after the temperature thereof drops to form the protective member 104 as shown in FIG. 12B. Incidentally, when, in addition to the composite exposed portion 102, the edge 125 of the coating portion 122 is heated up to about 120° C. in the immersion/heat-up process, the protective member 104 covering the composite exposed portion 102 and the edge 125 is formed.

The protective member 104 covers the outer circumferential side of the composite exposed portion 102 (or the composite exposed portion 102 and the edge 125) without gap and is also formed by sealing the space between, for example, the underhead portion 124 side of the composite exposed portion 102 and the coating portion 122 without any gap, confirming that electric wire characteristics (insulation properties, resistance to water, durability and the like) required of an automobile wire harness can sufficiently be provided.

Further, the protective member 104 is indirectly heated up to about 120° C. by induction heating the composite exposed portion 102 having the protective member 104 formed as described above by applying the induction heating unit 306 again (reheat-up process) and the observation confirms that the surface of the protective member 104 is smoothed (smoothed as shown in, for example, FIG. 3B).

Next, the method of manufacturing a cable that coats the outer circumferential side of a core wire or a plurality of bundled core wires with a coating portion made of an insulating polymeric material, the method of manufacturing a composite electric wire, and a production unit of a cable (hereinafter, called the method of manufacturing a cable) will be described. First, the first mode of the method of manufacturing a cable will be described.

In the first mode of the method of manufacturing a cable, instead of simply coating the outer circumferential side of a core wire with a coating portion like the technique of the general powder coating method or the extrusion molding method (hereinafter, called the conventional technique), any exposure target region of a core wire is prevented from being coated with a coating portion and only the coating target region positioned outside the exposure target region is coated with the coating portion.

When the conventional technique is applied, for example, cables of the same shape or electric characteristics (the diameter of a core wire, the thickness of a coating portion and the like) can be mass-produced (continuously), but such cables are stored in a predetermined storage location before being applied and also a molding machine needs to be installed and thus, upsizing or higher costs of facilities may be invited and further, the work space becomes narrower, which could degrade work efficiency (for example, work efficiency of bundling each cable or electrically connecting to an exposed portion) of each process in the facilities.

When a cable according to the conventional technique is applied to a composite electric wire, for example, an automobile wire harness or the like, it is necessary to produce the composite electric wire and the cable by separate facilities or to prepare large facilities. Even if a cable fitting to the intended composite electric wire can be produced, when the design of the composite electric wire is changed (for example, when a cable of different electric wire characteristics is requested), it is necessary to produce a new cable in response to the design change or reinforce the cable using reinforcing tape (such as changing the thickness of the coating portion), which makes it difficult to achieve delayed differentiation.

Then, when a cable according to the conventional technique is applied, a removal process that removes the coating portion coating an exposure target region by peeling or the like is needed, which degrades handleability and may also cause waste of materials related to the cable. When a general injection molding method is applied, the method may be considered to be able to coat only the coating target region of a core wire, but a mold is needed for each cable and waste due to a material remaining in a so-called runner or the like may arise.

On the other hand, according to the first mode of the method of manufacturing a cable, only the coating target region of a core wire is coated with a coating portion and the removal process of the conventional technique is not needed, which enhances handleability and waste of a material related to the cable can also be avoided. Even if the shape or electric wire characteristics of the intended cable are diverse, for example, a one-wire mode of the core wire, a mode bundling a plurality of wires, and a mode in which a branching portion is formed (for example, a mode of a composite electric wire), the intended cable can be obtained if the mode allows the coating target region of the core wire to be heated to the melting temperature of an insulating polymeric material or higher (heat-up process) and the core wire of the heated coating target region to be immersed in the powder insulating polymeric material inside an immersion container (immersion process). Compared with the conventional technique using an extrusion molding machine or the like, the heat-up process and the immersion process as described above can be considered to be simple and easy from various viewpoints.

That is, in the first mode of the method of manufacturing a cable, by undergoing the heat-up process and the immersion process described above using the core wire of the intended cable, the cable can be produced easily (more easily than when the conventional technique is used) and obtaining desired electric wire characteristics such as insulation properties, resistance to water, and durability can be considered to be certainly possible. In addition, the storage location and a molding machine needed for the conventional technique are not needed so that work efficiency can be increased by securing sufficient work space or facilities can be reduced in size or costs thereof can be reduced.

Further, when the intended cable is needed, core wires of the cable may be prepared to form the cable by undergoing the heat-up process and the immersion process described above and thus, cost reductions can be achieved by avoiding waste related to the cable and also delayed differentiation can be achieved. Therefore, it is certainly possible to produce the composite electric wire, for example, an automobile wire harness and the cable in the same facilities (for example, automobile wire harness facilities).

In the first mode of the method of manufacturing a cable, if, as described above, a cable can be produced by coating only the coating target region of a core wire with a coating portion, technologies known generally in various fields such as the automobile field, electric wire field, terminal field, powder coating field, insulating polymeric material field, welding field and the like can be applied to appropriately design a cable and, for example, an example of the method of manufacturing a cable or a composite electric wire can be cited.

<<Example of the First Mode of the Method of Manufacturing a Cable>>

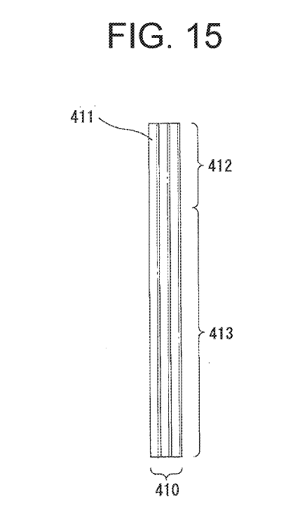

Reference numeral 410 in FIGS. 15 to 28 (details of each diagram will be described below when appropriate) is, for example, a configuration in which a plurality of wire-shaped or stranded element wires 411 is bundled and shows, for example, an example of a cable 401 that can be applied to a composite electric wire 402 such as an automobile wire harness.

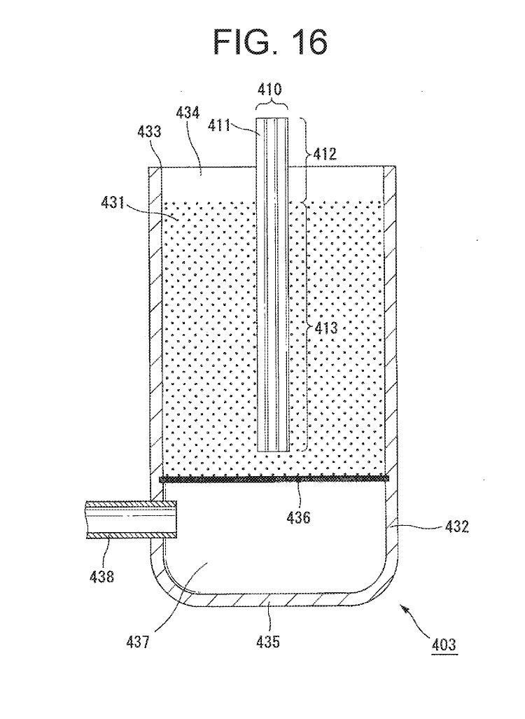

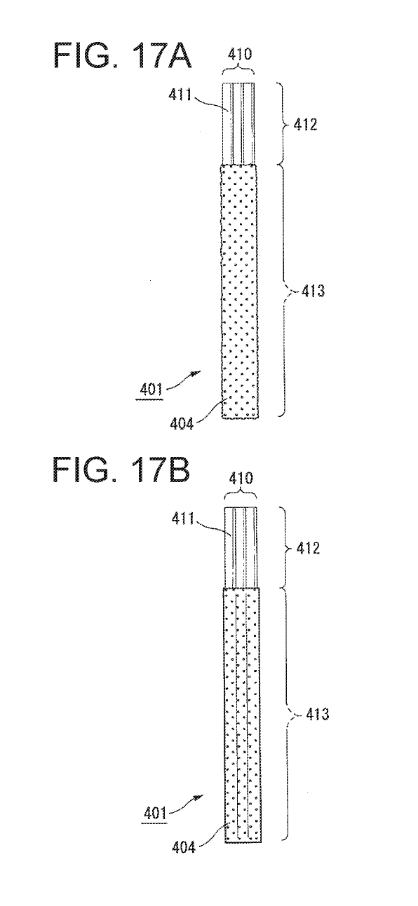

In the core wire 410, any portion, as shown in, for example, FIG. 15, a portion (one end in FIG. 15) of the core wire 410 is an exposure target region (corresponding to an exposed portion) 412 to connect a terminal or to electrically connect (for example, connecting one end or a center portion of the composite electric wire 402 by welding) to the other core wire 410 and a portion other than the exposure target region 412 is a coating target region 413 to be coated with a coating portion 404. Then, the cable 401 having desired electric characteristics can be obtained by coating, as shown in, for example, FIGS. 17A and 17B, the coating target region 413 of the core wire 410 with the coating portion 404 made of a powder material 431 (that is, an insulating polymeric material) by the technique using an immersion container 403 filled with, as shown in, for example, FIG. 16, the powder insulation polymeric material (hereinafter, simply called the powder material) 431.

In the technique using the immersion container 403, first the coating target region 413 is heated to the melting temperature of the powder material 431 (hereinafter, simply a power melting temperature) or higher by the heat-up process using a desired heat-up unit (for example, a heating furnace 406 described below or the like). Next, when the aforementioned coating target region 413 in a heated state is immersed in the powder material 431 inside the immersion container 403 as shown in, for example, FIG. 16 by the immersion process, the powder material 431 around the coating target region 413 is melted and the melt adheres like covering the coating target region 413. Then, the coating target region 413 is taken out of the immersion container 403 and when the melt drops to a temperature below the powder melting temperature and is set, as shown in FIGS. 17A and 17B, the coating portion 404 coating the coating target region 413 is formed. If the coating portion 404 rises in temperature up to the powder melting temperature or higher by, for example, the reheat-up process and softens, the surface thereof is smoothed (smoothed like in FIG. 17B in the case of, for example, the coating portion 404 in FIG. 17A) and the appearance thereof is improved.

<Example of the Core Wire in the First Mode of the Method of Manufacturing a Cable>

In the core wire 410, various modes can be applied depending on electric wire characteristics required of the intended cable 401 and the material, shape (the transverse section shape, the diameter and the like) and the like thereof can also be set appropriately in accordance with desired electric wire characteristics and, for example, a configuration formed by using one or a plurality of the element wires 411 obtained by molding a conductive material such as copper, aluminum, or an alloy like a wire or a stranded wire can be cited.

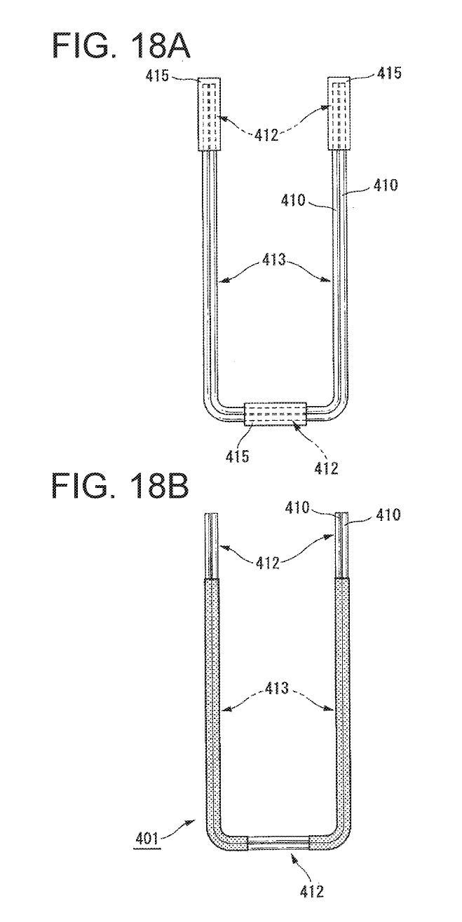

The exposure target region 412 and the coating target region 413 of the core wire 410 can appropriately be set according to purpose of use of the cable 401 and as an example thereof, as shown in FIGS. 15 to 17, setting the exposure target region 412 so as to be positioned on one end side (the upper side in FIG. 15) of the core wire 410 can be cited, but the selection thereof is not specifically limited. For example, as shown in FIGS. 18A and 18B, the center portion or both ends of the core wire 410 may be selected as the exposure target region 412.

The core wire 410 is not limited to a simple linear form as shown in FIGS. 15 to 17 and if the heat-up process and the immersion process described below can be undergone, various modes can be applied. For example, as shown in FIGS. 18, 19, and 21 to 27, a mode in which a plurality of the core wires 410 is bundled or a mode in which a branching portion 414 is formed may be adopted.

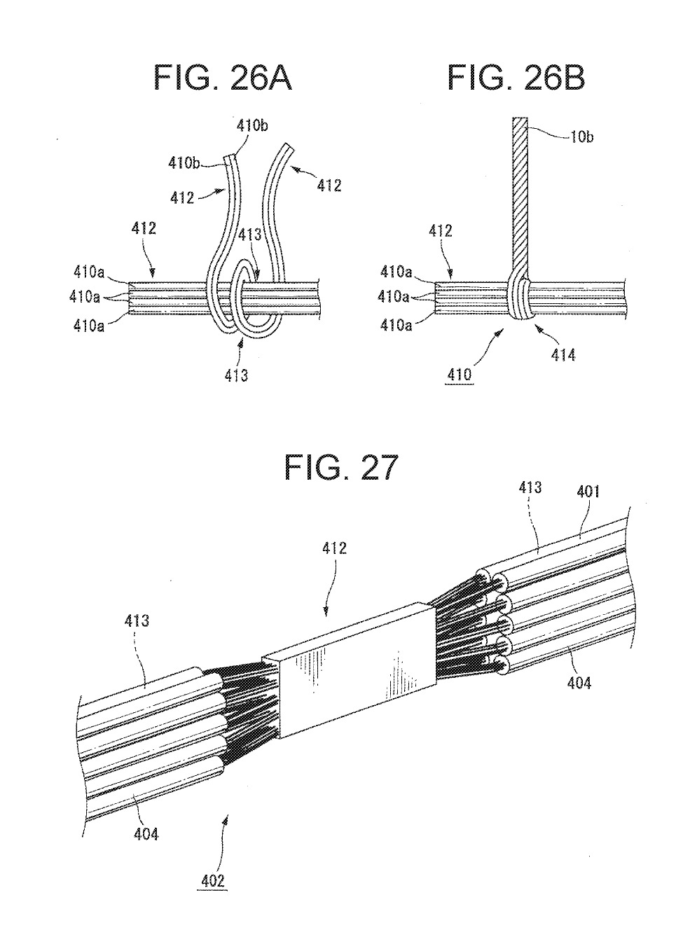

For the core wire 410 having the branching portion 414, for example, producing the core wire 410 by using the plurality of core wires 410 and performing welding (electric resistance welding, ultrasonic welding or the like) when appropriate can be cited. As a concrete example, first, as shown in FIG. 26A, a plurality of core wires 410a (core wire bundling four wires in FIG. 26A), 410b (core wire bundling two wires in FIG. 26A) is prepared and the center side (for example, the coating target region 413 side) of the core wire 410b is wound (wound, for example, like a coil) around the center side (for example, the coating target region 413 side) of the core wire 410a and tightened. Then, as shown in FIG. 26B, the core wire 410 in a mode in which the branching portion 414 is formed in the tightening location is formed by stranding both ends (for example, the exposure target region 412 side) of the tightened core wire 410b.

<Example of the Heat-Up Process in the First Mode of the Method of Manufacturing a Cable>

The heat-up process is a process in which the temperature of the coating target region 413 of the core wire 410 is heated up to the powder melting temperature or higher by using a heat-up unit and the process is not specifically limited if, when the coating target region 413 in a heated state is immersed in the powder material 431 inside the immersion container 403 in a subsequent immersion process, the powder material 431 is melted (the powder material 431 around the coating target region 413) and the melt is allowed to adhere to (adhere like covering) the coating target region 413.

For example, a process in which the heating furnace 406 as shown in FIG. 20 is applied as a heat-up unit and the coating target region 413 is heated by accommodating the core wire 410 in the inside 461 of the heating furnace 406 can be cited. Heat-up conditions by the heating furnace 406 can appropriately be set in accordance with the heat capacity (heat capacity based on the specific heat, specific gravity, shape and the like) and heat dissipation (temperature drop) characteristics of the coating target region 413 and conditions (the powder melting temperature, the immersion time and the like) of the subsequent immersion process.

In the exposure target region 412 of the core wire 410, maintaining the temperature thereof below the powder melting temperature at least immediately before the subsequent immersion process without heating in the heat-up process can be cited. If, for example, the exposure target region 412 is heated in the heat-up process, in addition to the coating target region 413, it is preferable to cool the exposure target region 412 to a temperature below the powder melting temperature when necessary. Accordingly, for example, in the subsequent immersion process, the melt of the powder material 431 can be inhibited from adhering to the exposure target region 412. Accordingly, for example, in the subsequent immersion process, the melt of the powder material 431 can be inhibited from adhering to the exposure target region 412.

<Example of the Immersion Process in the First Mode of the Method of Manufacturing a Cable>

The immersion process can be performed by appropriately using the general powder coating method and using, for example, an immersion coating method using the immersion container 403 as shown in, for example, FIGS. 16 and 21 to 25 can be cited. The immersion coating method is a method by which the intended coating target region 413 (surface or the like) of the core wire is heated (pre-heated) in advance by the aforementioned heat-up process or the like and the coating target region 413 in a heated state is immersed in the powder material 431 inside the immersion container 403 to melt the powder material 431 (the powder material 431 around the immersed coating target region 413) by heat of the coating target region 413 and to form the coating portion 404 in the coating target region 413 by allowing the melt to adhere to the coating target region 413.

Various modes can be applied to the immersion container 403 in accordance with the shape or the like of the immersed coating target region 413 and any mode allowing the immersion container 403 to be sufficiently filled with the powder material 431 and allowing the coating target region 413 to be immersed in the powder material 431 may be used. As a concrete example, as shown in FIGS. 16 and 21 to 25, a configuration including a peripheral wall 432 in a closed-end cylindrical shape, an immersion portion 434 formed on the side of an opening 433 inside the peripheral wall 432, a gas jetting portion 437 formed on the side of a bottom wall 435 inside the peripheral wall 432 and partitioned from the immersion portion 434 by a partition wall 436, and a supply portion 438 communicatively connecting an outer circumferential side of the peripheral wall 432 and the gas jetting portion 437 and capable of supplying a gas to the gas jetting portion 437 can be cited.

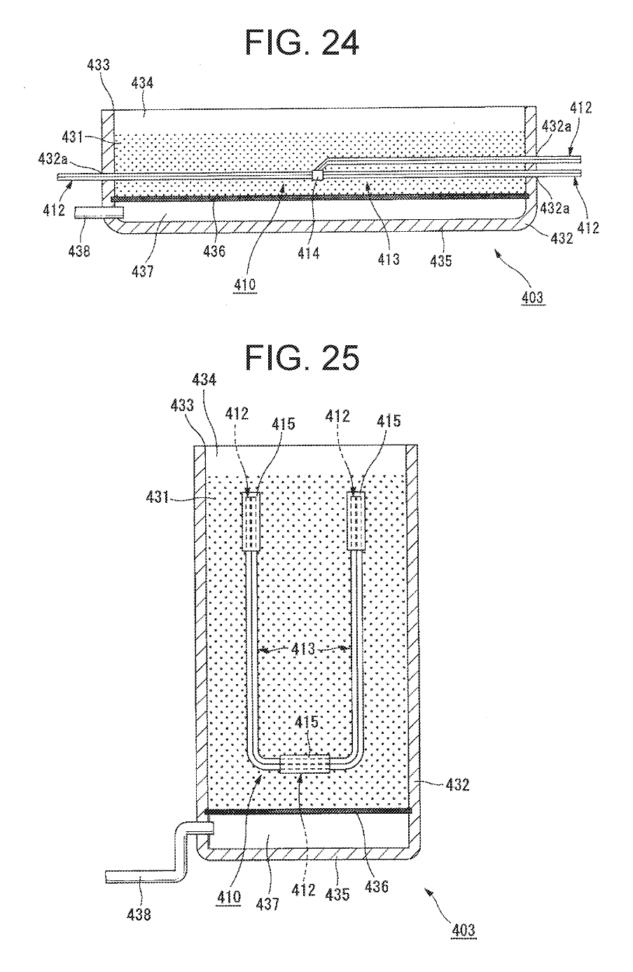

In the immersion container 403 shown in FIG. 24, a through hole 432a (three holes in FIG. 24) is formed on the immersion portion 434 side of the peripheral wall 432 and the through hole 432a is configured to allow a portion (exposure target region 412 in FIG. 24) of the core wire 410 to pass through. By adopting such a configuration, for example, as illustrated in FIG. 24, the coating target region 413 can be immersed in the immersion portion 434 while extending the core wire 410 linearly. In the configuration including the through hole 432a as described above, as shown in FIG. 24, the powder material 431 inside the immersion portion 434 can be inhibited from leaking out to the outer circumferential side of the peripheral wall 432 even in a state in which a portion of the core wire 410 passes through the through hole 432a by an appropriate design (for example, by providing a check valve outside FIG. 24 or the like in the through hole 432a).

A porous structure in which a plurality of holes (not shown) of shape equal to the size of the powder material 431 or less than the size of the powder material 431 is punched can be applied as the partition wall 436 of the gas jetting portion 437 and, for example, a partition wall obtained by sintering, fiber cloth, or machining can be cited. By using the immersion container 403 having the partition wall 436 as described above, a gas supplied to the gas jetting portion 437 via the supply portion 438 is equally jetted (for example, jetted under the atmospheric pressure) to the immersion portion 434 via each hole of the partition wall 436, which makes the powder material 431 inside the immersion portion 434 easier to flow. In a state in which the powder material 431 is made to flow, it is easier to immerse the coating target region 413 in the powder material 431.

The gas supplied from the supply portion 438 is not specifically limited, but applying an inert gas such as air, dry air, nitrogen, and dry nitrogen can be cited.

Concerning the flow rate of gas, setting the flow rate appropriately in accordance with the particle size, distribution, shape, density and the like of the powder material 431 with which the immersion portion 434 is filled can be cited. For example, the flow rate can be set based on a linear speed (cm/min) of the value obtained by dividing a gas flow rate (cm³/min) by an effective area (effective area (cm²) of a region of the immersion portion 434 in which the gas is jetted equally). For example, setting 0.5 cm/min to 50 cm/min (more desirably, 1 cm/min to 20 cm/min) can be cited.

<Example of the Powder Material in the Immersion Process in the First Mode of the Method of Manufacturing a Cable>

Concerning the powder material 431, applying the powder material 431 obtained by pulverizing, for example, the composition (for example, a pellet-shaped composition; hereinafter, simply the composition) of an insulating polymeric material, wherein the composition is pulverized to the extent that the coating portion 404 can be formed in the intended coating target region 413 (coated portion) by the aforementioned immersion coating method can be cited. For example, the powder material 431 pulverized to about a few tens of μm to a few hundred μm (as a concrete example, pulverized to about 80 μm to 170 μm) in average particle size can be cited, but the average particle size can appropriately be set in accordance with the intended coating target region 413 or the applied immersion coating method (for example, conditions of the heat-up process and the immersion process). The shape (the particle size, powder shape and the like) of the powder material 431 obtained by pulverization may change depending on the kind (the type, model and the like) of device used for pulverization or the pulverization time within a range to the extent that the coating portion 404 can be formed in the intended coating target region 413 by the immersion coating method as described above.

As the device used for pulverization, for example, applying various mill devices can be cited and as concrete examples, devices by rotation, impact, vibration and the line can be cited. Considerable heat is generated during pulverization by a mill device and the composition itself may unintendedly be melted (autohesion) or degraded. In such a case, cooling the whole mill device or a portion (portion related to pulverization) thereof or cooling (cooling by using a refrigerator, a freezer, liquid nitrogen or the like) the composition itself in advance can be considered. If the composition cannot be input into the mill device due to a large lump state or the like, the composition may coarsely be pulverized to the extent that the pulverized composition can be input.

As a method of preventing fusion (autohesion) and adhesion of powder in the powder material 431, applying the powder material 431 obtained by pulverizing a composition using the composition to which inorganic powder such as silica and calcium carbonate can be considered. The inorganic powder can appropriately be used to the extent that characteristics of the intended powder material 431 are not impaired and adding 0.1 wt % to 10 wt % of the inorganic powder having the average particle size of, for example, about 0.1 μm to 20 μm can be cited.

As a concrete example of the powder material 431, a material obtained by appropriately applying various additives used generally in the field of polymeric material molding technology, for example, heat stabilizers, light stabilizers (ultraviolet inhibitors), antioxidants, age inhibitors, pigments, coloring agents, inorganic fillers, small inorganic fillers (nanoparticles), fire retardants, antibacterial agents, and corrosion inhibitors to an insulating polymeric material such as a thermoplastic resin as a main component within a range that does not impair desired electric wire characteristics, wherein the material melts when heated up to a predetermined temperature (that is, the powder melting temperature) or more and sets when cooled below the predetermined temperature can be cited. As the main component (thermoplastic resin and the like), various insulating polymeric components of PVC, EVA, PA, polyester, polyolefin and the like can be cited.

<Example of Immersion in the Immersion Process in the First Mode of the Method of Manufacturing a Cable>

Immersion conditions in the immersion process, for example, the immersion time and immersion position (the spatial position, direction and the like during immersion and the state of the core wire 410 during immersion and the like) of the coating target region 413 with respect to the immersion portion 434 of the immersion container 403 can appropriately be set in accordance with the exposure target region 412 and the coating target region 413, the heat capacity (heat capacity based on the specific heat, specific gravity, shape and the like), heat dissipation (temperature drop) characteristics, the shape, and the powder melting temperature of the coating target region 413 and the shape and the like of the intended coating portion 404.

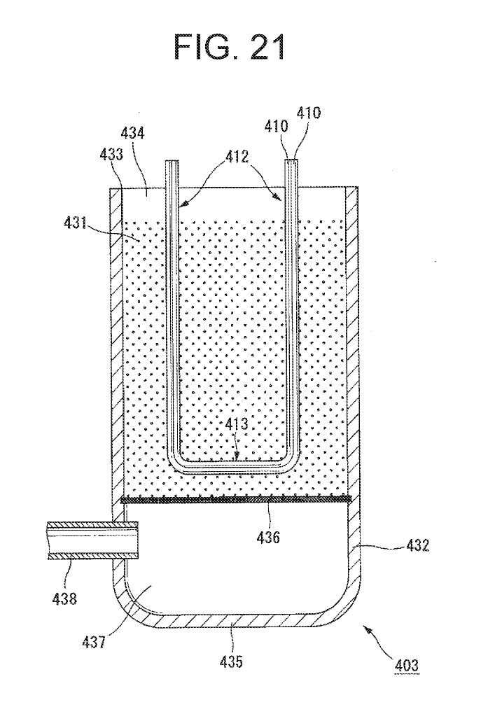

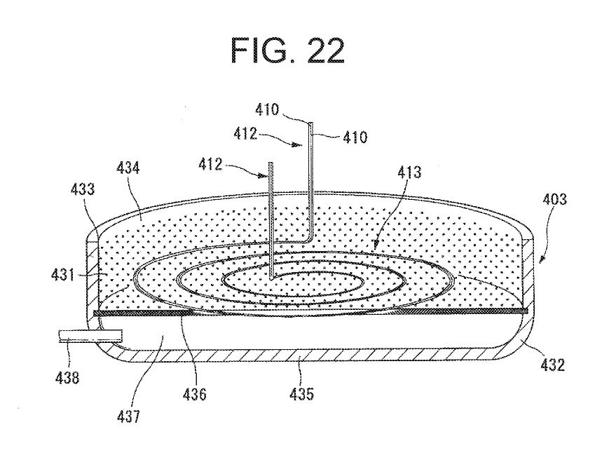

For example, as shown in FIG. 16, immersing one end of the core wire 410 in the immersion portion 434 while the core wire 410 is extended straight, as shown in FIG. 21, immersing a center side of the core wire 410 while the core wire 410 is bent (for example, in a U shape), and, as shown in FIG. 22, immersing the center side of the core wire 410 while the core wire 410 is compactly put together (for example, spirally as shown in FIG. 22).

Thus, even in a mode configured by bundling a plurality of the core wires 410 or configured by forming the branching portion 414 in the coating target region 413, by, as shown in, for example, FIGS. 21 to 25, appropriately immersing the coating target region 413 in the immersion portion 434 to coat the coating target region 413 with the coating portion 404, the intended cable 401 can be produced and cable 401 can also be applied as the composite electric wire 402.

Even if the exposure target region 412 (partially or wholly) may be immersed in the immersion portion 434, in addition to the coating target region 413, in the immersion process, the melt of the powder material 431 can be inhibited from adhering to the exposure target region 412 if the temperature of the exposure target region 412 is lower than the powder melting temperature. Also, if, as shown in, for example, FIGS. 18A and 25, the exposure target region 412 is appropriately masked by a masking member (for example, a masking tape) 415, the melt of the powder material 431 can be inhibited from adhering to the exposure target region 412. As an application example of the cable 401 produced by using the center side of the core wire 410 as the exposure target region 412 as shown in FIGS. 18A and 25, an example in which, as shown in, for example, FIG. 27, a plurality of the cables 401 is bundled and the exposure target region 412 of each of the cables 401 is welded and electrically connected to produce the composite electric wire 402 can be cited.

If, in the coating target region 413, any location that temporarily does not need the coating portion 404 exists, the immersion process may be performed by appropriately masking the relevant location. Further, the immersion process may be performed not simply once, but may be divided for a plurality of times or repeated. When the immersion process is divided and performed a plurality of times, various kinds (for example, multi-color) of the coating portion 404 can be formed for the coating target region 413 by changing the type of the powder material 431 for each immersion process.

The thickness of the melt (melt of the powder material 431) adhering to the coating target region 413 can be changed by appropriately adjusting immersion conditions or the heat-up temperature or the like of the heat-up process. Without adjustments of immersion conditions or the heat-up temperature or the like of the heat-up process, the thickness of the melt increases over time in a fixed immersion time after starting the immersion of the coating target region 413, but after the fixed immersion time, the thickness of the melt is considered to be constant or nonuniform (the surface state is coarse). For example, depending on the shape of the coating target region 413, it may be difficult for the melt to be fixed (for example, when peeling) or the melt may dangle so that the thickness may become nonuniform. Such a trend may also arise if the heat-up temperature in the heat-up process is too low or too high. In such a case, in addition to appropriately adjusting immersion conditions or the heat-up temperature or the like of the heat-up process as described above, it is preferable to perform the reheat-up process described below when appropriate.

<Example of the Reheat-Up Process in the First Mode of the Method of Manufacturing a Cable>

The reheat-up process is not specifically limited if the surface of the coating portion 404 (including a half-melting state before complete setting) can be smoothed by heating the coating portion 404 formed in the coating target region 413 in the prior immersion process up to the powder melting temperature or higher. For example, like the heat-up process described above, a process (description based on a diagram is omitted) in which the heating furnace 406 as shown in FIG. 20 is applied as a heat-up unit and the coating portion 404 is heated by accommodating the cable 401 in the inside 461 of the heating furnace 406 can be cited. Also, heat-up conditions by the heating furnace 406 in the reheat-up process can appropriately be set in accordance with the heat capacity (heat capacity based on the specific heat, specific gravity, shape and the like) and heat dissipation (temperature drop) characteristics of the coating portion 404.

The immersion process and the reheat-up process described above may each be performed once, but may also be alternately repeated in accordance with the intended coating portion 404.

<Example of the Cable and Composite Electric Wire in the First Mode of the Method of Manufacturing a Cable>

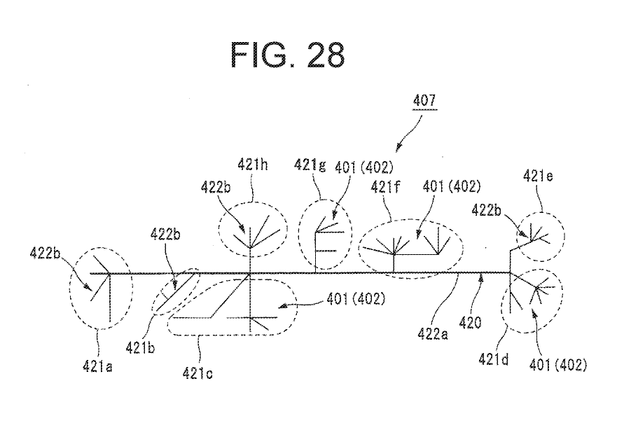

For the cable 401 and the composite electric wire 402 in the first mode of the method of manufacturing a cable, as shown in, for example, FIG. 28, a mode of usage of applying to a wire harness 407 in a configuration in which a plurality of twigs 421 (421a to 421h in FIG. 28) extends outwardly from both ends or a center side of a trunk line 420 can be cited, but is not limited to such an example.

The wire harness 407 as shown in FIG. 28 is constructed in, for example, assembly facilities, by attaching the twig 421 to the trunk line 420 or attaching various components from outside the diagram when necessary, but even if produced in small quantities or the specification is special, ready-made products may be applicable to a portion of the wire harness 407.

That is, the cable 401 and the composite electric wire 402 may be applied to all of the trunk line 420 and each of the twigs 421 of the wire harness 407, but the cable 401 and the composite electric wire 402 may also be applied to only a portion of the trunk line 420 and each of the twigs 421 when necessary so that ready-made wires (for example, ready-made products that can be mass-produced in large facilities or imported products; such as electric wires 422a, 422b described below) are applied for the rest.

As a concrete example, applying the cable 401 or the composite electric wire 402 according to the first mode of the method of manufacturing a cable to twigs 421c, 421d, 421f, 421g and applying the ready-made electric wires 422a, 422b to the trunk line 420 and twigs 421a, 421b, 421e, 421h can be cited.

In a mode of usage in which the cable 401 and the composite electric wire 402 are appropriately applied as described above, facilities (such as the immersion container 403) and materials (such as the powder material 431) needed to perform the heat-up process, the immersion process and the like (including the reheat-up process when necessary) related to the cable 401 and the composite electric wire 402 can be installed in, for example, the work space of existing assembly facilities of the wire harness 407 (each facility is integrated) so that the cables 401 or the composite electric wires 402 can be produced in number and mode as needed for the intended wire harness 407 when needed for the work, which makes it easier to achieve delayed differentiation.

<Example 1 According to the First Mode of the Method of Manufacturing a Cable>

Based on the content described above, we tried to produce the cable 401 applicable to an automobile wire harness (for example, the wire harness 407). First, as shown in FIG. 15, the core wire 410 made of a plurality of element wires 411 and applicable to an automobile wire harness is prepared.

Next, the core wire 410 is accommodated in the inside 461 of the heating furnace 406 as shown in FIG. 20 and the coating target region 413 is heated up to about 120° C. Then, the heated coating target region 413 is immersed (immersed swiftly after heat-up) in the powder material 431 with which the immersion portion 434 of the immersion container 403 is filled as shown in FIG. 16 and after holding the immersed state for about 30 sec, the coating target region 413 is taken out of the immersion portion 434. Incidentally, a material using a polyamide thermoplastic resin (Platamid manufactured by Arkema, product number: HX2544PRA170) and pulverized to about 80 μm to 170 μm in average particle size is applied as the powder material 431.

The observation of the coating target region 413 taken out of the immersion portion 434 shows that the melt of the powder material 431 adheres like covering the coating target region 413 and the melt is set after the temperature thereof drops to form the coating portion 404 as shown in FIG. 17A. The coating portion 404 coats the outer circumferential side of the coating target region 413 of the core wire 410 without gap and is also formed by sealing the space (border) between, for example, the exposure target region 412 and the coating target region 413 without any gap, confirming that electric wire characteristics (insulation properties, resistance to water, durability and the like) required of an automobile wire harness can sufficiently be provided.

Then, the cable 401 is again accommodated in the inside 461 of the heating furnace 406 and the coating portion 404 is heated up to about 120° C. and then, the observation of the cable 401 after being taken out of the inside 461 confirms that, as shown in FIG. 17B, the surface of the coating portion 404 is smoothed.

<Example 2 According to the First Mode of the Method of Manufacturing a Cable>

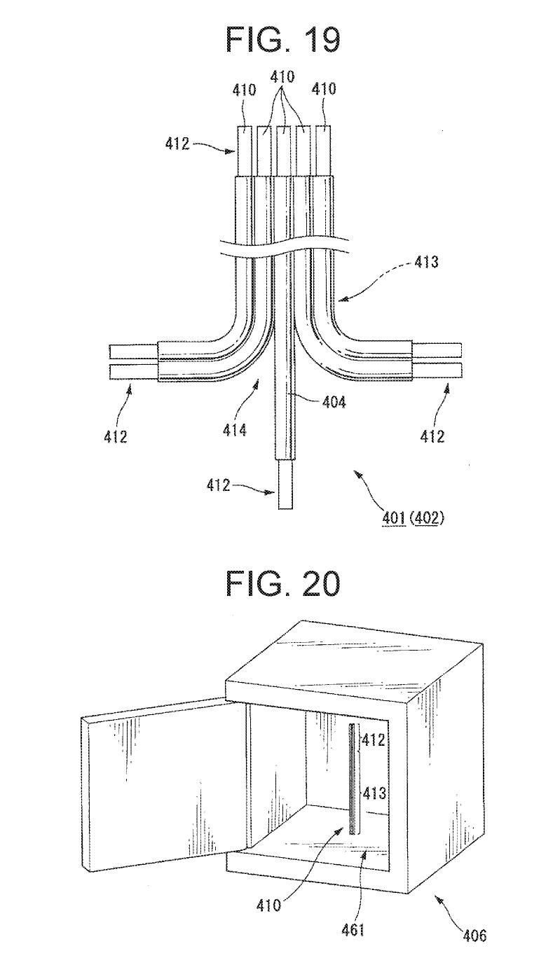

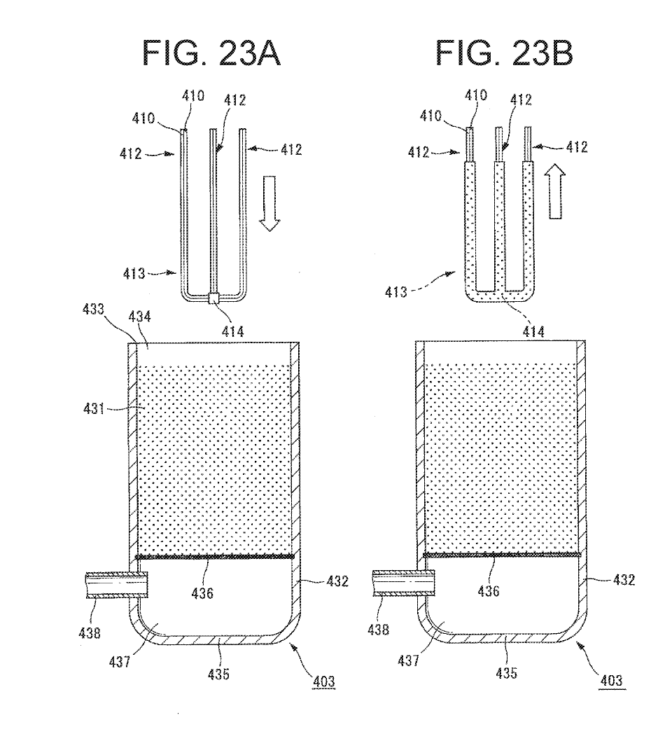

Next, the core wire 410 applicable to an automobile wire harness (for example, the wire harness 407) and having the branching portion 414 as shown in FIGS. 19, 23, 24, and 26 is prepared and the production of the composite electric wire 402 is tried. First, using a technique similar to that of Example 1, the core wire 410 having the branching portion 414 is accommodated in the inside 461 of the heating furnace 406 as shown in FIG. 20 and the coating target region 413 is heated up to about 120° C. Then, the heated coating target region 413 is immersed (immersed swiftly after heat-up) in the powder material 431 with which the immersion portion 434 of the immersion container 403 is filled as shown in FIGS. 23 and 24 and after holding the immersed state for about 30 sec, the coating target region 413 is taken out of the immersion portion 434. The powder material 431 similar to that in Example 1 is applied.

The observation of the coating target region 413 taken out of the immersion portion 434 shows that the melt of the powder material 431 adheres like covering the coating target region 413 and the melt is set after the temperature thereof drops to form the coating portion 404 as shown in, for example, FIG. 23B. The coating portion 404 covers the outer circumferential side of the coating target region 413 without gap and is also formed by sealing the space between, for example, the exposure target region 412 and the coating target region 413 (and the branching portion 414) without any gap, confirming that electric wire characteristics (insulation properties, resistance to water, durability and the like) required of an automobile wire harness can sufficiently be provided.

Then, the composite electric wire 402 is again accommodated in the inside 461 of the heating furnace 406 and the coating portion 404 is heated up to about 120° C. and then, the observation of the composite electric wire 402 after being taken out of the inside 461 confirms that the surface of the coating portion 404 is smoothed (smoothed as shown in, for example, FIG. 17B).

Next, the second mode of the method of manufacturing a cable will be described. The second mode of the method of manufacturing a cable is the same as the first mode of the method of manufacturing a cable except that induction heating is used for heat-up. Hereinafter, the description focuses on differences of the second mode of the method of manufacturing a cable from the first mode of the method of manufacturing a cable and a repeated description of equal points is omitted.

In the second mode of the method of manufacturing a cable, first by including a configuration equal to that of the first mode of the method of manufacturing a cable, only the coating target region of a core wire is coated with the coating portion and thus, handleability is high because the removal process of the conventional technique is not needed and also waste of the material related to the cable can be avoided. Even if the shape or electric wire characteristics of the intended cable are diverse, for example, a one-wire mode of the core wire, a mode bundling a plurality of wires, and a mode in which a branching portion is formed (for example, a mode of a composite electric wire), the intended cable can be obtained if the mode allows the coating target region of the core wire to be heated to the melting temperature of an insulating polymeric material or higher (heat-up process) and the core wire of the heated coating target region to be immersed in the powder insulating polymeric material inside an immersion container (immersion process). Compared with the conventional technique using an extrusion molding machine or the like, the heat-up process and the immersion process as described above can be considered to be simple and easy from various viewpoints.

That is, in the second mode of the method of manufacturing a cable, by undergoing the heat-up process and the immersion process described above using the core wire of the intended cable, the cable can be produced easily (more easily than when the conventional technique is used) and obtaining desired electric wire characteristics such as insulation properties, resistance to water, and durability can be considered to be certainly possible. In addition, the storage location and a molding machine needed for the conventional technique are not needed so that work efficiency can be increased by securing sufficient work space or facilities can be reduced in size or costs thereof can be reduced.

Further, when the intended cable is needed, core wires of the cable may be prepared to form the cable by undergoing the heat-up process and the immersion process described above and thus, cost reductions can be achieved by avoiding waste related to the cable and also delayed differentiation can be achieved. Therefore, it is certainly possible to produce the composite electric wire, for example, an automobile wire harness and the cable in the same facilities (for example, automobile wire harness facilities).

Also, by heating only the coating target region of the core wire, for example, locally heating only the coating target region by applying an induction heating unit in the heat-up process, heat-up of the exposure target region of the core wire can be prevented in the heat-up process or a contribution to a higher cycle or energy saving concerning the formation of a coating portion can be made.

In the second mode of the method of manufacturing a cable, if, as described above, a cable can be produced by coating only the coating target region of a core wire with a coating portion, technologies known generally in various fields such as the automobile field, electric wire field, terminal field, powder coating field, induction heating field, insulating polymeric material field, welding field and the like can be applied to appropriately design a cable and, for example, an example of the method of manufacturing a cable or a composite electric wire can be cited.

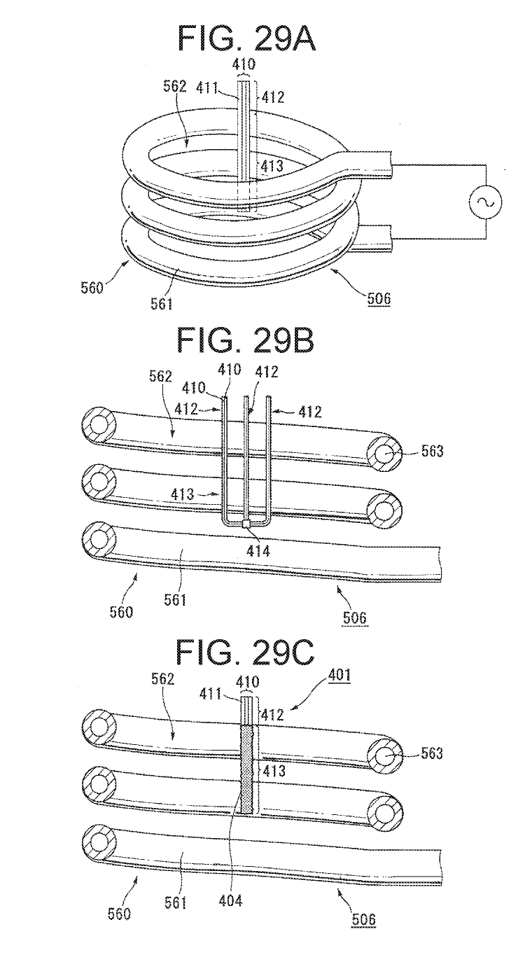

Hereinafter, the second mode of the method of manufacturing a cable will be described with reference to FIGS. 29A, 29B, and 29C. In FIGS. 29A, 29B, and 29C, the same reference signs as those in FIGS. 15 to 28 are attached to elements equivalent to those shown in FIGS. 15 to 28 and hereinafter, a repeated description of the same element is omitted.

<Example of the Heat-Up Process in the Second Mode of the Method of Manufacturing a Cable>

The heat-up process is a process in which the temperature of the coating target region 413 of the core wire 410 is heated up to the powder melting temperature or higher by using a heat-up unit and the process is not specifically limited if, when the coating target region 413 in a heated state is immersed in the powder material 431 inside the immersion container 403 in a subsequent immersion process, the powder material 431 is melted (the powder material 431 around the coating target region 413) and the melt is allowed to adhere to (adhere like covering) the coating target region 413.

For example, a process in which an induction heating unit 506 as shown in FIGS. 29A, 29B, and 29C is applied as a heat-up unit and the coating target region 413 is heated by the induction heating unit 506 can be cited. The induction heating unit 506 shown in FIGS. 29A, 29B, and 29C has, for example, a heating coil portion 560 made of a conductive material 561 extending like a coil and is configured so that an alternating current can be passed to the heating coil portion 560.

According to the heat-up unit like the induction heating unit 506, as shown in, for example, FIGS. 29A, 29B, and 29C, the coating target region 413 (object to be heated) is arranged in an inner portion 562 (axial center side) of the heating coil portion 560 and when an alternating current is passed to the heating coil portion 560, the coating target region 413 can be heated by induction heating (non-contact direct heating) without heating (heat-up), for example, the exposure target region 412.

Compared with a case when the coating target region 413 is heated by, for example, a common heating furnace, only the coating target region 413 can locally be heated by induction heating swiftly and the heat-up efficiency (heating efficiency) is good and thus, miniaturization or cost reductions of facilities (particularly the heat-up unit) can be achieved or a higher cycle or energy saving concerning the formation of the coating portion 404 can be achieved. In addition, scaling of the core wire 410 can be inhibited.

The shape (the number of winding, diameter, axial center direction length of the heating coil portion 560, the transverse section shape of the conductive material 561 and the like) of the heating coil portion 560, conducting conditions (the frequency of AC, conducting time and the like), the arrangement position (the spatial position, direction and the like in the inner portion 562 and the posture of the core wire 410) of the coating target region 413 with respect to the inner portion 562 are not specifically limited and can appropriately be set in accordance with the heat capacity (heat capacity based on the specific heat, specific gravity, shape and the like), heat dissipation (temperature drop) characteristics, electric characteristics (electric conductivity, magnetic permeability and the like), and conditions (the powder melting temperature, immersion time and the like) of the subsequent immersion process of, for example, the coating target region 413 to be heated.

For example, as the posture of the core wire 410 arranged with respect to the inner portion 562 of the heating coil portion 560, extending the core wire 410 straight as shown in FIG. 29A and putting the core wires 410 together (for example, as illustrated in FIG. 29B, the core wires 410 dispersed spirally from the branching portion 414 as a base point are put together) compactly as shown in FIG. 29B can be cited.

If the coating target region 413 is heated by induction heating as described above, heat of the coating target region 413 is conducted to the exposure target region 412 and the temperature of the exposure target region 412 may rise, but by setting conducting conditions of the heating coil portion 560 appropriately (for example, by shortening the conducting time), the temperature rise of the exposure target region 412 can be inhibited. If the exposure target region 412 is heated in the heat-up process, it is preferable to cool the exposure target region 412 to a temperature below the powder melting temperature when necessary. Accordingly, for example, in the subsequent immersion process, the melt of the powder material 431 can be inhibited from adhering to the exposure target region 412. Accordingly, for example, in the subsequent immersion process, the melt of the powder material 431 can be inhibited from adhering to the exposure target region 412.

If an alternating current can be passed, as described above, the conductive material 561 is not specifically limited and, for example, applying a metallic material such as copper as the conductive material 561 can be cited. By adopting a configuration in which, as shown in FIGS. 29B and 29C, the conductive material 561 in a tubular shape having a hollow portion 563 is applied and a refrigerant can be circulated to the hollow portion 563, the temperature of the heating coil portion 560 can be inhibited from rising when an alternating current is passed to the heating coil portion 560.

<Example of the Reheat-Up Process in the Second Mode of the Method of Manufacturing a Cable>

The reheat-up process is not specifically limited if the surface of the coating portion 404 (including a half-melting state before complete setting) can be smoothed by heating the coating portion 404 formed in the coating target region 413 in the prior immersion process up to the powder melting temperature or higher. For example, like the aforementioned heat-up process, a process of applying the induction heating unit 506 as shown in FIGS. 29A, 29B, and 29C to reheat the coating target region 413 of the core wire 410 coated with the coating portion by induction heating and conducting heat of the coating target region 413 to the coating portion 404 for heat-up (heat-up by indirect heating) can be cited.

Heat-up conditions of the coating portion 404 by the induction heating unit 506 in the reheat-up process can appropriately be set in accordance with the heat capacity (heat capacity based on the specific heat, specific gravity, shape and the like) and heat dissipation (temperature drop) characteristics of the coating portion 404. In addition, the induction heating unit 506 in the reheat-up process can appropriately be applied based on content of <Example of the heat-up process> described above and a detailed description thereof is omitted.

The immersion process and the reheat-up process described above may each be performed once, but may also be alternately repeated in accordance with the intended coating portion 404.

<Example 1 According to the Second Mode of the Method of Manufacturing a Cable>

Based on the content described above, we tried to produce the cable 401 applicable to an automobile wire harness (for example, the wire harness 407). First, as shown in FIG. 15, the core wire 410 made of a plurality of element wires 411 and applicable to an automobile wire harness is prepared.

Next, the coating target region 413 is heated up to about 120° C. by applying the induction heating unit 506 as shown in FIGS. 29A, 29B, and 29C, arranging the coating target region 413 of the core wire 410 in the inner portion 562 of the heating coil portion 560, and passing an alternating current to the heating coil portion 560. Then, the heated coating target region 413 is immersed (immersed swiftly after heat-up) in the powder material 431 with which the immersion portion 434 of the immersion container 403 is filled as shown in FIG. 16 and after holding the immersed state for about 30 sec, the coating target region 413 is taken out of the immersion portion 434. Incidentally, a material using a polyamide thermoplastic resin (Platamid manufactured by Arkema, product number: HX2544PRA170) and pulverized to about 80 μm to 170 μm in average particle size is applied as the powder material 431.

The observation of the coating target region 413 taken out of the immersion portion 434 shows that the melt of the powder material 431 adheres like covering the coating target region 413 and the melt is set after the temperature thereof drops to form the coating portion 404 as shown in FIG. 17A. The coating portion 404 coats the outer circumferential side of the coating target region 413 of the core wire 410 without gap and is also formed by sealing the space (border) between, for example, the exposure target region 412 and the coating target region 413 without any gap, confirming that electric wire characteristics (insulation properties, resistance to water, durability and the like) required of an automobile wire harness can sufficiently be provided.

Then, the coating target region 413 having the coating portion 404 formed as described above is again arranged in the inner portion 562 of the heating coil portion 560 and the coating target region 413 is induction-heated by passing an alternating current to the heating coil portion 560 to indirectly heat the coating portion 404 up to about 120° C. and then, the observation confirms that the surface of the coating portion 404 is smoothed as shown in FIG. 17B.

<Example 2 According to the Second Mode of the Method of Manufacturing a Cable>

Next, the core wire 410 applicable to an automobile wire harness (for example, the wire harness 407) and having the branching portion 414 as shown in FIGS. 19, 23, 24, and 26 is prepared to try to produce the cable 401 in such a branching shape. First, using a technique similar to that of Example 1, the coating target region 413 is heated up to about 120° C. by applying the induction heating unit 506 as shown in FIGS. 29A, 29B, and 29C. Then, the heated coating target region 413 is immersed (immersed swiftly after heat-up) in the powder material 431 with which the immersion portion 434 of the immersion container 403 is filled as shown in FIGS. 23 and 24 and after holding the immersed state for about 30 sec, the coating target region 413 is taken out of the immersion portion 434. The powder material 431 similar to that in Example 1 is applied.

The observation of the coating target region 413 taken out of the immersion portion 434 shows that the melt of the powder material 431 adheres like covering the coating target region 413 and the melt is set after the temperature thereof drops to form the coating portion 404 as shown in, for example, FIG. 23B. The coating portion 404 covers the outer circumferential side of the coating target region 413 without gap and is also formed by sealing the space between, for example, the exposure target region 412 and the coating target region 413 (and the branching portion 414) without any gap, confirming that electric wire characteristics (insulation properties, resistance to water, durability and the like) required of an automobile wire harness can sufficiently be provided.

Then, the coating portion 404 is indirectly heated up to about 120° C. by induction heating the formed coating target region 413 by applying the induction heating unit 506 again and the observation confirms that the surface of the coating portion 404 is smoothed (smoothed as shown in, for example, FIG. 17B).

Next, the third mode of the method of manufacturing a cable will be described. The third mode of the method of manufacturing a cable is equal to the first mode of the method of manufacturing a cable described above except that the coating target region 413 is heated while the coating target region 413 is immersed in the powder material 431. Hereinafter, the description focuses on differences of the third mode of the method of manufacturing a cable from the first mode of the method of manufacturing a cable and a repeated description of equal points is omitted.

In the third mode of the method of manufacturing a cable, first by including a configuration equal to that of the first mode of the method of manufacturing a cable, only the coating target region of the core wire is coated to make the removal process of the conventional technique unnecessary, and also waste of the material related to the cable can be avoided. Even if the shape or electric wire characteristics of the intended cable are diverse, for example, the mode is a one-wire mode of the core wire, a mode bundling a plurality of wires, or a mode in which a branching portion is formed (for example, a mode of a composite electric wire), the intended cable can be obtained if the mode allows the coating target region of the core wire to be heated by induction heating to the melting temperature or higher of an insulating polymeric material (immersion/heat-up process) by the induction heating unit positioned on the outer circumferential side of the immersion container while the coating target region is immersed in the powder insulating polymeric material inside the immersion container. Compared with the conventional technique using an extrusion molding machine or the like, the immersion/heat-up process as described above can be considered to be simple and easy from various viewpoints.

That is, in the third mode of the method of manufacturing a cable, by undergoing the immersion/heat-up process described above using the core wire of the intended cable, the cable can be produced easily (more easily than when the conventional technique is used) and obtaining desired electric wire characteristics such as insulation properties, resistance to water, and durability can be considered to be certainly possible. In addition, the storage location and a molding machine needed for the conventional technique are not needed so that work efficiency can be increased by securing sufficient work space or facilities can be reduced in size or costs thereof can be reduced.

Further, when the intended cable is needed, core wires of the cable may be prepared to form the cable by undergoing the heat-up process and the immersion process described above and thus, cost reductions can be achieved by avoiding waste related to the cable and also delayed differentiation can be achieved. Therefore, it is certainly possible to produce the composite electric wire, for example, an automobile wire harness and the cable in the same facilities (for example, automobile wire harness facilities).

Also, by heating only the coating target region of the core wire, for example, locally heating only the coating target region by applying an induction heating unit as a heat-up unit, heat-up of the exposure target region of the core wire can be prevented in the immersion/heat-up process or a contribution to a higher cycle or energy saving concerning the formation of a coating portion can be made.

In the third mode of the method of manufacturing a cable, if, as described above, a cable can be produced by coating only the coating target region of a core wire with a coating portion, technologies known generally in various fields such as the automobile field, electric wire field, terminal field, powder coating field, induction heating field, insulating polymeric material field, welding field and the like can be applied to appropriately design a cable and, for example, an example of the method of manufacturing a cable or a composite electric wire can be cited.

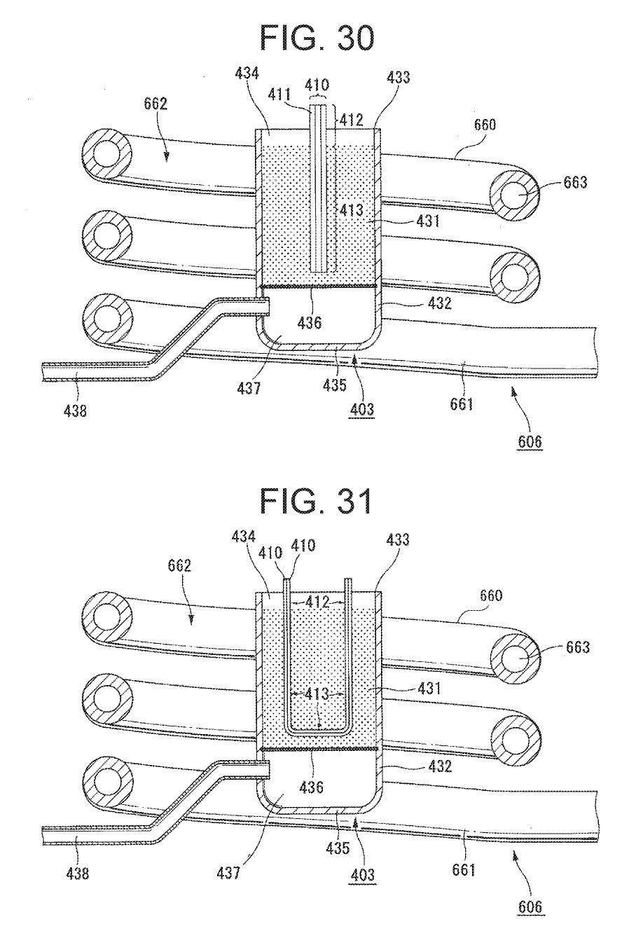

Next, the third mode of the method of manufacturing a protective structure will be described with reference to FIGS. 30 to 37. In FIGS. 30 to 37, the same reference signs as those in FIGS. 15 to 28 are attached to elements equivalent to those shown in FIGS. 15 to 28 and hereinafter, a repeated description of the same element is omitted.

<Example of the Immersion Container of the Immersion/Heat-Up Process in the Third Mode of the Method of Manufacturing a Cable>

The immersion/heat-up process can be performed by using the general powder coating method when appropriate and, for example, the immersion coating method using the immersion container 403 as shown in, for example, FIGS. 30 to 36 can be used.

Various modes can be applied to the immersion container 403 in accordance with the shape or the like of the immersed coating target region 413 and any mode allowing the immersion container 403 to be sufficiently filled with the powder material 431 and allowing the coating target region 413 to be immersed in the powder material 431 may be used. As a concrete example, as shown in FIGS. 30 to 36, a configuration including the peripheral wall 432 in a closed-end cylindrical shape, the immersion portion 434 formed on the side of the opening 433 inside the peripheral wall 432, the gas jetting portion 437 formed on the side of the bottom wall 435 inside the peripheral wall 432 and partitioned from the immersion portion 434 by the partition wall 436, and the supply portion 438 communicatively connecting the outer circumferential side of the peripheral wall 432 and the gas jetting portion 437 and capable of supplying a gas to the gas jetting portion 437 can be cited.

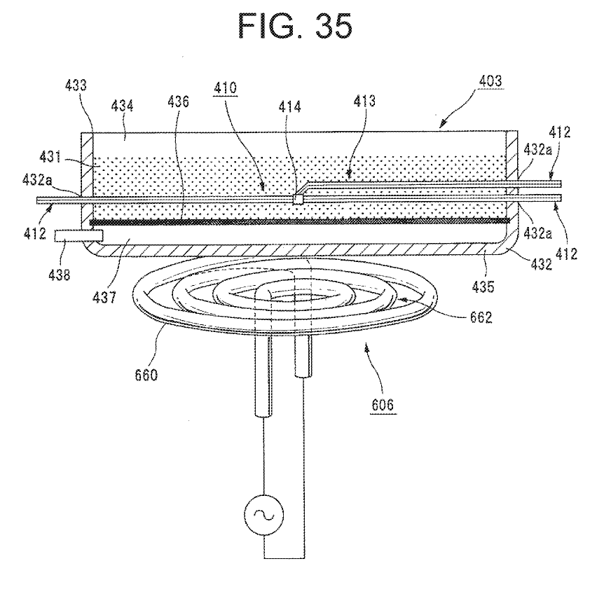

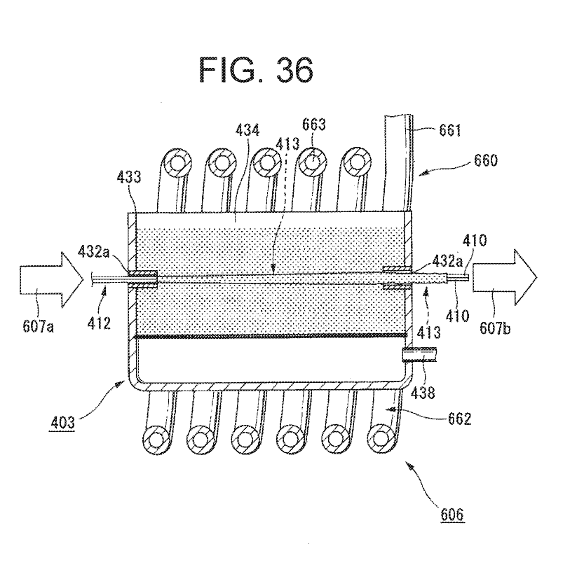

In the immersion container 403 shown in FIGS. 35 and 36, a through hole 432a (three holes in FIG. 35 and two holes in FIG. 36) is formed on the immersion portion 434 side of the peripheral wall 432 and the through hole 432a is configured to allow the core wire 410 to pass through. By adopting such a configuration, in the case of, for example, the immersion container 403 in FIG. 35, the coating target region 413 can be immersed in the immersion portion 434 by extending, as shown in FIG. 35, the core wire 410 linearly while allowing a portion (in FIG. 35, the exposure target region 412) of the core wire to pass through the through hole 432a.

In the case of the immersion container 403 in FIG. 36, a pair of the through holes 432a is formed in opposite positions of the peripheral wall 432 across the immersion portion 434 such that the one-wire core wire 410 can pass through the pair of the through holes 432a and the intended cable 401 can consecutively be produced. According to the immersion container 403 shown in FIG. 36, even if the peripheral wall 432 is configured not to have the opening 433 (configured to surround the immersion portion 434), the coating target region 413 can be immersed in the immersion portion 434 via the through hole 432a.

As a concrete example of consecutively producing the cable 401 by the immersion container 403 in FIG. 36, first immersing the coating target region 413 in the immersion portion 434 by, like a white arrow 607a in FIG. 36, introducing, for example, the one-wire core wire 410 into the immersion portion 434 from one of the pair of the through holes 432a (introducing from one end of the core wire 410) can be cited. Then, when the coating target region 413 is immersed in the immersion portion 434, the coating target region 413 is induction-heated by the induction heating unit 606, the powder material 431 around the coating target region 413 is melted to allow the melt to adhere to the coating target region 413 and then, like a white arrow 607b in FIG. 36, the core wire 410 is led to the outer circumferential side of the immersion container 403 from the other of the pair of the through holes 432a to obtain the cable 401 having the coating portion 404 formed thereon.

In the configuration of the immersion container 403 including the through hole 432a as described above, as shown in FIGS. 35 and 36, the powder material 431 inside the immersion portion 434 can be inhibited from leaking out to the outer circumferential side of the peripheral wall 432 even in a state in which the core wire 410 passes through the through hole 432a by an appropriate design (for example, by providing a check valve outside FIGS. 35 and 36 or the like in the through hole 432a).

A porous structure in which a plurality of holes (not shown) of shape equal to the size of the powder material 431 or less than the size of the powder material 431 is punched can be applied as the partition wall 436 of the gas jetting portion 437 and, for example, a partition wall obtained by sintering, fiber cloth, or machining can be cited. By using the immersion container 403 having the partition wall 436 as described above, a gas supplied to the gas jetting portion 437 via the supply portion 438 is equally jetted (for example, jetted under the atmospheric pressure) to the immersion portion 434 via each hole of the partition wall 436, which makes the powder material 431 inside the immersion portion 434 easier to flow. In a state in which the powder material 431 is made to flow, it is easier to immerse the coating target region 413 in the powder material 431.

The gas supplied from the supply portion 438 is not specifically limited, but applying an inert gas such as air, dry air, nitrogen, and dry nitrogen can be cited. Concerning the flow rate of gas, setting the flow rate appropriately in accordance with the particle size, distribution, shape, density and the like of the powder material 431 with which the immersion portion 434 is filled can be cited. For example, the flow rate can be set based on a linear speed (cm/min) of the value obtained by dividing a gas flow rate (cm³/min) by an effective area (effective area (cm²) of a region of the immersion portion 434 in which the gas is jetted equally). For example, setting 0.5 cm/min to 50 cm/min (more desirably, 1 cm/min to 20 cm/min) can be cited.

<Example of the Heat-Up Unit of the Immersion/Heat-Up Process in the Third Mode of the Method of Manufacturing a Cable>

When the coating portion 404 is formed by a general immersion coating method, for example, a technique (hereinafter, called a post-heating immersion technique) by which the coating target region 413 is heated by the heat-up unit such as a heating furnace for heat-up (that is, heat-up before immersion) and then, the heated coating target region 413 is immersed in the immersion container 403 to allow the melt of the powder material 431 to adhere to the coating target region 413 can be considered.

However, when the post-heating immersion technique is simply applied, the thickness of the melt increases over time in a fixed immersion time after starting the immersion of the coating target region 413, but after the fixed immersion time, the thickness of the melt is considered to be constant or nonuniform (the surface state is coarse) because the temperature of the coating target region 413 drops below the powder melting temperature. For example, depending on the shape of the coating target region 413, it may be difficult for the melt to be fixed (for example, when peeling) or the melt may dangle so that the thickness may become nonuniform. Such a trend may also be observed when the heat-up temperature by the heating furnace is too low or too high.

Thus, in the third mode of the method of manufacturing a cable, a technique by which the coating target region 413 immersed in the powder material 431 inside the immersion container 403 is heated by induction heating of an induction heating unit 606 as shown in, for example, FIGS. 30 to 36 is applied. The induction heating unit 606 includes, as shown in, for example, FIGS. 30 to 36, a heating coil portion 660 having a conductive material 661 extending like a coil (or spirally) and applying a configuration allowing the induction heating unit 606 to be arranged on the outer circumferential side of the immersion container 403 can be cited.

According to the heat-up unit such as the induction heating unit 606, as shown in, for example, FIGS. 30 to 36, even in a state in which the coating target region 413 is immersed in the powder material 431 inside the immersion container 403, the coating target region 413 can be heated by induction heating (non-contact direct heating) by passing an alternating current to the heating coil portion 660 without heating (heat-up), for example, the exposure target region 412. Then, the powder material 431 around the coating target region 413 is melted by heat of the heated coating target region 413 and the melt thereof adheres to (adheres by covering) the coating target region 413.

Compared with the post-heating immersion technique by a heating furnace or the like, only the coating target region 413 of the core wire 410 can locally be heated by induction heating swiftly and the heat-up efficiency (heating efficiency) is good and thus, miniaturization or cost reductions of facilities (particularly the heat-up unit) can be achieved or a higher cycle or energy saving concerning the formation of the coating portion 404 can be achieved, In addition, scaling of the core wire 410 can be inhibited.

Further, by continuously passing a current to the heating coil portion 660, the coating target region 413 immersed in the powder material 431 can be maintained at the power melting temperature or higher and the thickness of the coating portion 404 can be controlled by easily adjusting the thickness of the melt allowed to adhere to the coating target region 413. When the immersion container 403 as shown in FIG. 36 is used, if a current is intermittently passed to the heating coil portion 660, for example, the coating target region 413 is immersed in the immersion portion 434, the desired coating portion 404 can be produced only for the coating target region 413 by passing a current to the heating coil portion 660.

The heating coil portion 660 only needs to be configured so that the coating target region 413 immersed in the powder material 431 inside the immersion container 403 can be heated by induction heating from the outer circumferential side of the immersion container 403. Therefore, the shape (the number of winding, diameter, axial center direction length of the heating coil portion 660, the transverse section (or longitudinal section) shape of the conductive material 661, the position and the like) of the heating coil portion 660, conducting conditions (the frequency of AC, conducting time and the like), the arrangement position (the spatial position, direction and the like in an inner portion 662) of the immersion container 403 with respect to the inner portion 662 are not specifically limited and can appropriately be set in accordance with the heat capacity (heat capacity based on the specific heat, specific gravity, shape and the like), heat dissipation (temperature drop) characteristics, electric characteristics (electric conductivity, magnetic permeability and the like), the powder melting temperature of the powder material 431, and immersion conditions (details thereof will be described below) of, for example, the coating target region 413 to be heated.

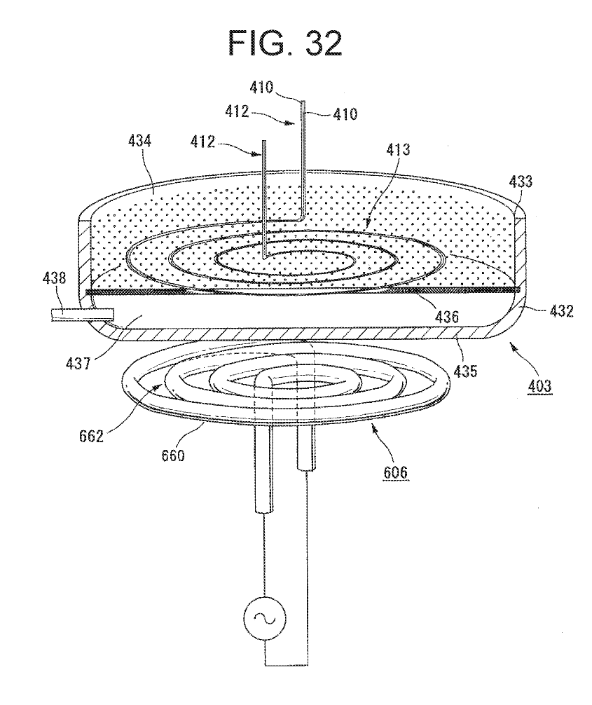

As a concrete example, as shown in FIGS. 30, 31, 33, 34, and 36, applying the heating coil portion 660 having the conductive material 661 extending like a coil so as to be able to surround the outer circumferential side of the immersion container 403, wherein the inner portion 662 (axial center side) of the heating coil portion 660 is configured to be able to accommodate the immersion container 403 can be cited. Also, as shown in FIGS. 32 and 35, a configuration having the conductive material 661 extending like a coil or spirally such that the immersion portion 434 of the immersion container 403 is positioned in the axial center direction of the inner portion 662 and allowing the heating coil portion 660 to be arranged on the bottom wall 435 side of the immersion container 403 can be cited.

If the coating target region 413 is heated by induction heating as described above, heat of the coating target region 413 is conducted to the exposure target region 412 and the temperature of the exposure target region 412 may also rise, but by setting conducting conditions of the heating coil portion 660 appropriately (for example, by shortening the conducting time), the temperature rise of the exposure target region 412 can be inhibited.

If an alternating current can be passed, as described above, the conductive material 661 is not specifically limited and, for example, applying a metallic material such as copper as the conductive material 661 can be cited. By adopting a configuration in which, as shown in FIG. 30, the conductive material 661 in a tubular shape having a hollow portion 663 is applied and a refrigerant can be circulated to the hollow portion 663, the temperature of the heating coil portion 660 can be inhibited from rising when an alternating current is passed to the heating coil portion 660.

<Example of Immersion Conditions for the Immersion/Heat-Up Process in the Third Mode of the Method of Manufacturing a Cable>

Immersion conditions for the immersion/heat-up process, for example, the immersion time and the immersion position (the spatial position and direction during immersion and the posture of the core wire 410 during immersion and the like) of the coating target region 413 with respect to the immersion portion 434 of the immersion container 403 can appropriately be set in accordance with the exposure target region 412 and the coating target region 413, the heat capacity (heat capacity based on the specific heat, specific gravity, shape and the like), heat dissipation (temperature drop) characteristics, the shape, and the powder melting temperature of the coating target region 413, and the shape and the like of the intended coating portion 404.

For example, as shown in FIG. 30, immersing one end of the core wire 410 while the core wire 410 is extended straight with respect to the immersion portion 434, as shown in FIG. 31, immersing the center side of the core wire 410 while the core wire 410 is bent (for example, in a U shape), or as shown in FIG. 32, immersing the center side of the core wire 410 while the core wire 410 is put together compactly (for example, spirally as shown in FIG. 32) can be cited.

Thus, even in a mode configured by bundling a plurality of the core wires 410 or configured by forming the branching portion 414 in the coating target region 413, by, as shown in, for example, FIGS. 31 to 36, appropriately immersing the coating target region 413 in the immersion portion 434 to coat the coating target region 413 with the coating portion 404, the intended cable 401 can be produced and cable 401 can also be applied as the composite electric wire 402.

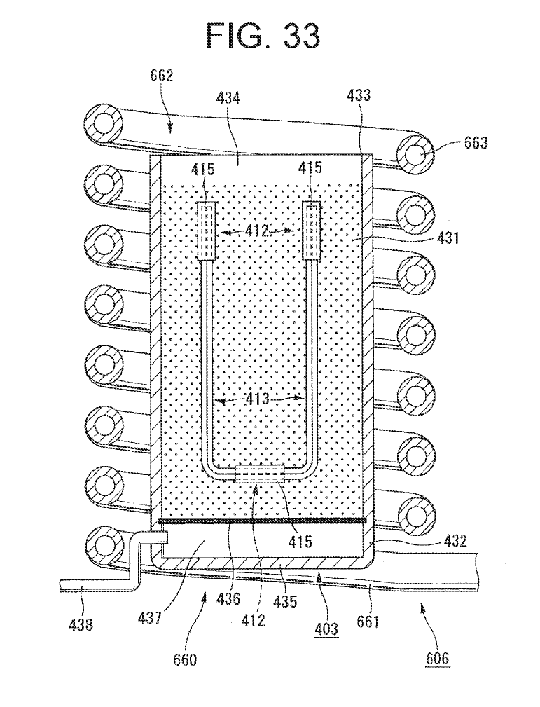

Even if the exposure target region 412 (partially or wholly) may be immersed in the immersion portion 434, in addition to the coating target region 413, in the immersion/heat-up process, the melt of the powder material 431 can be inhibited from adhering to the exposure target region 412 if the temperature of the exposure target region 412 is lower than the powder melting temperature. Also, if, as shown in, for example, FIGS. 18A and 33, the exposure target region 412 is appropriately masked by a masking member (for example, a masking tape) 415, the melt of the powder material 431 can be inhibited from adhering to the exposure target region 412. As an application example of the cable 401 produced by using the center side of the core wire 410 as the exposure target region 412 as shown in FIGS. 18A and 33, an example in which, as shown in, for example, FIG. 27, a plurality of the cables 401 is bundled and the exposure target region 412 of each of the cables 401 is welded and electrically connected to produce the composite electric wire 402 can be cited.

If, in the coating target region 413, any location that temporarily does not need the coating portion 404 exists, the immersion/heat-up process may be performed by appropriately masking the relevant location. Further, the immersion/heat-up process may be performed not simply once, but may be divided for a plurality of times or repeated. When the immersion/heat-up process is divided and performed a plurality of times, various kinds (for example, multi-color) of the coating portion 404 can be formed for the coating target region 413 by changing the type of the powder material 431 for each immersion/heat-up process.

The thickness of the melt (melt of the powder material 431) adhering to the coating target region 413 can be changed by appropriately adjusting immersion conditions such as the immersion time and heat-up temperature of the immersion/heat-up process. Without adjustments of immersion conditions, the thickness of the melt increases over time in a fixed immersion time after starting the immersion of the coating target region 413, but after the fixed immersion time, the thickness of the melt is considered to be constant or nonuniform (the surface state is coarse). For example, depending on the shape of the coating target region 413, it may be difficult for the melt to be fixed (for example, when peeling) or the melt may dangle so that the thickness may become nonuniform. Such a trend may also arise if the heat-up temperature in the immersion/heat-up process is too low or too high. In such a case, in addition to appropriately adjusting immersion conditions as described above, it is preferable to perform the reheat-up process described below when appropriate.

<Example of the Reheat-Up Process in the Third Mode of the Method of Manufacturing a Cable>

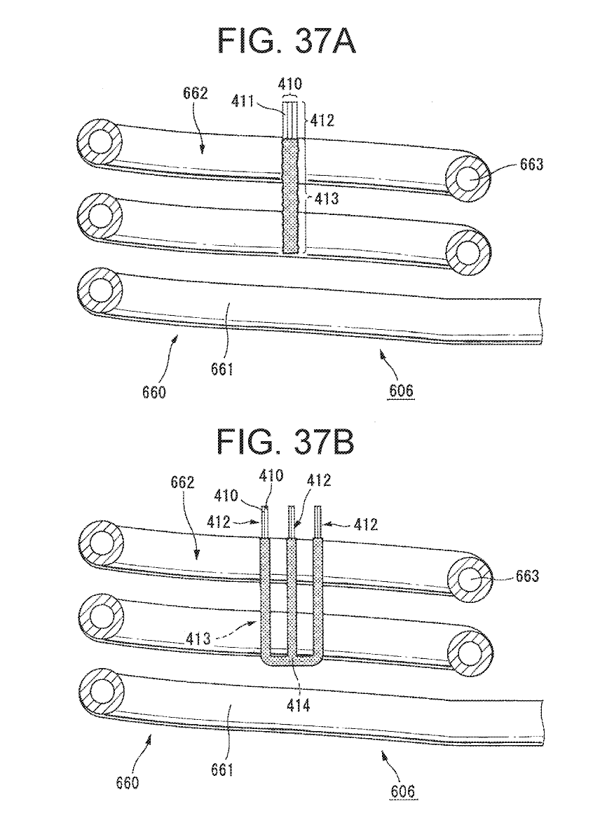

The reheat-up process is not specifically limited if the surface of the coating portion 404 (including a half-melting state before complete setting) can be smoothed by heating the coating portion 404 formed in the coating target region 413 in the prior immersion/heat-up process up to the powder melting temperature or higher. For example, applying the induction heating unit 606 like in the immersion/heat-up process described above can be cited. As a concrete example, as shown in, for example, FIGS. 37A and 37B, a process of arranging the coating target region 413 (coating portion 404) in the inner portion 662 (axial center side) of the heating coil portion 660 and passing an alternating current to the heating coil portion 660 to reheat the coating target region 413 by induction heating so that heat of the coating target region 413 is conducted to the coating portion 404 for heat-up (heat-up by indirect heating) can be cited.

Heat-up conditions of the coating portion 404 by the induction heating unit 606 in the reheat-up process can appropriately be set in accordance with the heat capacity (heat capacity based on the specific heat, specific gravity, shape and the like) and heat dissipation (temperature drop) characteristics of the coating portion 404. For example, as the posture of the coating target region 413 arranged with respect to the inner portion 662 of the heating coil portion 660 in the reheat-up process, extending the coating target region 413 straight as shown in FIG. 37A and putting the coating target region 413 together (for example, as illustrated in FIG. 37B, the coating target region 413 dispersed spirally from the branching portion 414 as a base point are put together) compactly as shown in FIG. 37B can be cited. In addition, the induction heating unit 606 in the reheat-up process can appropriately be applied based on content of <Example of the heat-up unit in the immersion/heat-up process> described above and a detailed description thereof is omitted.

The immersion/heat-up process and the reheat-up process described above may each be performed once, but may also be alternately repeated in accordance with the intended coating portion 404.

<Example 1 According to the Third Mode of the Method of Manufacturing a Cable>

Based on the content described above, we tried to produce the cable 401 applicable to an automobile wire harness (for example, the wire harness 407). First, as shown in FIG. 15, the core wire 410 made of a plurality of element wires 411 and applicable to an automobile wire harness is prepared.

Next, the coating target region 413 is heated up to about 120° C. by induction heating by passing an alternating current to the heating coil portion 660 of the induction heating unit 606 positioned on the outer circumferential side of the immersion container 403 while the coating target region 413 of the core wire 410 is immersed in the powder material 431 inside the immersion container 403 as shown in FIG. 30 and the heated state is maintained for about 30 sec. Incidentally, a material using a polyamide thermoplastic resin (Platamid manufactured by Arkema, product number: HX2544PRA170) and pulverized to about 80 μm to 170 μm in average particle size is applied as the powder material 431.

Then, the observation of the coating target region 413 taken out of the immersion portion 434 shows that the melt of the powder material 431 adheres like covering the coating target region 413 and the melt is set after the temperature thereof drops to form the coating portion 404 as shown in FIG. 17A. The coating portion 404 coats the outer circumferential side of the coating target region 413 of the core wire 410 without gap and is also formed by sealing the space (border) between, for example, the exposure target region 412 and the coating target region 413 without any gap, confirming that electric wire characteristics (insulation properties, resistance to water, durability and the like) required of an automobile wire harness can sufficiently be provided.

Further, the coating target region 413 having the coating portion 404 formed as described above is again arranged in the inner portion 662 of the heating coil portion 660 as shown in FIGS. 37A and 37B and the coating target region 413 is induction-heated by passing an alternating current to the heating coil portion 660 to indirectly heat the coating portion 404 up to about 120° C. and then, the observation confirms that the surface of the coating portion 404 is smoothed as shown in FIG. 17B,

<Example 2 According to the Third Mode of the Method of Manufacturing a Cable>

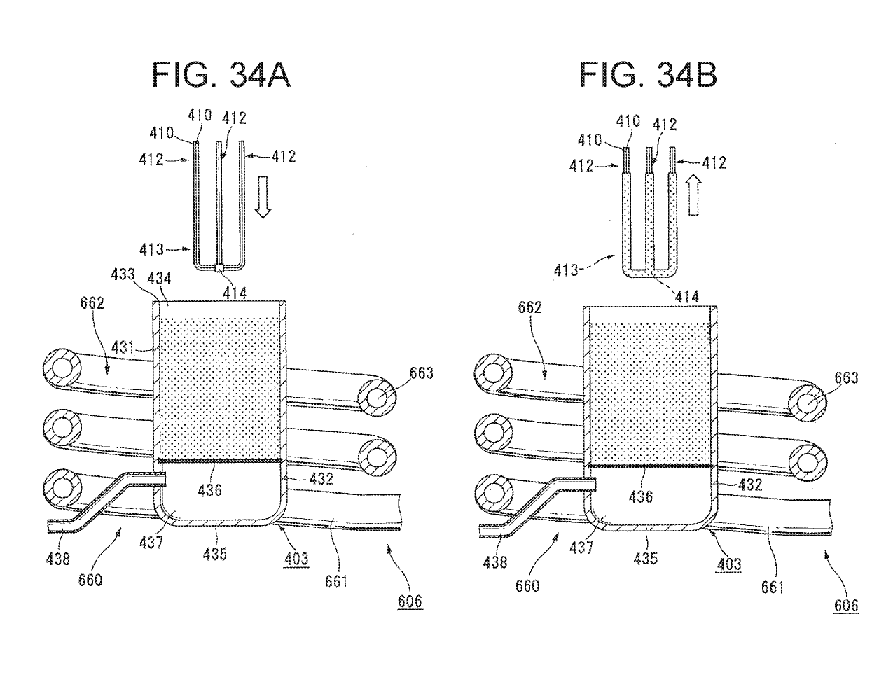

Next, the core wire 410 applicable to an automobile wire harness (for example, the wire harness 407) and having the branching portion 414 as shown in FIGS. 19, 34, 35, and 37 is prepared and the production of the cable 401 in such a branching shape is tried. First, as shown in FIGS. 34 and 35, like in Example 1, the coating target region 413 is heated up to about 120° C. by induction heating while the coating target region 413 of the core wire 410 is immersed in the powder material 431 inside the immersion container 403 and the heated state is maintained for about 30 sec. The powder material 431 similar to that in Example 1 is applied.

Then, the observation of the coating target region 413 taken out of the immersion portion 434 shows that the melt of the powder material 431 adheres like covering the coating target region 413 and the melt is set after the temperature thereof drops to form the coating portion 404 as shown in, for example, FIG. 34B. The coating portion 404 covers the outer circumferential side of the coating target region 413 without gap and is also formed by sealing the space between, for example, the exposure target region 412 and the coating target region 413 (and the branching portion 414) without any gap, confirming that electric wire characteristics (insulation properties, resistance to water, durability and the like) required of an automobile wire harness can sufficiently be provided.

Further, the coating portion 404 is indirectly heated up to about 120° C. by induction heating the coating target region 413 having the coating portion 404 formed as described above by applying the induction heating unit 606 again and the observation confirms that the surface of the coating portion 404 is smoothed (smoothed as shown in, for example, FIG. 17B).

Next, different examples of the immersion container applied to, among the first to third modes of the method of manufacturing a protective structure and the first to third modes of the method of manufacturing a cable described above, the third mode of the method of manufacturing a protective structure and the third mode of the method of manufacturing a cable in which an induction heating unit is arranged on the outer circumferential side of the immersion container will be described.

In the third mode of the method of manufacturing a protective structure and the third mode of the method of manufacturing a cable, situations as described below could arise.

FIGS. 38A and 38B are diagrams illustrating situations that could arise in the third mode of the method of manufacturing a protective structure and in the third mode of the method of manufacturing a cable. Here, the third mode of the method of manufacturing a protective structure is taken as an example. That is, the coating target portion is the composite exposed portion 102 produced by bundling and welding the exposed portions 121a of the core wires 121 of a plurality of the cables 120 forming the composite electric wire 110. In addition, the heating coil portion 360 of the induction heating unit 306 is arranged like surrounding the outer circumference of the immersion container 103. If the composite exposed portion 102 as a coating target portion (that is, a heating target portion) is inserted into the immersion container 103 in such a configuration, as shown in FIG. 38A, a shift d tends to arise between a center axis ML1 of the composite exposed portion 102 as a coating target portion and a center axis ML2 of the heating coil portion 360. A magnetic flux generated by the heating coil portion 360 generates heat by intersecting the composite exposed portion 102 as a coating target portion in a density in accordance with the relative physical relationship of the two center axes ML1, ML2.

Thus, when a plurality of sets of the composite electric wire 110 is produced, if the relative physical relationship of the two center axes ML1, ML2 varies each time the composite exposed portion 102 is inserted, the heated state varies and quality of the protective member 104 (see FIG. 3) coating the composite exposed portion 102 could vary. Thus, a more stable state of the relative physical relationship of the enter axes ML1, ML2 is desirable and ideally, as shown in FIG. 38B, the center axis ML1 of the composite exposed portion 102 as a coating target portion and the center axis ML2 of the heating coil portion 360 match.

Here, the immersion container 103 shown in FIGS. 38A and 38B has a shape in which the peripheral wall thereof tapers and guiding the composite exposed portion 102 as a coating target portion (that is, a heating target portion) toward the center axis ML2 of the heating coil portion 360 along the inner surface of the peripheral wall by increasing the tapering to increase the inclination can be considered. However, if the tapering is too much, the quantity of the powder material 131 around the composite exposed portion 102 as a coating target portion (that is, a heating target portion) tends to be insufficient. On the other hand, if the tapering is too little, the composite exposed portion 102 may not be adequately guided.

Thus, in the immersion containers of different examples described below, ideas to stabilize the relative physical relationship of the center axes ML1, ML2 are devised by inhibiting the shift d of the two center axes when a coating target portion is inserted.

Hereinafter, immersion containers of four different examples will be described. Also here, examples applied to the third mode of the method of manufacturing a protective structure are taken for the description that follows.

<Immersion Container of the First Different Example>

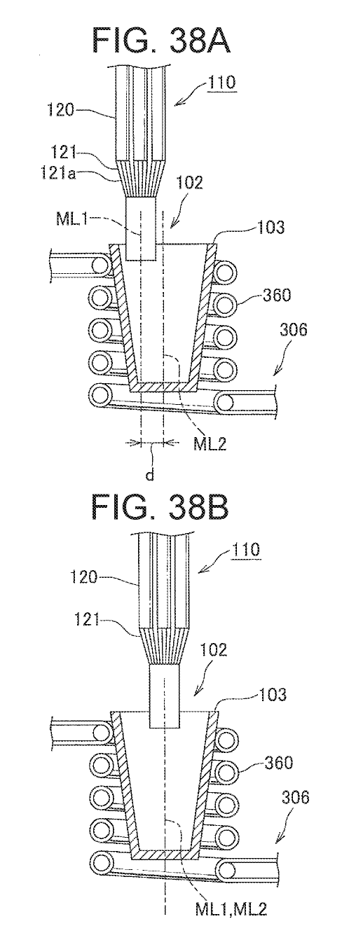

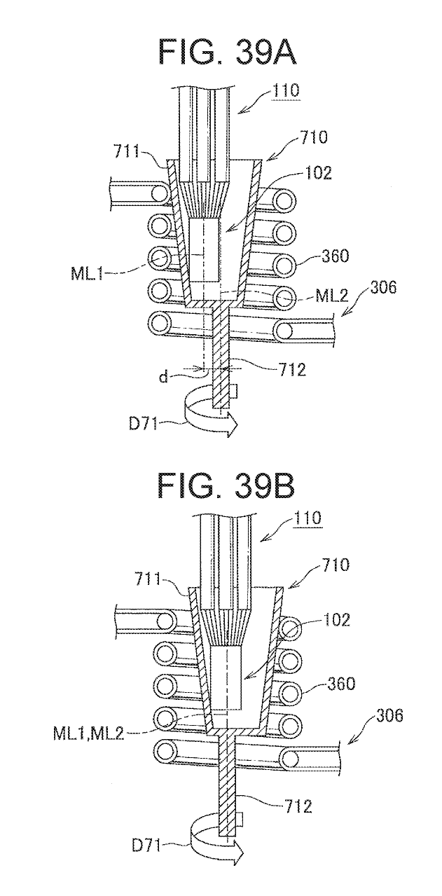

FIGS. 39A and 39B are diagrams showing the immersion container of the first different example. FIG. 39A shows a state in which the shift d arises between the center axis ML1 of the composite exposed portion 102 and the center axis ML2 of the heating coil portion 360 of the induction heating unit 306 in an initial phase of the insertion of the composite exposed portion 102 as a coating target portion. FIG. 39B shows a state in which the shift d is inhibited.

An immersion container 710 of the first different example includes a cup-shaped container 711 and an eccentric rotation axis 712 projecting from a position shifting from the center of the bottom of the container 711 and arranged to extend by matching the center axis ML2 of the heating coil portion 360. Then, the immersion container 710 rotates around the eccentric rotation axis 712 in an arrow D71 direction. Accordingly, even if the shift d arises in the initial phase of the insertion of the composite exposed portion 102, when the immersion container 710 rotates, the inner surface thereof guides the composite exposed portion 102 such that the center axis ML1 of the composite exposed portion 102 moves in a direction toward the center axis ML2 of the heating coil portion 360 while in contact with the composite exposed portion 102. While this rotation continues, the shift d is the two center axes ML1, ML2 is inhibited.

The degree of eccentricity of the eccentric rotation axis 712 at the bottom of the container 711 remains unchanged because both are fixed and thus, when the shift d is inhibited, the composite exposed portion 102 is always guided to the same point. As a result, the relative physical relationship of the center axes ML1, ML2 can be stabilized.

<Immersion Container of the Second Different Example>

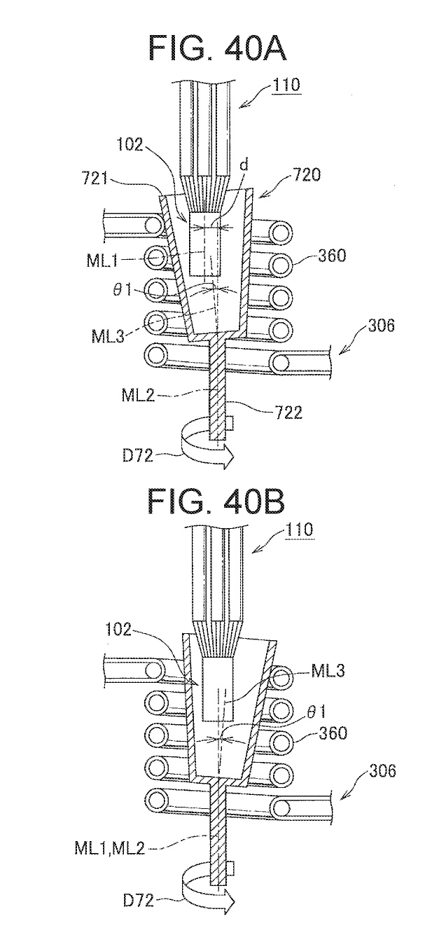

FIGS. 40A and 40B are diagrams showing the immersion container of the second different example. FIG. 40A shows a state in which the shift d arises between the two center axes ML1, ML2. FIG. 40B shows a state in which the shift d is inhibited.

Also, an immersion container 720 of the second different example includes a cup-shaped container 721 and a rotation axis 722 projecting from the bottom of the container 721 and arranged to extend by matching the center axis ML2 of the heating coil portion 360. In this case, the rotation axis 722 projects from the center position at the bottom of the container 721. However, the container 721 is fixed to the rotation axis 722 in an inclined posture of an inclination θ1 of a center axis ML3 thereof with respect to the center axis ML2 of the heating coil portion 360. The immersion container 720 rotates in an arrow D72 direction in such an inclined state of the container 721. Accordingly, even if the shift d arises in the initial phase of the insertion of the composite exposed portion 102, when the immersion container 720 rotates, the inner surface thereof guides the composite exposed portion 102 such that the center axis ML1 of the composite exposed portion 102 moves in a direction toward the center axis ML2 of the heating coil portion 360 while in contact with the composite exposed portion 102. Then, while this rotation continues, the shift d is the two center axes ML1, ML2 is inhibited.

Also here, the degree of inclination of the rotation axis 722 with the bottom of the container 721 remains unchanged because both are fixed and thus, when the shift d is inhibited, the composite exposed portion 102 is always guided to the same point. As a result, the relative physical relationship of the center axes ML1, ML2 can be stabilized.

<Immersion Container of the Third Different Example>

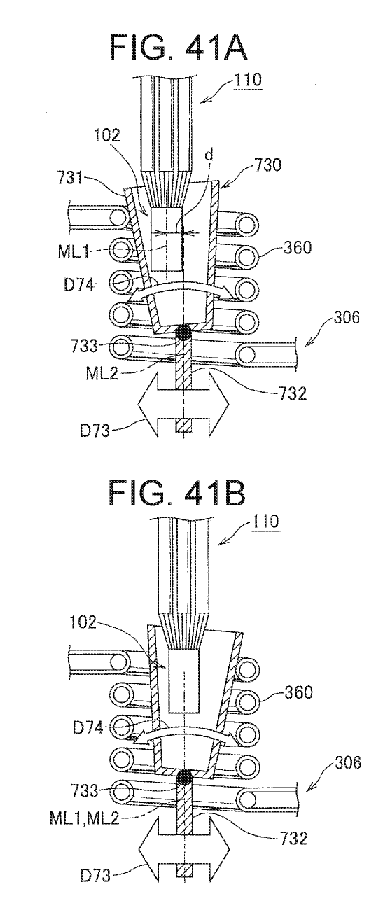

FIGS. 41A and 41B are diagrams showing the immersion container of the third different example. FIG. 41A shows a state in which the shift d arises between the two center axes ML1, ML2. FIG. 41B shows a state in which the shift d is inhibited.

An immersion container 730 of the third different example includes a cup-shaped container 731 and an axis 732 provided so as to be able to reciprocate in a reciprocating direction D73 to be a left and right direction in FIGS. 41A and 41B across the center axis ML2 of the heating coil portion 360. The bottom of the container 731 is coupled to the tip of the axis 732 so as to be able to oscillate in an oscillating direction D74 around a rotatable axis 733.

Accordingly, even if the shift d arises in the initial phase of the insertion of the composite exposed portion 102, when the axis 732 reciprocates in the reciprocating direction D73, the container 731 oscillatingly moves in the oscillating direction D74 and the inner surface thereof guides the composite exposed portion 102 such that the center axis ML1 of the composite exposed portion 102 moves in a direction toward the center axis ML2 of the heating coil portion 360 while in contact with the composite exposed portion 102. Then, while the reciprocation of the axis 732 (that is, the oscillating movement of the container 731) continues, the shift d is the two center axes ML1, ML2 is inhibited.

Here, the range of reciprocation of the axis 732 (that is, the range oscillating movement of the container 731) is determined and thus, when the shift d is inhibited, the composite exposed portion 102 is always guided to the same point. As a result, the relative physical relationship of the center axes ML1, ML2 can be stabilized.

<Immersion Container of the Fourth Different Example>

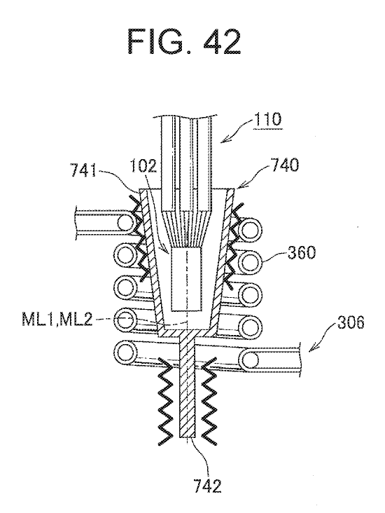

FIG. 42 is a diagram showing the immersion container of the fourth different example. FIG. 42 shows a state in which the shift d between the two center axes ML1, ML2 is inhibited.

An immersion container 740 of the fourth different example includes a cup-shaped container 741 and a vibration axis 742 projecting from the center of the bottom of the container 741 and provided so as to be able to vibrate in the left and right direction of FIG. 42 or in a direction perpendicular to the drawing around the center axis ML2 of the heating coil portion 360. The container 741 is fixed to the tip of the vibration axis 742. As depicted like a caricature in FIG. 42, when the vibration axis 742 vibrates, the container 741 also vibrates.

Accordingly, even if the shift d arises in the initial phase of the insertion of the composite exposed portion 102, when the vibration axis 742 vibrates, the container 741 vibrates and the inner surface thereof guides the composite exposed portion 102 such that the center axis ML1 of the composite exposed portion 102 moves in a direction toward the center axis ML2 of the heating coil portion 360 while in contact with the composite exposed portion 102. Then, while the vibration of the vibration axis 742 (that is, the vibration of the container 731) continues, the shift d is the two center axes ML1, ML2 is inhibited.

Here, the vibration range of the vibration axis 742 (that is, the vibration range of the container 741) is determined and thus, when the shift d is inhibited, the composite exposed portion 102 is always guided to the same point. As a result, the relative physical relationship of the center axes ML1, ML2 can be stabilized.

Next, like the immersion containers 710, . . . , 740 of the different examples described above, an insertion structure in the immersion container of a heating target portion (that is, a coating target portion) applied to the third mode of the method of manufacturing a protective structure and the third mode of the method of manufacturing a cable will be described.

<Example of the Insertion Structure into the Immersion Container>

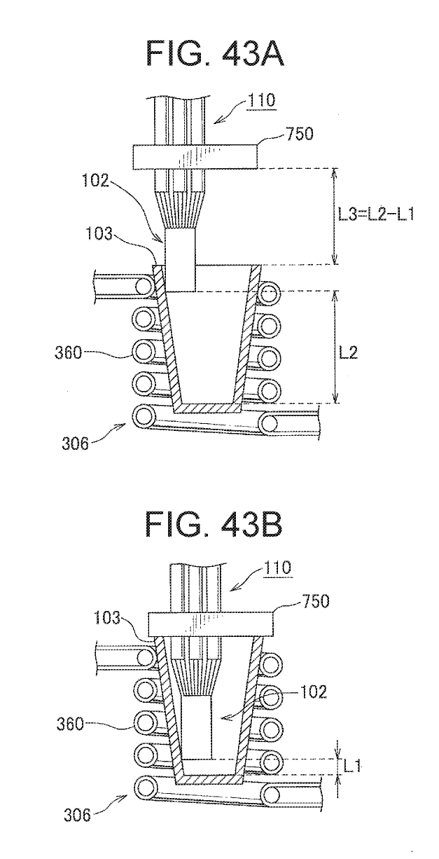

FIGS. 43A and 43B are diagrams showing an example of an insertion structure into the immersion container of a heating target portion (that is, a coating target portion). An insertion structure 750 holds the composite electric wire 110 having the composite exposed portion 102 as a heating target portion (that is, a coating target portion) and also moves to the immersion container 103 to insert the composite exposed portion 102 into the immersion container 103.

The insertion structure 750 controls the insertion position of the composite exposed portion 102 during insertion such that an intended interval L1 is secured between the tip of the composite exposed portion 102 and an inner bottom of the immersion container 103. The control is exercised by setting the initial position of the insertion structure 750 such that a second separation distance L3 obtained by subtracting the intended distance L1 from a first separation distance L2 between the tip of the composite exposed portion 102 of the composite electric wire 110 held by the insertion structure 750 in the initial position and the inner bottom of the immersion container 103 is secured to an upper edge of the immersion container 103. By exercising such control, the composite exposed portion 102 as a heating target portion (that is, a coating target portion) is always arranged in the same position during insertion so that coating of stable quality can be performed by stable heating.

Next, several heating methods applicable to, among the first to third modes of the method of manufacturing a protective structure and the first to third modes of the method of manufacturing a cable described above, the second and third modes of the method of manufacturing a protective structure and the second and third modes of the method of manufacturing a cable adopting induction heating and the coating method adopting the heating method will be described.

<Example of the First Heating Method and the Coating Method Adopting the Heating Method>

The first heating method is a heating method that heats a conductive heating target portion and includes a heat-up process in which the heating target portion is brought into contact with an auxiliary member having stronger magnetism than the heating target portion to heat by induction heating together with the auxiliary member.

According to the first heating method, the heating target portion is brought into contact with an auxiliary member to heat by induction heating together with the auxiliary member. The magnetism of the auxiliary member is strong and it is easy to heat and thus, according to the heating method of the present invention, the heating target portion can efficiently be heated.

Also, a first example of the coating method adopting the first heating method is a coating method that coats a conductive heating target portion with a thermoplastic material and includes a heat-up process in which the heating target portion is brought into contact with an auxiliary member having stronger magnetism than the heating target portion to heat by induction heating to a temperature equal to the melting temperature of the thermoplastic material or higher together with the auxiliary member and an immersion process in which the heated heating target portion is immersed in the powder thermoplastic material inside the immersion container to allow the thermoplastic material to adhere to the heating target portion to coat the heating target portion.

According to the first example of the first coating method, the heating target portion is efficiently heated together with the auxiliary member having strong magnetism and the heated target portion is immersed in the thermoplastic material in a powder state. According to the coating method of the present invention, heating is made efficient and correspondingly, coating is made efficient.

The first example of the first coating method further includes a connection process in which the heating target portion is an exposed portion of a core wire in a cable in which a portion of the core wire is exposed and the exposed portions of a plurality of the cables are electrically connected while each of which is brought into contact with the auxiliary member, the heat-up process is suitably a process in which a plurality of the exposed portions mutually connected in the connection process is heated together with the auxiliary member, and the immersion process is suitably a process that obtains a composite electric wire made of the plurality of cables by coating the plurality of exposed portions all together.

According to the suitable coating method, composite electric wires in which electrically joined exposed portions is protected with a coating made of the thermoplastic material can efficiently be obtained.

Also, a second example of the first coating method is a coating method that coats a conductive heating target portion with the thermoplastic material and includes the immersion/heat-up process in which the heating target portion is brought into contact with the auxiliary member and also immersed in the thermoplastic material in a powder state inside an immersion container and further, the heating target portion is induction-heated together with the auxiliary member by an induction heating unit positioned on the outer circumferential side of the immersion container to the melting temperature or higher to allow the thermoplastic material to adhere to the heating target portion to coat the heating target portion.

According to the second example of the first coating method, like the first example of the first coating method, heating is made efficient and correspondingly, coating is made efficient Further, according to this coating method, the heating target portion is heated and coated by one process of the immersion/heat-up process, which makes the coating more efficient.

Hereinafter, the first heating method and the coating methods adopting the heating method will be described by citing concrete examples.

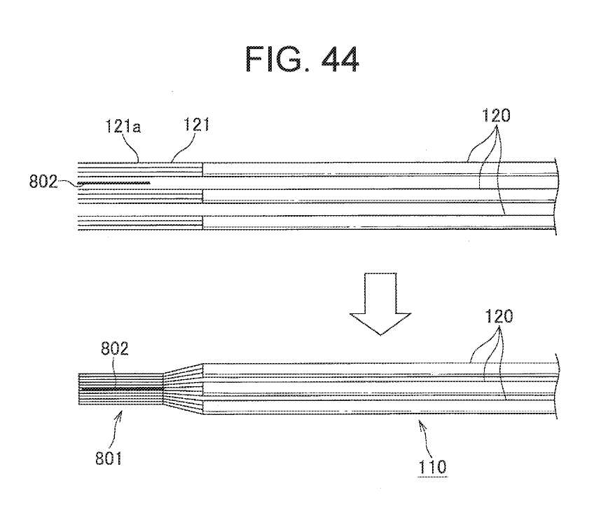

FIG. 44 is a diagram illustrating the first heating method and the coating method adopting the heating method. The first heating method includes the heat-up process in which a conductive heating target portion is brought into contact with an auxiliary member having stronger magnetism than the heating target portion to heat by induction heating together with the auxiliary member. More specifically, the heating target portion (that is, the coating target portion) is a composite exposed portion 801 produced by bundling a plurality of the exposed portions 121a in a plurality of the cables 120 in which a portion of the core wire 121 is exposed. That is, the coating method adopting the first heating method is the second or third mode of the method of manufacturing a protective structure adopting the first heating method and is a method of obtaining the composite electric wire 110 by bundling the plurality of cables 120.

Then, according to the coating method, as shown in FIG. 44, prior to the heat-up process, the connection process in which the composite exposed portion 801 electrically connecting and bundling the exposed portion 121a of the core wire 121 of each of the plurality of cables 120 is formed while being brought into contact with an iron member 802 as an auxiliary member is performed. Then, in the heat-up process, the induction heating unit 206, 306 shown in, for example, FIG. 9 or 11 is used to heat the composite exposed portion 801 together with the internal iron member 802. In the application to the second mode of the method of manufacturing a protective structure, in the immersion process subsequent to the heat-up process, as shown in, for example, FIG. 2, the composite exposed portion 801 is coated all together by the composite exposed portion 801 heated as described above being immersed in the powder material 131 (thermoplastic material) accommodated in the immersion container 103 to obtain the composite electric wire 110 made of the plurality of cables 120. In the application to the third mode of the method of manufacturing a protective structure, the composite exposed portion 801 is coated by the composite exposed portion 801 immersed in the powder material 131 being heated by the induction heating unit 306 in the heat-up/immersion process.

According to the first heating method described above and the coating method adopting the heating method, the composite exposed portion 801 as the heating target portion is brought into contact with the iron member 802 as an auxiliary member having stronger magnetism to heat by induction heating together with the iron member 802. In general, the core wire 121 is made of copper or aluminum and in some cases, it is difficult to heat the core wire 121 by induction heating. According to the first heating method and the coating method adopting the heating method, the iron member 802 having stronger magnetism and which can easily be heated by induction heating is brought into contact with the heating target portion and thus, the heating target portion can be heated in a short time.

The iron member 802 described above is not identified here, but a thin iron piece or iron powder can be cited. In addition, the above auxiliary member is not limited to the iron member and the concrete material does not matter if the member has stronger magnetism than the heating target portion.

Also, according to the coating method adopting the first heating method, the composite exposed portion 801 is coated by efficiently heating in the heat-up process and allowing the powder material 131 to adhere to the heated composite exposed portion 801. According to this coating method, heating is made efficient and correspondingly, coating is made efficient.

The above coating method adopting the first heating method includes, as described above, the connection process in which the heating target portion (that is, the coating target portion) is the composite exposed portion 801 and the composite exposed portion 801 is electrically connected while being brought into contact with the iron member 802 as an auxiliary member. Then, the heat-up process is a process in which the composite exposed portion 801 obtained in the connection process is heated together with the iron member 802 and the coating process is a process in which the composite electric wire 110 is obtained by coating the composite exposed portion 801 all together. Accordingly, the composite electric wire 110 in which the composite exposed portion 801 is protected with a coating can efficiently be obtained.

According to the coating method based on the application of the first heating method to the third mode of the method of manufacturing a protective structure, in the immersion/heat-up process, the composite exposed portion 801 immersed in the powder material 131 inside the immersion container 103 is brought into contact with the iron member 802 and heated to the melting temperature or higher by the induction heating unit 306 positioned on the outer circumferential side of the immersion container 103 by induction heating together with the iron member 802. According to this coating method, the composite exposed portion 801 is heated and coated by one process of the heat-up process, which makes the coating more efficient.

In the example here, the second and third modes of the method of manufacturing a protective structure are cited as the destination of adoption of the first heating method. However, the destination of adoption of the first heating method is not limited to the above example and may be the second and third modes of the method of manufacturing a cable in which the core wire is a heating target portion (that is, a coating target portion).

Next, the second heating method and the coating methods adopting the heating method will be described.

<Example of the Second Heating Method and the Coating Method Adopting the Heating Method>

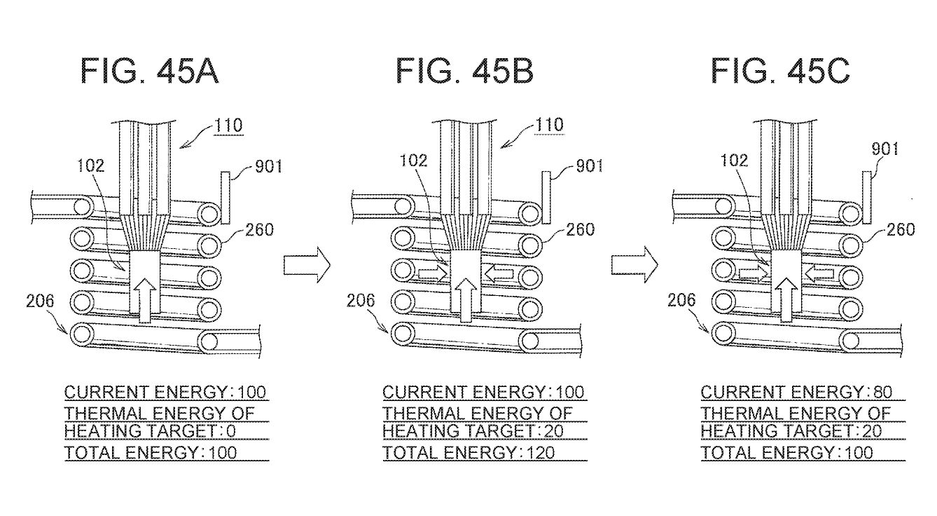

FIGS. 45A, 45B, and 45C are diagrams illustrating the second heating method and the coating method adopting the heating method. In FIGS. 45A, 45B, and 45C, an example in which the second heating method is applied to the second mode of the method of manufacturing a protective structure is shown. Then, the heating target portion (that is, the coating target portion) is the composite exposed portion 102 in the composite electric wire 110.

In the second heating method, a thermocouple 901 as a temperature sensor is mounted on the heating coil portion 260 of the induction heating unit 206. Then, the magnitude of an alternating current passed to the heating coil portion 260 is controlled based on a detection result by the thermocouple 901.

In the initial phase of heat-up, as shown in FIG. 45A, the composite exposed portion 102 as a heating target portion (that is, the coating target portion) is not heated up and thermal energy thereof is temporarily set as “0”. If current energy by the alternating current passed to the heating coil portion 260 is temporarily “100”, the total energy is “100”. If, at this point, as shown in FIG. 45B, the composite exposed portion 102 is heated up to some extent and thermal energy thereof is “20”, the total energy becomes “120” if the current energy of the heating coil portion 260 is “100”. In this case, “20” corresponding to the thermal energy of the composite exposed portion 102 of the total energy “120” will be wasted. Thus, in the second heating method, as shown in FIG. 45C, the magnitude of the alternating current passed to the heating coil portion 260 is decreased by the thermal energy of the composite exposed portion 102 to set the current energy thereof to “80”. Accordingly, the total energy becomes “100” and the waste of energy by the heat-up of the composite exposed portion 102 is eliminated.

Here, a detection result of the thermocouple 901 is sent to a controller (not shown). Then, the temperature determined from the detection result of the thermocouple 901 is grasped as a temperature due to radiation heat from the composite exposed portion 102 and thus, the thermal energy of the composite exposed portion 102 is calculated from the temperature by the controller based on the so-called Stefan-Boltzmann law. The control of the alternating current of the heating coil portion 260 as described above is exercised based on thermal energy calculated as described above.

After the heat-up process by the second heating method described above, the immersion process in which the composite exposed portion 102 is immersed in the powder material 131 is performed.

According to the second heating method described above and the coating method adopting the heating method, as described above, the waste of energy by the heat-up of the composite exposed portion 102 is eliminated. Then, for the eliminated waste, heating of lower output of the heating coil portion 260 becomes possible. Because the total energy is always controlled constant during heating, stable heat-up of the composite exposed portion 102 and by extension, coating of stable quality of the composite exposed portion 102 becomes possible.

In the example here, the second mode of the method of manufacturing a protective structure is cited as the destination of adoption of the second heating method. However, the destination of adoption of the second heating method is not limited to the above example and may be the third mode of the method of manufacturing a protective structure or the second and third modes of the method of manufacturing a cable in which the core wire is a heating target portion (that is, a coating target portion)

Next, the third heating method and the coating methods adopting the heating method will be described.

<Example of the Third Heating Method and the Coating Method Adopting the Heating Method>

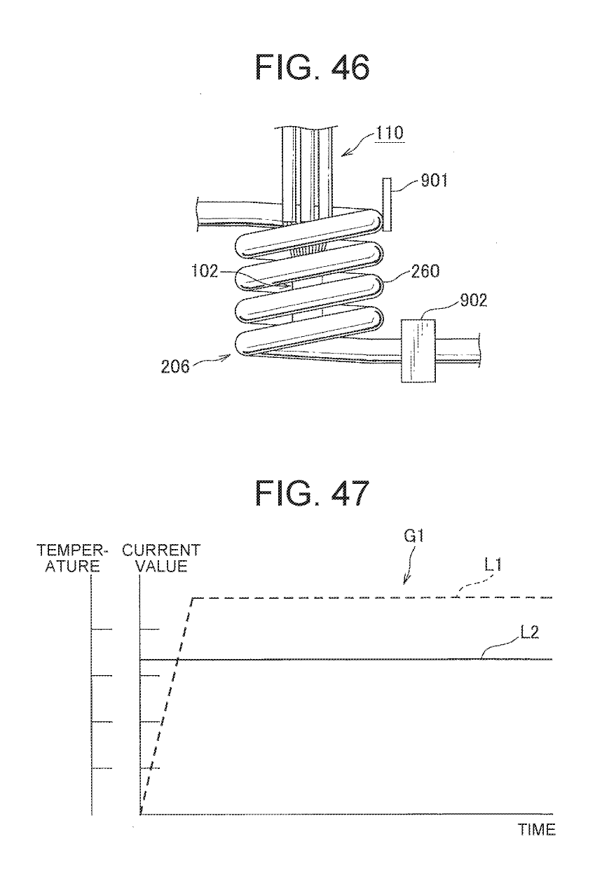

FIG. 46 is a diagram illustrating the third heating method and the coating method adopting the heating method. In FIG. 46, an example in which the third heating method is applied to the second mode of the method of manufacturing a protective structure is shown. Then, the heating target portion (that is, the coating target portion) is the composite exposed portion 102 in the composite electric wire 110.

In the third heating method, the thermocouple 901 as a temperature sensor and an ammeter 902 that detects a current value of an alternating current flowing through the heating coil portion 260 are mounted on the heating coil portion 260 of the induction heating unit 206 Then, the heat-up process for the composite exposed portion 102 as a heating target portion (that is, a coating target portion) is controlled based on a detection result by the thermocouple 901 and a detection result by the ammeter 902.

FIG. 47 is a graph showing an example of changes over time of the temperature determined from a detection result of a thermocouple shown in FIG. 46 and a detection result by an ammeter. In a graph G1 in FIG. 47, vertical axes represent the temperature determined from a detection result of the thermocouple 901 and the current value (effective value) detected by the ammeter and the horizontal axis represents the time. Then, changes over time of the temperature are shown by a broken line L1 and changes over time of the current value are shown by a solid line L2. The example shown in FIG. 47 is an example in which the heat-up process by the induction heating unit 206 is performed without any trouble.

If the current value of the alternating current flowing through the heating coil portion 260 is constant as indicated by the solid line L2, the temperature of the thermocouple 901 receiving radiation heat of the composite exposed portion 102 as a heating target portion (that is, a coating target portion) rises, if there is no abnormal condition, as indicated by the broken line L1 and then after a certain temperature is reached, remains constant. If, at this point, some abnormal condition such as a failure arises in the composite exposed portion 102, the shape of changes of the temperature of the thermocouple 901 is disturbed with respect to the shape of the broken line L1. The heating coil portion 260 is cooled, as described with reference to FIG. 10, by circulating a refrigerant through the hollow portion 263. Also when the cooling system fails, the shape of changes of the temperature of the thermocouple 901 is disturbed. Further, when an abnormal condition such as a failure occurs in the heating coil portion 260, the shape of changes of the current value of the ammeter 902 is disturbed with respect to the shape of the solid line L2. Such disturbances are detected by a controller (not shown). Then, in the second heating method, when such a disturbance is detected, the control is exercised such as immediately stopping the passage of a current to the heating coil portion 260 by the controller.

After the heat-up process by the third heating method described above, the immersion process in which the composite exposed portion 102 is immersed in the powder material 131 is performed.

According to the third heating method described above and the coating method adopting the heating method, by using detection results of various sensors as described above, conditions of the composite exposed portion 102 as a heating target portion (that is, a coating target portion) and the induction heating unit 206 can be monitored in real time. Then, by controlling the heat-up process based on a monitoring result, wasteful defective products can be inhibited from being produced. In addition, based on a monitoring result of the current value to the heating coil portion 260 of the induction heating unit 206, the replacement time of the heating coil portion 260 can be estimated.

In the example here, the second and third modes of the method of manufacturing a protective structure are cited as the destination of adoption of the third heating method. However, the destination of adoption of the third heating method is not limited to the above example and may be the third mode of the method of manufacturing a protective structure or the second and third modes of the method of manufacturing a cable in which the core wire is a heating target portion (that is, a coating target portion).

Next, the fourth heating method and the coating methods adopting the heating method will be described.

<Example of the Fourth Heating Method and the Coating Method Adopting the Heating Method>

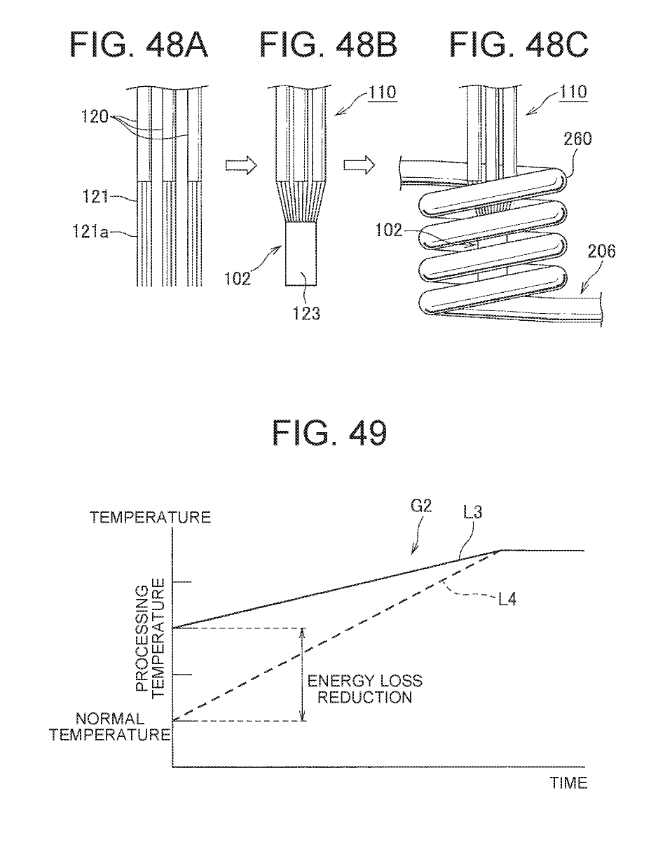

FIGS. 48A, 48B, and 48C are diagrams illustrating the fourth heating method and the coating method adopting the heating method. In FIGS. 48A, 48B, and 48C, an example in which the fourth heating method is applied to the second mode of the method of manufacturing a protective structure is shown. Then, the heating target portion (that is, the coating target portion) is the composite exposed portion 102 in the composite electric wire 110.

As described above and also as shown in FIGS. 48A and 48B, the composite exposed portion 102 has a configuration in which the exposed portions 121a of the plurality of cables 120 are bundled and welded to form the sheet welded portion 123. The composite exposed portion 102 including the welded portion 123 immediately after welding is in a heated state. In the fourth heating method, as shown in FIG. 48C, the composite exposed portion 102 still in a heated state is inserted into the heating coil portion 260 of the induction heating unit 206 for induction heating in the heat-up process.

FIG. 49 is a graph showing changes over time of the temperature of the composite exposed portion when heated up in the heat-up process by the fourth heating method shown in FIGS. 48A, 48B, and 48C. In a graph G2 in FIG. 49, the vertical axis represents the temperature of the composite exposed portion 102 and the horizontal axis represents the time. In the graph G2, changes over time of the temperature of the composite exposed portion 102 when heated up in the heat-up process by the fourth heating method are shown by a solid line L3. Also in the graph G2, changes over time of the temperature of the composite exposed portion when induction heating is performed after heat of the composite exposed portion 102 due to welding is once cooled to normal temperature are show by a broken line L4 for comparison.

Comparison of the solid line L3 and the broken line L4 in the graph G2 shows that when induction heating is performed after heat being cooled to normal temperature, heating energy to reach the processing temperature due to welding from normal temperature of the composite exposed portion 102 is needed. In the heat-up process by the fourth heating method, by contrast, heating starts from the processing temperature due to welding in the first place and the heating energy is eliminated.

After the heat-up process by the fourth heating method described above, the immersion process in which the composite exposed portion 102 is immersed in the powder material 131 is performed.

According to the fourth heating method described above and the coating method adopting the heating method, the heating energy is reduced as described above and thus, it is possible to heat up to the target temperature by inhibiting output to the heating coil portion 260.

In the example here, the second mode of the method of manufacturing a protective structure is cited as the destination of adoption of the fourth heating method. However, the destination of adoption of the fourth heating method is not limited to the above example and may be the third mode of the method of manufacturing a protective structure or the second and third modes of the method of manufacturing a cable in which the core wire is a heating target portion (that is, a coating target portion)

Next, a heating device of a different example applicable to the third mode of the method of manufacturing a protective structure and the third mode of the method of manufacturing a cable and using an induction coil that can be adopted as a heating coil portion in each of the above modes and a coating device adopting the heating device will be described.

<Heating Device of a Different Example and a Coating Device Adopting the Heating Device>

A heating device of a different example is a heating device that heats a conductive heating target portion accommodated in an insulating container having a cup shape in which the outside diameter of the other portion is made narrower than the outside diameter of an opening side and includes a heat-up unit having on an outer circumference of the container an induction coil wound in a shape in which at least a portion of the outside diameter is made narrower than the outside diameter of one end corresponding to the opening side to heat the heating target portion accommodated in the container by induction heating of the induction coil.

According to the heating device of the different example, the density of magnetic flux generating heat in the heating target portion inside the container by induction heating is increased by at least a portion of the outside diameter of the induction coil being made narrower than the outside diameter of one end. Accordingly, heating efficiency in induction heating is improved.

In the heating device of the different example, the induction coil may be wound wider or taperingly on the one end.

A coating device adopting the heating device of the different example is a coating device that coats a conductive heating target portion with a thermoplastic material and includes an insulating container formed in a cup shape in which the outside diameter of the other portion is made narrower than the outside diameter of an opening side and accommodating the thermoplastic material in a powder shape and an immersion/heat-up unit having an induction coil surrounding an outer circumference of the container and wound in a shape in which at least a portion of the outside diameter is made narrower than the outside diameter of one end corresponding to the opening side to coat the heating target portion by heating the heating target portion immersed in the thermoplastic material in the powder state inside the container to the melting temperature of the thermoplastic material or higher by induction heating of the induction coil to allow the thermoplastic material in the powder state to adhere to the heated heating target portion.

According to the coating device, the magnetic flux density generating heat in the heating target portion inside the container by induction heating is increased and thus, heating efficiency by induction heating can be increased. Then, according to the coating device of the present invention, heating is made efficient and correspondingly, coating is made efficient.

Also in the coating device, the induction coil may be wound widely or taperingly on the one end.

Hereinafter, the heating device of the different example and the coating device adopting the heating device will be described by citing concrete examples.

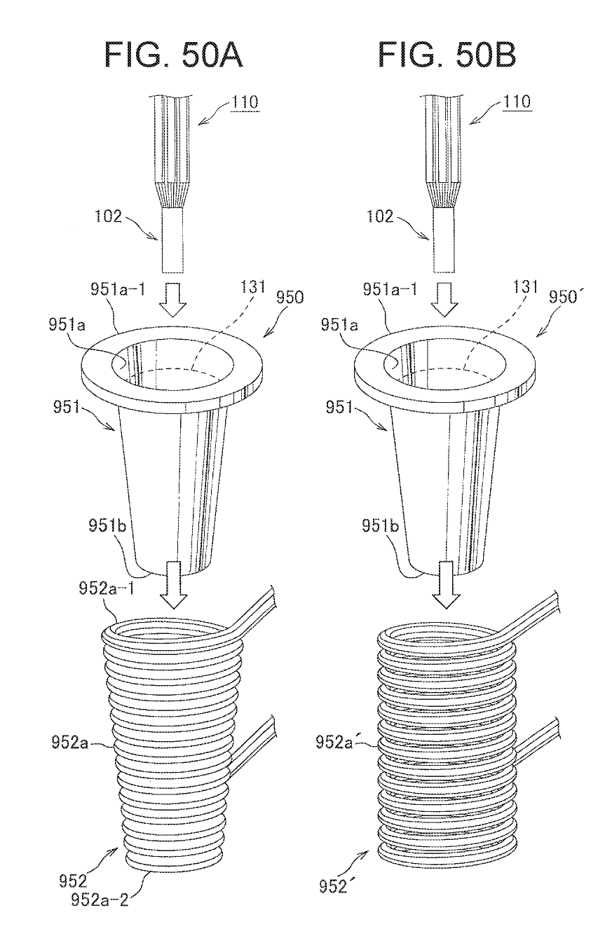

FIGS. 50A and 50B are diagrams showing coating devices adopting a heating device of a different example using an induction coil. A coating device 950 adopting the heating device of the different example is shown in FIG. 50A and a coating device 950′ of a comparative example to compare with the coating device 950 is shown in FIG. 50B. In these coating devices 950, 950′, the coating target portion (that is, the heating target portion) in both cases is the composite exposed portion 102 in the composite electric wire 110. That is, FIGS. 50A and 50B show an application example to the third mode of the method of manufacturing a protective structure.

The coating device 950 shown in FIG. 50A includes an immersion container 951 in which the powder material 131 is accommodated and an induction heating unit 952. The immersion container 951 is a container formed in a tapering cup shape in which the outside diameter of the other portion is made narrower than the outside diameter of an opening 951a, that is, the outside diameter is made narrower from the opening 951a toward a bottom 951b and a flange 951a-1 is provided in the opening 951a. The induction heating unit 952 (example of the heating device) has an induction coil 952a wound on the outer circumference of the immersion container 951 and a power supply and a control device (not shown) so as to have a tapering shape in which the outside diameter on another end 952a-2 is narrower than the outside diameter on one end 952a-1 corresponding to the opening 951a of the immersion container 951. That is, the induction coil 952a wound taperingly with the one end 952a-1 wide open. The immersion container 951 is accommodated inside the induction coil 952a and the flange 951a-1 of the immersion container 951 is placed on the one end 952a-1 of the induction coil 952a.

The induction heating unit 952 is the immersion/heat-up unit that coats the composite exposed portion 102 by heating the composite exposed portion 102 as a coating target portion (that is, a heating target portion) accommodated in the immersion container 951 so as to be immersed in the powder material 131 to the melting temperature of the powder material 131 or higher by induction heating of the induction coil 952a to melt the powder material 131 around the composite exposed portion 102 to allow the powder material 131 in a melted state to adhere to the composite exposed portion 102. Also in this example, the induction heating unit 952 itself is the heating device.

On the other hand, the coating device 950′ of the comparative example shown in FIG. 50B is equal to the coating device 950 in FIG. 50A except that an induction coil 952a′ in an induction heating unit 952′ is a coil in a cylindrical shape wound in the same outside diameter from one end to the other end.

In the coating device 950 in FIG. 50A, the induction coil 952a is wound in a narrowed shape as described above and thus, the magnetic flux density inside the coil is increased when compared with the magnetic flux density inside the induction coil 952a′ of the coating device 950′ of the comparative example shown in FIG. 50B.

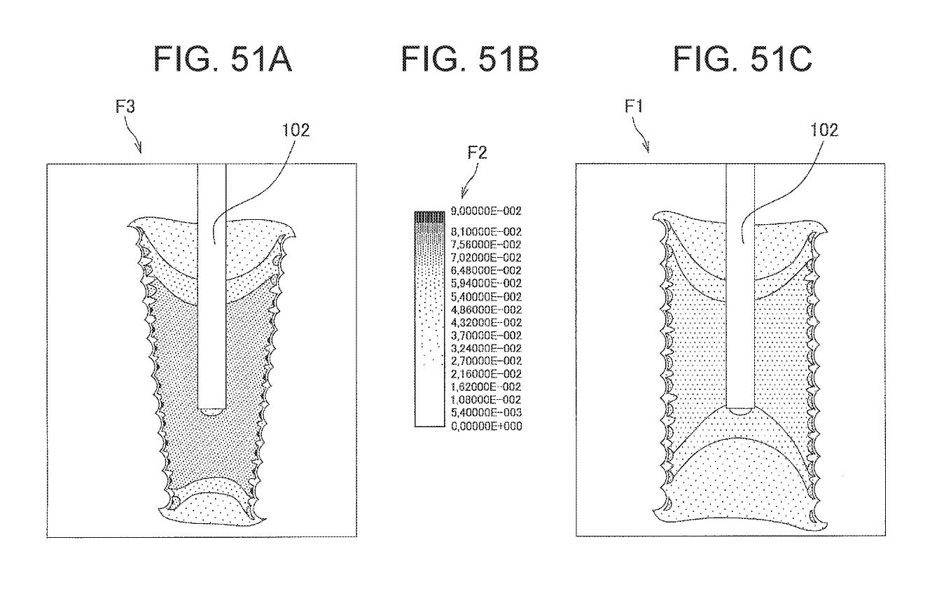

FIGS. 51A, 51B, and 51C are diagrams comparing internal magnetic flux densities of the heating coil portion of the coating device shown in FIG. 50A and the heating coil portion of the coating device of the comparative example shown in FIG. 50B. FIG. 51A shows a distribution map F1 obtained by simulating the distribution of the magnetic flux density in the induction coil 952a of FIG. 50A. In the distribution map F1, the level of the magnetic flux density is represented by the thickness of hatching and FIG. 51B shows a bar graph F2 representing the magnetic flux density corresponding to the thickness of hatching. As is evident from the bar graph F2, the magnetic flux density increases with an increasing thickness of hatching. FIG. 51B shows a distribution map F3 obtained by simulating the distribution of the magnetic flux density in the induction coil 952a′ of the comparative example of FIG. 50B.

In the distribution map F1 of FIG. 51A and the distribution map F3 of FIG. 51B, the composite exposed portion 102 as a coating target portion (that is, a heating target portion) is shown. Of the two distribution maps F1, F3, the distribution map F1 in FIG. 51A shows a higher magnetic flux density in the periphery of the composite exposed portion 102. This is because the induction coil 952a is wound in the narrowed shape as described above and thus, the magnetic flux density is increased by the total quantity of magnetic flux passing through a narrowed area.

According to the induction heating unit 952 and the coating device 950 shown in FIGS. 50A and 50B, the density of magnetic flux generating heat in the composite exposed portion 102 as a heating target portion inside the immersion container 951 is increased by at least a portion of the outside diameter of the induction coil 952a being made narrower than the outside diameter of one end. Accordingly, heating efficiency in induction heating is improved.

Here, the third mode of the method of manufacturing a protective structure is illustrated as the destination of application of the induction heating unit 952 and the coating device 950 shown in FIG. 50A. However, the destination of application of the induction heating unit 952 and the coating device 950 is not limited to such an example and may be the third mode of the method of manufacturing a cable.

<Heating Device of Another Different Example and the Method Thereof and the Coating Device Adopting the Heating Method and the Method Thereof>

To improve heating efficiency, a heating device of another different example is a heating device to heat a conductive heating target portion and includes an induction coil and a power supply unit to pass an alternating current to the induction coil, wherein the induction coil is provided with an introduction portion to introduce the heating target portion into the induction coil and the introduction portion is provided in a position where the heating target portion is introduced from a direction intersecting the center axis of the induction coil.

In each of the above examples, the electric wire (composite electric wire) as a heating target portion is inserted along the center axis of the coil, but according to the above heating device, the heating target portion is introduced into the induction coil from the introduction portion from a direction intersecting the center axis of the induction coil. Here, if the heating target portion is introduced in a direction intersecting the center axis of the induction coil while an alternating current is passed to the induction coil, the number of lines of magnetic force passing through the heating target portion increases when compared with a case when the heating target portion is inserted along the center axis of the induction coil. Accordingly, an eddy current of a large current value can be generated in the heating target portion. Therefore, heating efficiency can be improved.

The introduction portion may be provided in a center portion in the direction of the center axis of the induction coil.

That is, in the center portion in the direction of the center axis of the induction coil, compared with both ends, the line of magnetic force is less likely to leak out of the induction coil. That is, the center portion in the direction of the center axis of the induction coil has a higher magnetic flux density than both ends of the coil and thus, the heating target portion is inserted into a position where the magnetic flux density is high by the introduction portion being provided in the center portion in the direction of the center axis of the induction coil. Therefore, the current value of an eddy current generated inside the heating target portion becomes larger than a case when the heating target portion is inserted into a position of a low magnetic flux density. Therefore, heating efficiency can be improved still more.

The magnetic flux density in the center portion in the direction of the center axis of the induction coil is high and changes such that the magnetic flux density gradually decreases from the center portion toward the end. Thus, when the heating target portion is inserted along the center axis of the induction coil, the heating target portion needs to be caused to reach the neighborhood of the center portion in the direction of the center axis of the induction coil, which makes the relative movement of the induction coil and the heating target portion large. On the other hand, by inserting the heating target portion from a direction intersecting the center axis of the induction coil here, the heating target portion can be caused to reach a position where the magnetic flux density is high even if the relative movement of the induction coil and the heating target portion is small. Thus, by decreasing the relative movement of the induction coil and the heating target portion as described above, the movement of the heating target portion can be decreased. Therefore, the device can be made smaller in size.

Also, an insulating member in a closed-end cylindrical shape mounted on the induction coil and into which the heating target portion can be inserted may be included, wherein the heating target portion is inserted into the introduction portion via the insulating member and the insulating member may be positioned with respect to the induction coil by being mounted on the induction coil such that the axis direction thereof intersects the center axis of the induction coil.

That is, the induction coil and the insulating member are positioned. The insulating member may also has a guide function to guide the heating target portion to a predetermined position of the induction coil. In this case, the heating target portion is guided to a predetermined position of the induction coil by the insulating member while the insulating member is positioned on the induction coil. Because the heating target portion can be guided to the predetermined position where, for example, the magnetic flux density is the highest, heating efficiency can be improved still more.

The insulating member may also be provided with a flange extending outward in a radial direction thereof so that the insulating member is positioned on the induction coil by the flange being locked onto a circumference of the introduction portion.

Accordingly, the insulating member can be positioned on the induction coil by introducing the insulating member into the introduction portion and causing the circumference of the introduction portion to lock the flange.

To improve heating efficiency, a heating method of the other different example is a heating method of heating a conductive heating target portion by passing an alternating current to the induction coil and includes an introduction process in which the heating target portion is inserted into the induction coil from a direction intersecting the center axis of the induction coil or a direction perpendicular to the center axis of the induction coil and a current application process in which an alternating current is passed to the induction coil while the heating target portion is inserted into the induction coil.

According to the above heating method, the introduction process in which the heating target portion is inserted into the induction coil from a direction intersecting the center axis of the induction coil or a direction perpendicular to the center axis of the induction coil and the current application process in which an alternating current is passed to the induction coil while the heating target portion is inserted into the induction coil are included. Here, if the heating target portion is inserted in a direction intersecting the center axis of the induction coil or a direction perpendicular to the center axis of the induction coil while an alternating current flows to the induction coil, the number of lines of magnetic force passing through the heating target portion increases when compared with a case when the heating target portion is inserted along the center axis of the induction coil. Accordingly, an eddy current of a large current value can be generated in the heating target portion. Therefore, heating efficiency can be improved. In this heating method, the introduction process and the current application process may be performed successively or the current application process and the introduction process may be performed successively.

To improve heating efficiency, a coating device adopting the above heating device includes the above heating device, wherein the insulating member can accommodate therein a thermoplastic material with which the heating target portion is coated.

According to the coating device, an eddy current of a large current value can be generated in the heating target portion while the heating target portion is inserted into the insulating member and the thermoplastic material accommodated inside the insulating member can efficiently be melted and caused to adhere. The heating efficiency is increased as described above and thus, the heating target portion can efficiently be coated.

To improve heating efficiency, the coating method is a coating method of a heating target portion using the above coating device and includes an immersion process in which the heating target portion is immersed in the thermoplastic material by inserting the heating target portion into the insulating member while the thermoplastic material is accommodated inside the insulating material, a current application process in which an alternating current is passed to the induction coil while the heating target portion is immersed in the thermoplastic material, and a melting/adhesion process in which the thermoplastic material is melted and caused to adhere to the heating target portion.

According to the coating method, an eddy current of a large current value can be generated in the heating target portion while the heating target portion is inserted into the insulating member and therefore, the thermoplastic material accommodated inside the insulating member can efficiently be melted and caused to adhere. The heating efficiency is increased as described above and thus, the heating target portion can efficiently be coated.

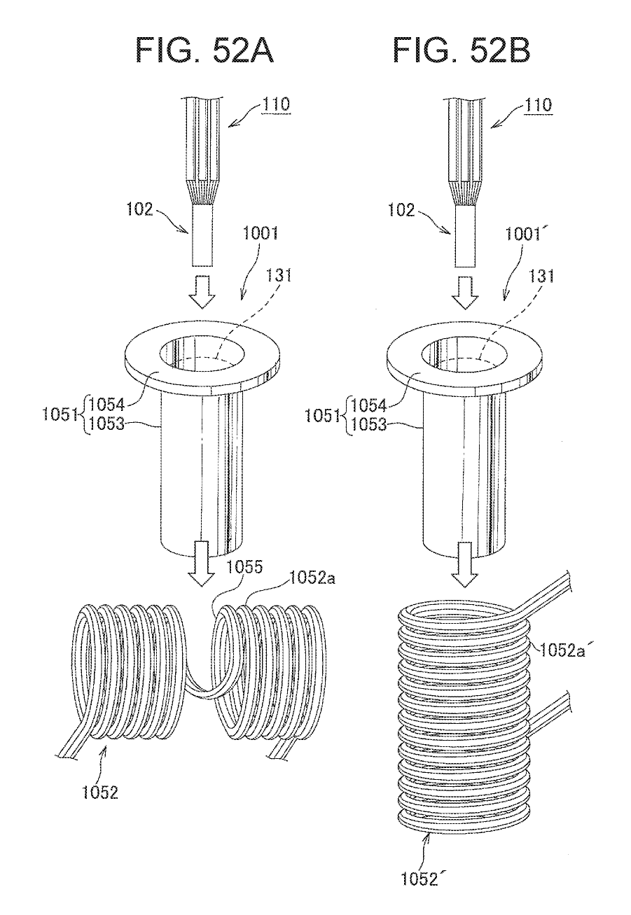

FIGS. 52A and 52B are diagrams showing a coating device adopting a heating device of another different example using an induction coil. A coating device 1001 adopting the heating device of the other different example is shown in FIG. 52A and a coating device 1001′ of a comparative example to compare with the coating device 1001 is shown in FIG. 52B. In these coating devices 1001, 1001′, the coating target portion (heating target portion) in both cases is the composite exposed portion 102 in the composite electric wire 110. In FIGS. 52A and 52B, the same reference signs as those in FIGS. 50A and 50B are attached to elements equivalent to those shown in FIGS. 50A and 50B and hereinafter, a repeated description of the same element is omitted.

The coating device 1001 shown in FIG. 52A includes an immersion container 1051 (insulating member) in which the powder material 131 is accommodated and an induction heating unit 1052.

The immersion container 1051 is constructed of, as shown in FIG. 52A, an insulating material in a closed-end cylindrical shape. The immersion container 1051 is to be mounted on the induction heating unit 1052 and includes a closed-end cylindrical body 1053 formed to have the same outside diameter from one end to the other end in the axial direction and a flange 1054 formed continuously on the circumference of the opening of the cylindrical body 1053. The immersion container 1051 is positioned in a predetermined position of the induction heating unit 1052 while the immersion container 1051 mounted on the induction heating unit 1052.

The immersion container 1051 is formed such that the inside diameter dimension of the cylindrical body 1053 is larger than the maximum outside diameter of the composite exposed portion 102 to enable the insertion of the composite exposed portion 102. The immersion container 1051 is also formed in dimensions allowing the cylindrical body 1053 to be introduced into a gap portion 1055 (introduction portion) (described below) of a heating coil portion 1052a (induction coil) of the induction heating unit 1052. Also, the cylindrical body 1053 is formed such that the axial dimension thereof becomes larger than the diameter dimension of the heating coil portion 1052a. That is, in the present example, the immersion container 1051 protrudes from the heating coil portion 1052a while the immersion container 1051 is mounted on the heating coil portion 1052a.

Here, the cylindrical body 1053 only needs to be formed in dimensions that enable the insertion into the gap portion 1055. Then, the formation position of the bottom in the cylindrical body 1053 (axis dimension of the cylindrical body 1053) may be set such that the composite exposed portion 102 is positioned in a predetermined position (position where the magnetic flux density is high) in the heating coil portion 1052a while the immersion container 1051 is positioned in the heating coil portion 1052a. Thus, the dimensional relationship between the immersion container 1051 and the heating coil portion 1052a may be set so that the immersion container 1051 guides the composite exposed portion 102 up to a predetermined position of the heating coil portion 1052a. That is, the composite exposed portion 102 is inserted into the heating coil portion 1052a from a direction perpendicular to the center axis of the heating coil portion 1052a after being guided by an inner circumferential surface of the immersion container 1051.

In the present example, the cylindrical body 1053 of the immersion container 1051 is formed to have the same outside diameter from one end to the other end in the axial direction, but like the immersion container 951 shown in FIGS. 50A and 50B, the cylindrical body may be formed such that the other end is formed in a tapering shape from one end.

The flange 1054 is provided all around the circumference of the opening of the cylindrical body 1053. The flange 1054 is formed such that the outside diameter dimension thereof becomes larger than the diameter dimension of the gap portion 1055 to be lockable onto the circumference of the gap portion 1055. In the present example, that the flange 1054 is locked onto the circumference of the gap portion 1055 unit that the undersurface of the flange 1054 abuts on the circumference of the gap portion 1055. Thus, if the undersurface of the flange 1054 can abut on the circumference of the gap portion 1055, the flange 1054 may not be provided all around the cylindrical body 1053. For example, the flange only needs to be present at least in positions opposite to each other across the center axis of the cylindrical body 1053. The flange 1054 is positioned on the circumference of the opening of the cylindrical body 1053, but may also be provided in an appropriate position in the axial direction of the cylindrical body 1053.

In the present example, the immersion container 1051 is positioned in a predetermined position of the induction heating unit 1052 by the flange 1054 being locked onto the circumference of the gap portion 1055 of the heating coil portion 1052a. For example, the outside diameter of the opening in the cylindrical body 1053 may be formed larger than the outside diameter of the circumference of the gap portion 1055 so that the opening of the cylindrical body 1053 is caught by the circumference of the gap portion 1055. In this manner, the immersion container 1051 may be positioned in a predetermined position of the induction heating unit 1052. In this case, the flange may be omitted.

The induction heating unit 1052 includes the induction coil 952a (induction coil) and a power supply, a control device and the like (not shown). The induction coil 952a has the gap portion 1055 (introduction portion) between neighboring conductor wires in the axial direction so that the axis of the immersion container 1051 is orthogonal to (intersecting) the center axis of the coil for mounting in a cylindrical multi-wound coil in which the conductor wire is wound in the same diameter from one end to the other end. That is, the gap portion 1055 is formed in a size allowing the cylindrical body 1053 to be inserted. The gap portion 1055 is provided in the center portion in the direction of the center axis of the induction coil 952a.

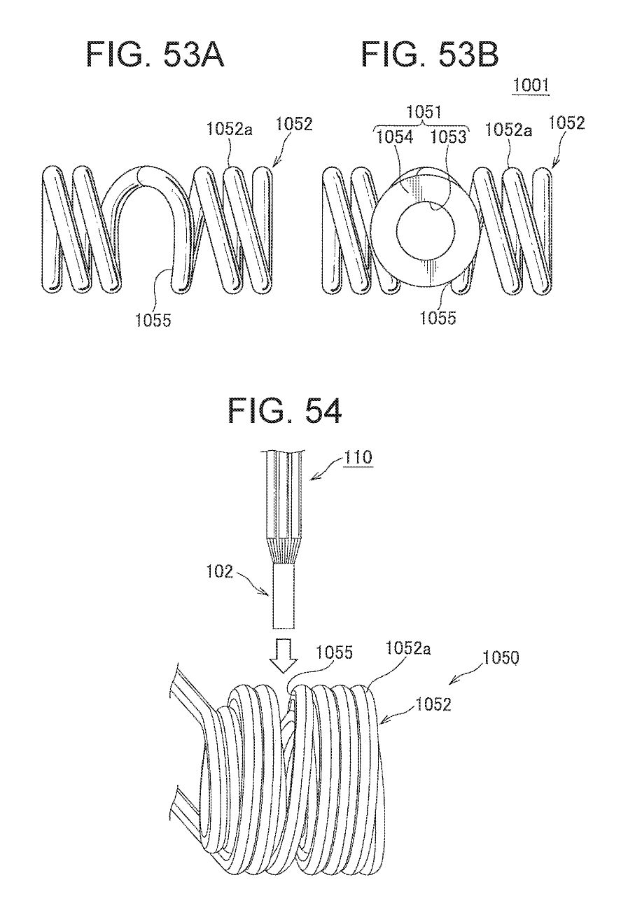

Next, the procedure for assembling the coating device 1001 will be described with reference to FIGS. 53A and 53B. As shown in FIG. 53A, the immersion container 1051 is inserted into the gap portion 1055 formed in the induction coil 952a by approaching from the bottom side. As shown in FIG. 53B, the flange 1054 of the immersion container 1051 locks onto the circumference of the gap portion 1055. In this manner, the immersion container 1051 is mounted on the heating coil portion 1052a. At this point, the immersion container 1051 is positioned on the heating coil portion 1052a. Both ends of the induction coil 952a are connected to a power supply unit to pass an alternating current. In this manner, the coating device 1001 is assembled.

Subsequently, the coating method using the coating device 1001 will be described.

The powder material 131 is poured into the immersion container 1051 from the opening. The composite exposed portion 102 is inserted (introduced) into the immersion container 1051 in which, as described above, the powder material 131 is accommodated (introduction process). Because the immersion container 1051 is mounted on the heating coil portion 1052a in a direction perpendicular to the center axis of the heating coil portion 1052a, the composite exposed portion 102 inserted into the immersion container 1051 is also introduced into the heating coil portion 1052a with the axis thereof in a direction perpendicular to the center axis of the heating coil portion 1052a. Then, the composite exposed portion 102 is immersed in the powder material 131 by the composite exposed portion 102 being inserted into the powder material 131 accommodated in the immersion container 1051 (immersion process).

An alternating current is passed to the heating coil portion 1052a by using the control device while the composite exposed portion 102 is inserted into and immersed in the powder material 131 (current application process).

Accordingly, an eddy current is generated in the composite exposed portion 102 by electromagnetic induction and the composite exposed portion 102 is heated. The powder material 131 is melted by the composite exposed portion 102 being heated and adheres to the composite exposed portion 102 (melting/adhesion process). In this manner, the composite exposed portion 102 is coated and the composite electric wire 110 is completed.

On the other hand, the coating device 1001′ of the comparative example shown in FIG. 52B is equal to the coating device in FIG. 52A except that a heating coil portion 1052a′ in an induction heating unit 1052′ does not have the gap portion 1055 in the present example and the composite exposed portion 102 is inserted into the heating coil portion 1052a′ along the center axis of the heating coil portion 1052a′.

Subsequently, the operation/working-effect of the coating device 1001 in the present example will be described while comparing with the coating device 1001′ in the comparative example.

According to the coating device 1001 in the present example shown in FIG. 52A, the composite exposed portion 102 (heating target portion) is introduced into the heating coil portion 1052a from the gap portion 1055 (introduction portion) in a direction perpendicular to the center axis of the heating coil portion 1052a. If the composite exposed portion 102 is introduced in a direction intersecting the center axis of the heating coil portion 1052a while an alternating current flows through the heating coil portion 1052a, compared with a case when inserted along the center axis of the heating coil portion 1052a′ like the coating device 1001′ of the comparative example shown in FIG. 52B, the number of lines of magnetic force passing through the composite exposed portion 102 increases. Accordingly, an eddy current of a large current value can be generated in the composite exposed portion 102. Therefore, heating efficiency can be improved.

In the center portion in the direction of the center axis of the heating coil portions 1052a, 1052a′, compared with both ends, the line of magnetic force is less likely to leak out of the coil. That is, the magnetic flux density in the center portion in the direction of the center axis of the heating coil portions 1052a, 1052a′ is higher than on both ends thereof and thus, with the gap portion 1055 (introduction portion) provided in the center portion in the direction of the center axis of the heating coil portion 1052a, the composite exposed portion 102 is introduced into a position where the magnetic flux density is high. Therefore, compared with a case when the composite exposed portion 102 is introduced into a position where the magnetic flux density is low, the current value of an eddy current generated inside the composite exposed portion 102 becomes large. Therefore, heating efficiency can be improved still more.

The magnetic flux density in the center portion in the direction of the center axis of the heating coil portion 1052a is high and changes such that the magnetic flux density gradually decreases from the center portion toward the end. Thus, when the composite exposed portion 102 is inserted along the center axis of the heating coil portion 1052a′ as shown in FIG. 52B, the composite exposed portion 102 needs to be caused to reach the neighborhood of the center portion in the direction of the center axis of the heating coil portion 1052a′, which makes the relative movement of the heating coil portion 1052a′ and the composite exposed portion 102 large. On the other hand, by inserting the composite exposed portion 102 from a direction intersecting the center axis of the heating coil portion 1052a as shown in FIG. 52A, the composite exposed portion 102 can be caused to reach a position where the magnetic flux density is high even if the relative movement of the heating coil portion 1052a and the composite exposed portion 102 is small. Thus, by decreasing the relative movement of the composite exposed portion 102 and the heating coil portion 1052a as described above, the movement of the composite exposed portion 102 can be decreased. Therefore, the device can be made smaller in size.

In the above modes, an example in which the immersion container 1051 is used as a portion of the configuration of a heating device 1050 (shown in FIG. 54) and the powder material 131 is accommodated in the immersion container 1051 is described, but the mode is not limited to such an example. The powder material 131 may not be accommodated in the immersion container 1051. That is, the immersion container 1051 may not be configured to be able to accommodate the powder material 131. In such a case, the immersion container 1051 (insulating member) may include a function to guide the composite exposed portion 102 up to a predetermined position of the heating coil portion 1052a.

Also in the above modes, an example in which the immersion container 1051 (insulating member) is mounted such that the axis thereof is in a direction perpendicular to the center axis of the heating coil portion 1052a (induction coil) is described. Also, an example in which the composite exposed portion 102 (heating target portion) is inserted into the immersion container 1051 in a direction perpendicular to the center axis of the induction coil 952a is described, but the mode is not limited to such examples. An insulating member may be mounted with the axis thereof intersecting the center axis of the induction coil and a heating target portion may be introduced into such an insulating member in a direction intersecting the center axis of the induction coil.

Also in the above modes, the composite exposed portion 102 (heating target portion) is introduced into the gap portion 1055 (introduction portion) via the immersion container 1051 (insulating member), but the mode is not limited to such an example. As shown in FIG. 54, the composite exposed portion 102 may directly be introduced into the gap portion 1055. In such a case, the immersion container 1051 (insulating member) may be omitted. That is, the heating device may not have the configuration of the immersion container 1051 (insulating member).

Also in the above modes, a cylindrical coil in which a conductor wire is wound in the same diameter from one end to the other end is used as the induction coil 952a, but the mode is not limited to such an example and the coil may be a coil in which a conductor wire is wound so as to have a portion (minor diameter portion) of a different diameter or a single-wound coil.

In each of the above modes, the composite exposed portion 102 of the composite electric wire 110 configured by bundling a plurality of the cables 120 is described as an example of the heating target portion, but the mode is not limited to such an example and the modes may also be applied to a portion that needs a coating of various electric wires such as one electric wire and a shielded electric wire. If not used as an electric wire, the above modes can be applied to objects having a conductive heating target portion. That is, the “conductive heating target portion” can be applied to others than electric wires.

Various modes described above show only representative modes of the present invention and the present invention is not limited to such modes. That is, a person skilled in the art can carry out various modifications without deviating from the spirit of the present invention according to heretofore known findings.

### REFERENCE SIGNS LIST

102 Composite exposed portion
103 Immersion container (an example of the immersion unit)
104 Protective member
106 Heating furnace (an example of the heat-up unit)
110 Composite electric wire
120 Cable
121 Core wire
121a Exposed portion
131 Powder material (an example of an insulating polymeric material in a powder state)
206, 306 Induction heating unit (an example of the heat-up unit)
260,360 Heating coil portion

What is claimed is:

1. A method of manufacturing a protective structure covering an exposed portion of a core wire of a cable with a protective member made of an insulating polymeric material, the method comprising:
a heat-up process of heating the exposed portion to a melting temperature of the insulating polymeric material or higher; and
an immersion process of immersing the exposed portion having been heated in the insulating polymeric material in a powder state inside an immersion container to allow the insulating polymeric material to adhere to the exposed portion.

2. The method according to claim 1, wherein the heat-up process includes a process of heating the exposed portion by an induction heating unit.

3. A method of manufacturing a protective structure covering an exposed portion of a core wire of a cable with a protective member made of an insulating polymeric material, the method comprising:
an immersion/heat-up process of heating the exposed portion immersed in the insulating polymeric material in a powder state inside an immersion container to a melting temperature of the insulating polymeric material or higher by an induction heating unit positioned on an outer circumferential side of the immersion container through induction heating.

4. The method according to claim 1, further comprising: a reheat-up process of heating the protective member covering the exposed portion to the melting temperature or higher.

5. The method according to claim 3, further comprising: a reheat-up process of heating the protective member covering the exposed portion to the melting temperature or higher.

6. The method according to claim 4, wherein the reheat-up process is a process of heating the exposed portion covered with the protective member through induction heating to heat the protective member to the melting temperature or higher.

7. The method according to claim 5, wherein the reheat-up process is a process of heating the exposed portion covered with the protective member through induction heating to heat the protective member to the melting temperature or higher.

8. The method according to claim 1, wherein the exposed portion is formed at an end, a midpoint, or both of the end and the midpoint of the cable.

9. The method according to claim 3, wherein the exposed portion is formed at an end, a midpoint, or both of the end and the midpoint of the cable.

10. A method of manufacturing a protective structure of a composite electric wire comprising: protecting an exposed portion by covering with a protective member by the method of manufacturing a protective structure according to claim 1, the exposed portion being obtained by bundling and electrically connecting exposed portions of core wires of a plurality of cables.

11. A method of manufacturing a protective structure of a composite electric wire comprising: protecting an exposed portion by covering with a protective member by the method of manufacturing a protective structure according to claim 3, the exposed portion being obtained by bundling and electrically connecting exposed portions of core wires of a plurality of cables.
